(19) United States
(12) Patent Application Publication
(10) Pub. No.: US 2009/0148069 A1
(43) Pub. Date: Jun. 11, 2009

(54) Image-data recording and reproducing apparatus

(75) Inventors: Wataru Inoha, Kanagawa-ken (JP); Shin Nakate, Kanagawa-ken (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 12/292,012

(22) Filed: Nov. 10, 2008

(30) Foreign Application Priority Data
Dec. 11, 2007 (JP) 2007-319348

(51) Int. Cl. G06K 9/54

(52) U.S. Cl. 382/305

(57) ABSTRACT

An image data recording apparatus includes a menu picture data managing section and a recording section. The menu picture data managing section operates for managing first menu picture data containing control information designed to allow switching from reproduction of first image data pieces to reproduction of second image data pieces or switching from reproduction of the second image data pieces to reproduction of the first image data pieces. The recording section operates for obtaining the first menu picture data from the menu picture data managing section, and for recording the obtained first menu picture data, the first image data pieces, and the second image data pieces on a recording medium.

### BACKGROUND OF THE INVENTION

1. Field of the Invention

This invention relates to an apparatus for recording first image data pieces and second image data pieces on a recording medium. This invention further relates to an apparatus for reproducing first image data pieces and second image data pieces from a recording medium. The second image data pieces may be replaced by playlists used for generating the second image data pieces from the first image data pieces. For example, the first image data pieces are main image data pieces while the second image data pieces are digest image data pieces, that is, data pieces representing digests of pictures represented by the main image data pieces.

2. Description of the Related Art

Japanese patent number 3064975 (corresponding to Japanese patent application publication number 11-032288/1999) discloses a video reproduction system in which main video programs are recorded on discs in casings, respectively. Product code words (reference marks) serving as IDs for the main video programs are printed on the related casings, respectively. There is another disc which stores short-story video signals representing digests of the main video programs respectively. Each of the short-story video signals contains the reference mark for the corresponding main video program.

In the system of Japanese patent 3064975, the short-story video programs are sequentially reproduced from the digest disc, and the digests represented by the short-story video programs are sequentially indicated on a display. During the sequential indication of the digests on the display, a user actuates a selection key when the currently-indicated digest is desired one. Upon the actuation of the selection key, the reference mark in the currently-reproduced short-story video signal is detected. Among the casings of the main program discs, one is found which has a product code word matching the detected reference mark. The main video program is reproduced from the main program disc in the found casing, and is indicated on the display. In this way, the user can find desired one among the main video programs by monitoring the digests thereof. The desired main video program is indicated on the display.

The system of Japanese patent 3064975 includes a digest reproducing device for reproducing the short-story video programs from the digest disc, and a main reproducing device for reproducing the main video program from selected one of the main program discs. There is a switch for selectively connecting the display to either the digest reproducing device or the main reproducing device. When the main video program is reproduced from the main program disc in the found casing by the main reproducing device, the switch is controlled to connect the display to the main reproducing device rather than the digest reproducing device to allow the transmission of the reproduced main video signal to the display and the indication of the reproduced main video signal thereon.

### SUMMARY OF THE INVENTION

It is a first object of this invention to provide an apparatus for recording first image data pieces and second image data pieces (or playlists used for generating the second image data pieces from the first image data pieces) on a recording medium in a manner such as to enable a data reproducing apparatus to smoothly implement switching from the reproduction of the first image data pieces to the reproduction of the second image data pieces or switching from the reproduction of the second image data pieces to the reproduction of the first image data pieces.

It is a second object of this invention to provide an apparatus for reproducing, from a recording medium, first image data pieces and second image data pieces (or playlists used for generating the second image data pieces from the first image data pieces) which can smoothly implement switching from the reproduction of the first image data pieces to the reproduction of the second image data pieces or switching from the reproduction of the second image data pieces to the reproduction of the first image data pieces.

A first aspect of this invention provides an image data recording apparatus comprising a menu picture data managing section for managing first menu picture data containing control information designed to allow switching from reproduction of first image data pieces to reproduction of second image data pieces or switching from reproduction of the second image data pieces to reproduction of the first image data pieces; and a recording section for obtaining the first menu picture data from the menu picture data managing section, and for recording the obtained first menu picture data, the first image data pieces, and the second image data pieces on a recording medium.

A second aspect of this invention is based on the first aspect thereof, and provides an image data recording apparatus wherein the menu picture data managing section operates for managing second menu picture data containing control information designed to allow starting reproduction of the first image data pieces or the second image data pieces from a desired point or to allow selecting desired one from the first image data pieces or the second image data pieces and starting reproduction of the selected desired image data piece, and wherein the recording section operates for obtaining the second menu picture data from the menu picture data managing section, and for recording the obtained second menu picture data on the recording medium.

A third aspect of this invention is based on the first aspect thereof, and provides an image data recording apparatus further comprising a digest generating section for generating digest image data pieces representing digests of pictures represented by the first image data pieces, and wherein the recording section operates for using the digest image data pieces generated by the digest generating section as the second image data pieces.

A fourth aspect of this invention is based on the first aspect thereof, and provides an image data recording apparatus wherein the control information in the first menu picture data represents a command to obtain reproduced picture identifying information indicating whether an image data piece reproduced before visualization of a first menu picture represented by the first menu picture data is one of the first image data pieces or one of the second image data pieces; a command to obtain reproduction-suspension point information representing a position at which reproduction of the image data piece reproduced before visualization of the first menu picture is suspended; and a command to decide a position, at which reproduction of the second image data pieces should be started, on the basis of the reproduction-suspension point information in cases where the reproduced picture identifying information indicates that the image data piece reproduced before visualization of the first menu picture is one of the first image data pieces, and decide a position, at which reproduction of the first image data pieces should be started, on the basis of the reproduction-suspension point information in cases where the reproduced picture identifying information indicates that the image data piece reproduced before visualization of the first menu picture is one of the second image data pieces.

A fifth aspect of this invention is based on the first aspect thereof, and provides an image data recording apparatus further comprising a first group generating section for classifying the first image data pieces into groups according to attribute information pieces about the first image data pieces, and for generating first list files mentioning the first image data pieces in the respective groups; a second group generating section for classifying the second image data pieces into groups according to the first list files, and for generating second list files mentioning the second image data pieces in the respective groups; wherein the recording section operates for recording the first list files and the second list files on the recording medium.

A sixth aspect of this invention is based on the fifth aspect thereof, and provides an image data recording apparatus wherein the control information in the first menu picture data represents a command to obtain reproduced picture identifying information indicating whether an image data piece reproduced before visualization of a first menu picture represented by the first menu picture data is one of the first image data pieces or one of the second image data pieces; a command to obtain reproduced group identifying information indicating a group having the image data piece reproduced before visualization of the first menu picture; and a command to decide a group, from which reproduction of the second image data pieces should be started, on the basis of the reproduced group identifying information in cases where the reproduced picture identifying information indicates that the image data piece reproduced before visualization of the first menu picture is one of the first image data pieces, and decide a group, from which reproduction of the first image data pieces should be started, on the basis of the reproduced group identifying information in cases where the reproduced picture identifying information indicates that the image data piece reproduced before visualization of the first menu picture is one of the second image data pieces.

A seventh aspect of this invention is based on the fourth aspect thereof, and provides an image data recording apparatus wherein the control information in the first menu picture data represents a command to hold information indicating whether an image data piece, start of reproduction of which is decided, is one of the first image data pieces or one of the second image data pieces.

An eighth aspect of this invention is based on the fifth aspect thereof, and provides an image data recording apparatus wherein the control information in the second menu picture data represents a command to start reproducing the first image data pieces or the second image data pieces from a desired group.

A ninth aspect of this invention is based on the second aspect thereof, and provides an image data recording apparatus wherein the control information in the second menu picture data represents a command to hold information indicating whether an image data piece, start of reproduction of which is decided, is one of the first image data pieces or one of the second image data pieces.

A tenth aspect of this invention is based on the second aspect thereof, and provides an image data recording apparatus further comprising an initial reproduction information generating section for generating initial reproduction information indicating whether the first image data pieces or the second image data pieces should be reproduced at the time of reproduction of recorded data from the recording medium, and wherein the recording section operates for recording the initial reproduction information generated by the initial reproduction information generating section on the recording medium.

An eleventh aspect of this invention provides an image data reproducing apparatus comprising a reproducing section for reproducing first image data pieces, second image data pieces, and first menu picture data from a recording medium, the first menu picture data containing control information designed to allow switching from reproduction of the first image data pieces to reproduction of the second image data pieces or switching from reproduction of the second image data pieces to reproduction of the first image data pieces; a display section for indicating contents of the reproduced first image data pieces, contents of the reproduced second image data pieces, and contents of the reproduced first menu picture data; a menu indication inputting section for inputting a request to indicate a first menu picture represented by the first menu picture data; a menu control inputting section for inputting a request to select one from segments of the control information, contents of which are indicated by the display section, and a request to decide the selection of one from the segments; and a reproduction controlling section for controlling the display section to indicate the contents of the control information in the first menu picture data in cases where the first image data pieces are reproduced and then the contents of the first menu picture data are indicated by the display section in response to a request inputted via the menu indication inputting section, and for controlling the reproducing section to reproduce the second image data pieces on the basis of the control information in the first menu picture data in cases where one is selected from segments of the control information, contents of which are indicated by the display section, and the selection of one from the segments is decided by requests inputted via the menu control inputting section; the reproduction controlling section operating for controlling the display section to indicate the contents of the control information in the first menu picture data in cases where the second image data pieces are reproduced and then the contents of the first menu picture data are indicated by the display section in response to a request inputted via the menu indication inputting section, and for controlling the reproducing section to reproduce the first image data pieces on the basis of the control information in the first menu picture data in cases where one is selected from segments of the control information, contents of which are indicated by the display section, and the selection of one from the segments is decided by requests inputted via the menu control inputting section.

A twelfth aspect of this invention is based on the eleventh aspect thereof, and provides an image data reproducing apparatus wherein the reproducing section operates for reproducing second menu picture data from a recording medium, the second menu picture data containing control information designed to allow starting reproduction of the first image data pieces or the second image data pieces from a desired point or to allow selecting desired one from the first image data pieces or the second image data pieces and starting reproduction of the selected desired image data piece; wherein the display section operates for indicating the reproduced second menu picture data; and wherein the reproduction controlling section operates for controlling the display section to indicate the contents of the second menu picture data in response to a request inputted via the menu indication inputting section, and for controlling the reproducing section to start reproducing the first image data pieces or the second image data pieces on the basis of the control information in the second menu picture data in cases where one is selected from segments of the control information in the second menu picture data, contents of which are indicated by the display section, and the selection of one from the segments is decided by requests inputted via the menu control inputting section.

A thirteenth aspect of this invention is based on the eleventh aspect thereof, and provides an image data reproducing apparatus wherein the reproduction controlling section includes a memory and operates for controlling the reproducing section to suspend reproduction of a current image data piece in response to a request inputted via the menu indication inputting section, for generating reproduced picture identifying information indicating whether an image data piece reproduced before visualization of a first menu picture represented by the first menu picture data is one of the first image data pieces or one of the second image data pieces, for generating reproduction-suspension point information representing a position at which reproduction of the image data piece reproduced before visualization of the first menu picture is suspended, and for recording the reproduced picture identifying information and the reproduction-suspension point information into the memory; and wherein the reproduction controlling section operates for obtaining the reproduced picture identifying information and the reproduction-suspension point information from the memory in response to a request inputted via the menu control inputting section, for deciding a position, at which reproduction of the second image data pieces should be started, on the basis of the reproduction-suspension point information in cases where the reproduced picture identifying information indicates that the image data piece reproduced before visualization of the first menu picture is one of the first image data pieces, for deciding a position, at which reproduction of the first image data pieces should be started, on the basis of the reproduction-suspension point information in cases where the reproduced picture identifying information indicates that the image data piece reproduced before visualization of the first menu picture is one of the second image data pieces, and for controlling the reproducing section to start reproduction from the decided position.

A fourteenth aspect of this invention is based on the eleventh aspect thereof, and provides an image data reproducing apparatus wherein the reproducing section operates for reproducing first list files and second list files from the recording medium, the first list files corresponding to groups respectively, the second list files corresponding to the groups respectively; and wherein the reproduction controlling section operates for controlling the reproducing section to reproduce ones among the first image data pieces in a reproduction order and for reproduction intervals prescribed by at least one of the first list files, and for controlling the reproducing section to reproduce ones among the second image data pieces in a reproduction order and for reproduction intervals prescribed by at least one of the second list files.

A fifteenth aspect of this invention is based on the fourteenth aspect thereof, and provides an image data reproducing apparatus wherein the reproduction controlling section includes a memory and operates for controlling the reproducing section to suspend reproduction of a current image data piece in response to a request inputted via the menu indication inputting section, for generating reproduced picture identifying information indicating whether an image data piece reproduced before visualization of a first menu picture represented by the first menu picture data is one of the first image data pieces or one of the second image data pieces, and for recording the reproduced picture identifying information into the memory; and wherein the reproduction controlling section operates for obtaining the reproduced picture identifying information from the memory in response to a request inputted via the menu control inputting section, for controlling the reproducing section to start reproducing the second image data pieces in the same group as that having the image data piece reproduced before visualization of the first menu picture in cases where the reproduced picture identifying information indicates that the image data piece reproduced before visualization of the first menu picture is one of the first image data pieces, and for controlling the reproducing section to start reproducing the first image data pieces in the same group as that having the image data piece reproduced before visualization of the first menu picture in cases where the reproduced picture identifying information indicates that the image data piece reproduced before visualization of the first menu picture is one of the second image data pieces.

A sixteenth aspect of this invention is based on the eleventh aspect thereof, and provides an image data reproducing apparatus wherein the reproduction controlling section includes a first memory and a second memory and operates for controlling the reproducing section to suspend reproduction of a current image data piece in response to a request inputted via the menu indication inputting section, for generating reproduced picture identifying information indicating whether an image data piece reproduced before visualization of a first menu picture represented by the first menu picture data is one of the first image data pieces or one of the second image data pieces, for generating reproduction-suspension point information representing a position at which reproduction of the image data piece reproduced before visualization of the first menu picture is suspended, and for recording the reproduced picture identifying information and the reproduction-suspension point information into the first memory; wherein the reproduction controlling section operates for obtaining the reproduced picture identifying information and the reproduction-suspension point information from the first memory in response to a request inputted via the menu control inputting section, for deciding a position, at which reproduction of the second image data pieces should be started, on the basis of the reproduction-suspension point information and recording information indicative of start of reproduction of the second image data pieces into the second memory in cases where the reproduced picture identifying information indicates that the image data piece reproduced before visualization of the first menu picture is one of the first image data pieces, for deciding a position, at which reproduction of the first image data pieces should be started, on the basis of the reproduction-suspension point information and recording information indicative of start of reproduction of the first image data pieces into the second memory in cases where the reproduced picture identifying information indicates that the image data piece reproduced before visualization of the first menu picture is one of the second image data pieces, and for controlling the reproducing section to start reproduction from the decided position; wherein the reproducing section operates for reproducing second menu picture data from the recording medium, the second menu picture data containing control information designed to allow starting reproduction of the first image data pieces or the second image data pieces from a desired point or to allow selecting desired one from the first image data pieces or the second image data pieces and starting reproduction of the selected desired image data piece; wherein the display section operates for indicating contents of the reproduced second menu picture data; and wherein the reproduction controlling section operates for, in response to a request inputted via the menu indication inputting section, deciding whether contents of the first menu picture data or the second menu picture data should be indicated by the display section depending on the information in the second memory.

A seventeenth aspect of this invention is based on the sixteenth aspect thereof, and provides an image data reproducing apparatus wherein the reproducing section operates for reproducing first list files and second list files from the recording medium, the first list files corresponding to groups respectively, the second list files corresponding to the groups respectively; wherein the reproduction controlling section operates for controlling the reproducing section to reproduce ones among the first image data pieces in a reproduction order and for reproduction intervals prescribed by at least one of the first list files, and for controlling the reproducing section to reproduce ones among the second image data pieces in a reproduction order and for reproduction intervals prescribed by at least one of the second list files; wherein the reproduction controlling section operates for obtaining the reproduced picture identifying information from the first memory in response to a request inputted via the menu control inputting section, for controlling the reproducing section to start reproducing the second image data pieces in the same group as that having the image data piece reproduced before visualization of the first menu picture in cases where the reproduced picture identifying information indicates that the image data piece reproduced before visualization of the first menu picture is one of the first image data pieces, and for controlling the reproducing section to start reproducing the first image data pieces in the same group as that having the image data piece reproduced before visualization of the first menu picture in cases where the reproduced picture identifying information indicates that the image data piece reproduced before visualization of the first menu picture is one of the second image data pieces; wherein the reproduction controlling section operates for controlling the display section to indicate contents of the second menu picture data in response to a request inputted via the menu indication inputting section; and wherein the reproduction controlling section operates for controlling the reproducing section to start reproducing the first image data pieces or the second image data pieces in a desired group on the basis of the control information in the second menu picture data in cases where one is selected from segments of the control information in the second menu picture data, contents of which are indicated by the display section, and the selection of one from the segments is decided by requests inputted via the menu control inputting section.

An eighteenth aspect of this invention is based on the seventeenth aspect thereof, and provides an image data reproducing apparatus wherein the reproduction controlling section includes a third memory and operates for recording, into the third memory, information indicating whether an image data piece, start of reproduction of which is decided, is one of the first image data pieces or one of the second image data pieces when contents of the second menu picture data are indicated by the display section; and wherein the reproduction controlling section operates for, in response to a request inputted via the menu indication inputting section, deciding whether contents of the first menu picture data or the second menu picture data should be indicated by the display section depending on the information in the third memory.

A nineteenth aspect of this invention is based on the sixteenth aspect thereof, and provides an image data reproducing apparatus wherein the reproducing section operates for reproducing initial reproduction information from the recording medium, and the reproduction controlling section operates for controlling the display section to first indicate contents of the first menu picture data or the second menu picture data in accordance with the reproduced initial reproduction information.

This invention provides the advantages mentioned below. First image data pieces and second image data pieces are recorded on a recording medium. A request for indicating a reproduction change menu picture is inputted in order to prepare switching between the reproduction of the first image data pieces and the reproduction of the second image data pieces. The reproduction of the current image data piece is suspended upon the inputting of the request. At this time, information is recorded which represents whether the reproduction-suspended image data piece is one of the first image data pieces or one of the second image data pieces. Menu picture data is recorded on a recording medium. The menu picture data contains control information which can allow reproduction to be started from a position at which the reproduction of the image data piece is suspended. During the reproduction of the first image data pieces, information is recorded which represents that the first image data pieces are being reproduced. When a request for indicating a menu picture is inputted, the reproduction of the current first image data piece is suspended. Then, information representing the position at which the reproduction of the current first image data piece is suspended is recorded into a prescribed memory. Thereafter, the reproduction change menu picture is indicated. When reproduction change is selected in the indicated reproduction change menu picture and this selection is decided, the reproduction of one of the second image data pieces is started from a position corresponding to the position at which the reproduction of the first image data piece is suspended. Similarly, during the reproduction of the second image data pieces, information is recorded which represents that the second image data pieces are being reproduced. When a request for indicating a menu picture is inputted, the reproduction of the current second image data piece is suspended. Then, information representing the position at which the reproduction of the current second image data piece is suspended is recorded into the prescribed memory. Thereafter, the reproduction change menu picture is indicated. When reproduction change is selected in the indicated reproduction change menu picture and this selection is decided, the reproduction of one of the first image data pieces is started from a position corresponding to the position at which the reproduction of the second image data piece is suspended.

The first image data pieces may be main image data pieces while the second image data pieces may be digest image data pieces representing digests of pictures represented by the main image data pieces. In this case, switching between the reproduction of the main image data pieces and the reproduction of the digest image data pieces is performed immediately after the time point of the inputting of a request for indicating the reproduction change menu picture. The following actions can be taken. The reproduction of the digest image data pieces which allows a short-time grasp of the contents of the main image data pieces is started before the reproduction of the digest image data pieces is replaced by the reproduction of the main image data pieces at a desired point. The reproduction of the main image data pieces is started before the reproduction of the main image data pieces is replaced by the reproduction of the digest image data pieces at a desired point.

The first image data pieces (the main image data pieces) are classified into groups according to attribute information pieces thereabout. The second image data pieces (the digest image data pieces) are grouped in accordance with the grouping of the first image data pieces. A group of main image data pieces having desired attributes can be found during the reproduction of the digest image data pieces. When such a desired group of main image data pieces is found in this way, the reproduction of the digest image data pieces can be replaced by the reproduction of the main image data pieces in the found group. Thereafter, the reproduction of the main image data pieces in the found group can be replaced by the reproduction of the digest image data pieces.

Thumbnail menu picture data representing a thumbnail menu picture is recorded on the recording medium. The thumbnail menu picture data allows starting the reproduction of the first image data pieces or the second image data pieces from a desired point or a desired group. The thumbnail menu picture data further allows starting the reproduction of desired one selected from the first image data pieces and the second image data pieces. Initial reproduction information is recorded on the recording medium. The initial reproduction information prescribes that the thumbnail menu picture should be indicated first upon the start of the reproduction of recorded data from the recording medium. Thus, according to the initial reproduction information, the thumbnail menu picture is indicated first upon the start of the reproduction of recorded data from the recording medium. Then, the reproduction of the first image data pieces or the second image data pieces can be started from a desired point. The thumbnail menu picture data contains control information denoting a command to record, into a memory, information representing whether one of the first image data pieces or one of the second image data pieces is selected and reproduced. In the case where a request for indicating a menu picture is inputted after the original image data piece is selected and the reproduction thereof is started, the thumbnail menu picture is indicated. On the other hand, in the case where a request for indicating a menu picture is inputted after a digest image data piece is selected and the reproduction thereof is started, the reproduction change menu picture is indicated. Thus, it is possible to designate which of the reproduction change menu picture and the thumbnail menu picture should be indicated depending on whether the image data piece selected in the reproduction change menu picture and then reproduced is one of the first image data pieces or one of the second image data pieces.

### BRIEF DESCRIPTION OF THE DRAWINGS

FIG. 1 is a diagram of an image data recording apparatus according to a first embodiment of this invention.

FIG. 2 is a diagram showing an example of main image data pieces, and an example of the grouping of the main image data pieces.

FIG. 3 is a diagram of an example of the structure of a main list file.

FIG. 4 is a diagram of an example of the directory structure for data recorded on a recording medium in FIG. 1.

FIG. 5 is a diagram of an example of main image data pieces in a first group, and cuts extracted from the main image data pieces to form digest image data pieces in the first group.

FIG. 6 is a diagram of an example of main image data pieces in a second group, and cuts extracted from the main image data pieces to form digest image data pieces in the second group.

FIG. 7 is a diagram of an example of main image data pieces in a third group, and cuts extracted from the main image data pieces to form digest image data pieces in the third group.

FIG. 8 is a diagram of an example of the structure of a digest list file.

FIG. 9 is a diagram of an example of a thumbnail menu picture.

FIG. 10 is a diagram of an example of a reproduction change menu picture.

FIG. 11 is a diagram of an example of the assignment of the 8 higher bits in a 16-bit command information piece to portions of command information.

FIG. 12 is a diagram of an example of the logic states of 4-bit commands used regarding button pictures in the thumbnail menu picture, and the meanings of the respective commands.

FIG. 13 is a diagram of an example of the logic states of 4-bit commands used regarding button pictures in the reproduction change menu picture, and the meanings of the respective commands.

FIG. 14 is a block diagram of the image data recording apparatus in the first embodiment of this invention.

FIG. 15 is a flowchart of a first segment of a control program for a computer in FIG. 14.

FIG. 16 is a flowchart of a second segment of the control program for the computer in FIG. 14.

FIG. 17 is a diagram of an image data reproducing apparatus according to the first embodiment of this invention.

FIG. 18 is a block diagram of the image data reproducing apparatus in the first embodiment of this invention.

FIG. 19 is a flowchart of a first segment of a control program for a computer in FIG. 18.

FIG. 20 is a flowchart of a second segment of the control program for the computer in FIG. 18.

FIGS. 21 and 22 are a flowchart of a third segment of the control program for the computer in FIG. 18.

FIG. 23 is a diagram of an image data recording and reproducing apparatus according to a second embodiment of this invention.

FIGS. 24 and 25 are a flowchart of a segment of a control program for a computer in an image data reproducing apparatus according to a third embodiment of this invention.

### DETAILED DESCRIPTION OF THE INVENTION

### First Embodiment

Each main image data piece represents pictures taken by, for example, a video camera during every shooting. Each main image data piece may have sound-representing components and other-information-representing components in addition to picture-representing components. The pictures represented by each main image data piece are moving pictures, still pictures, or a mixture of moving pictures and still pictures. Each main image data piece is a main image data sequence, a main image data block, or a main image data file.

Digest image data pieces correspond to main image data pieces, respectively. Each digest image data piece is formed by a portion of the corresponding main image data piece. Each digest image data piece represents a digest of pictures represented by the corresponding main image data piece. Each digest image data piece may have sound-representing components and other-information-representing components in addition to picture-representing components. The picture digest represented by each digest image data piece means a digest of moving pictures, a digest of still pictures, or a digest of a mixture of moving pictures and still pictures. Each digest image data piece is a digest image data sequence, a digest image data block, or a digest image data file.

Main image data pieces are referred to as first image data pieces also. Digest image data pieces are referred to as second image data pieces also. The second image data pieces correspond to the first image data pieces, respectively. Each second image data piece is formed by a portion of the corresponding first image data piece.

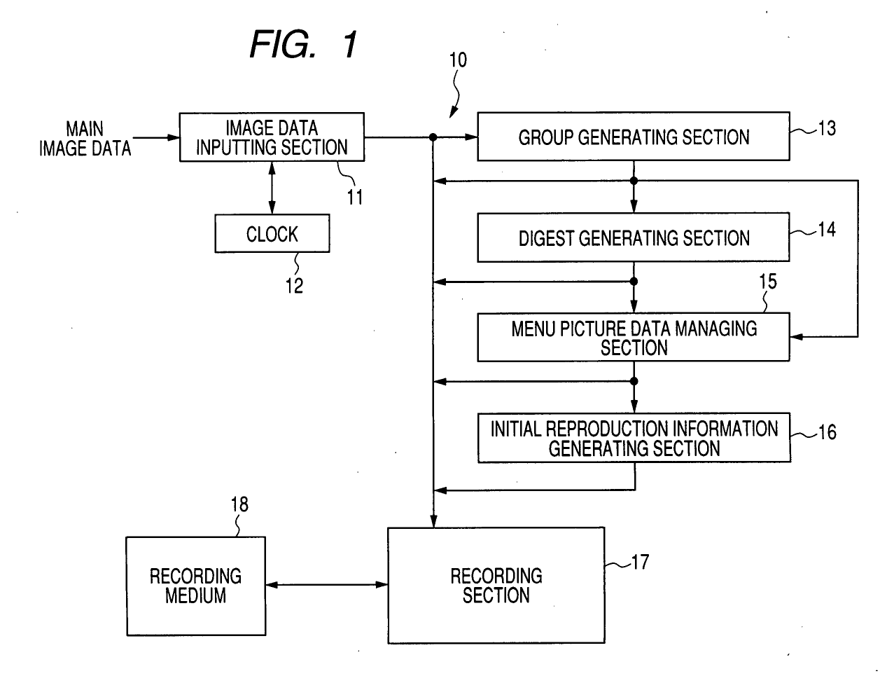

FIG. 1 shows an image data recording apparatus 10 according to a first embodiment of this invention. It should be noted that a portion of FIG. 1 shows the operation of the image data recording apparatus 10 rather than the hardware structure thereof. The image data recording apparatus 10 serves to record main image data pieces, main list files, digest list files, thumbnail menu picture data, reproduction change menu picture data, and initial reproduction information on a recording medium 18.

With reference to FIG. 1, there are an image data inputting section 1 1, a clock 12, a group generating section 13, a digest generating section 14, a menu picture data managing section 15, an initial reproduction information generating section 16, and a recording section 17.

Each main image data piece is inputted to the image data inputting section 11. By referring to the output signal from the clock 12, the image data inputting section 11 detects the date and time (the inputting date and time) at which each main image data piece is inputted thereto. The image data inputting section 11 adds, to the inputted main image data piece, an information piece representing the inputting date and time and an information piece representing the file name or the ID number of the inputted main image data piece. The image data inputting section 11 sends the resultant main image data piece to the group generating section 13 and the recording section 17.

The group generating section 13 successively receives main image data pieces from the image data inputting section 11. The group generating section 13 classifies the received main image data pieces into groups according inputting date and time. The group generating section 13 generates main list files for the respective groups. The group generating section 13 assigns different ID numbers (different file names) to the generated main list files respectively. Each main list file is a list of the file names (or the ID numbers) of main image data pieces belonging to the corresponding group. The group generating section 13 notifies the generated main list files to the digest generating section 14, the menu picture data managing section 15, and the recording section 17.

The digest generating section 14 generates digest list files on the basis of the main list files for the groups, respectively. The digest generating section 14 assigns different ID numbers (different file names) to the generated digest list files respectively. Each of the digest list files is a list of the addresses (the positions) of digest segments, that is, portions of the main image data pieces which are to be used as digest image data pieces. The digest generating section 14 notifies the generated digest list files to the menu picture data managing section 15 and the recording section 17.

The ID numbers of a main list file and a digest list file corresponding to a same group have the following relation. The ID number of the digest list file is equal to the ID number of the main list file plus “100”. Thus, the ID number of the main list file is equal to the ID number of the digest list file minus “1100”. For example, when the ID number of the main list file plus is “001”, the ID number of the digest list file is “101”.

The digest generating section 14 may actually generate digest image data pieces from the main image data pieces. In this case, the digest generating section 14 sends the generated digest image data pieces to the recording section 17.

The menu picture data managing section 15 generates reproduction change menu picture data and thumbnail menu picture data on the basis of the main list files and the digest list files. The reproduction change menu picture data has a main portion representing a reproduction change menu picture and a sub portion including control information. The thumbnail menu picture data has a main portion representing a thumbnail menu picture and a sub portion including control information. The menu picture data managing section 15 sends the reproduction change menu picture data and the thumbnail menu picture data to the recording section 17.

The initial reproduction information generating section 16 generates initial reproduction information inclusive of control information. The initial reproduction information is designed for use by an image data reproducing apparatus when recorded data is reproduced from the recording medium 18 for the first time or when a command to indicate a menu is inputted into the image data reproducing apparatus. The initial reproduction information forms computer program portions which can be used by the image data reproducing apparatus. The initial reproduction information generating section 16 sends the initial reproduction information to the recording section 17.

The recording section 17 records the main image data pieces, the main list files, the digest list files, the reproduction change menu picture data, the thumbnail menu picture data, and the initial reproduction information on the recording medium 18. The recording section 17 may further record the digest image data pieces on the recording medium 18.

The recording medium 18 is provided in the image data recording apparatus 10. The recording medium 18 may be provided outside the image data recording apparatus 10. The recording medium 18 is removable or unremovable from the body of the image data recording apparatus 10. Examples of the recording medium 18 are a hard disc, a DVD, a Blu-ray disc, another optical disc, a magnetic tape, a nonvolatile memory, and a memory medium.

The grouping of the main image data pieces may be omitted from operation of the image data recording apparatus 10. The grouping of the main image data pieces may be implemented by an apparatus different from the image data recording apparatus 10. In these cases, the group generating section 13 is omitted from the image data recording apparatus 10.

The digest list file may be generated by an apparatus different from the image data recording apparatus 10. In this case, the digest generating section 14 is omitted from the image data recording apparatus 10.

A more detailed description of the image data recording apparatus 10 will follow. In the case where the image data recording apparatus 10 is provided in a digital camera or a digital video camera, the image data inputting section 11 includes an imager and an encoder. The imager has a lens and an imaging element array provided with a CCD or CMOS array. The imager generates signal data representing captured images. The encoder encodes the signal data generated by the imager into a main image data piece.

The image data inputting section 11 may be designed to read image signals from a recording medium other than the recording medium 18 and encode the read image signals into main image data pieces respectively. In this case, the image data inputting section 11 includes an accessing unit for successively reading recorded signals from the recording medium. The accessing unit is a magnetic head when the recording medium is a hard disc. The accessing unit is an optical pickup when the recording medium is an optical disc. The accessing unit is a reader when the recording medium is a memory. The image data inputting section 11 further includes a unit for controlling the position of the accessing unit relative to the recording medium, a motor for rotating the recording medium, a unit for controlling rotation of the motor (that is, rotation of the recording medium), a signal processor for subjecting every signal read from the recording medium by the accessing unit to demodulation, and an encoder for encoding every demodulation-result signal into a main image data piece in conformity with the MPEG2 standards or the MPEG4-AVC/H.264 standards.

The image data inputting section 11 may be designed to receive coded image data pieces from an apparatus other than the image data recording apparatus 10 as main image data pieces. In this case, the image data inputting section 11 includes an interface of the Ethernet type or the USB type.

The image data inputting section 11 may be designed to read main image data pieces from the recording medium 18. In this case, the image data inputting section 11 includes a reproducing device for reading the main image data pieces from the recording medium 18.

For every inputted main image data piece, the image data inputting section 11 obtains a date and time information piece from the clock 12. The obtained date and time information piece represents the date and time (the inputting date and time) at which the main image data piece is inputted to the image data inputting section 11. The image data inputting section 11 places the date and time information piece in a field prescribed by a data recording format for the recording medium 18 or a picture format. Examples of the field is a header of the main image data piece or a prescribed area in a management information file.

The inputting date and time may be replaced by the recording date and time. Specifically, the image data inputting section 11 obtains a date and time information piece from the clock 12 each time the recording section 17 records a main image data piece on the recording medium 18. In this case, the obtained date and time information piece represents the date and time (the recording date and time) at which the main image data piece is recorded on the recording medium 18. The image data inputting section 11 places the date and time information piece in the previously-mentioned field.

In the case where the header of each inputted main image data piece already has the date and time information piece representing the inputting date and time or the recording date and time, it is unnecessary to obtain a new date and time information piece from the clock 12 and place the new date and time information piece in the previously-mentioned field. In this case, the clock 12 may be omitted from the image data recording apparatus 10.

The image data inputting section 11 successively sends main image data pieces inclusive of respective date and time information pieces to the group generating section 13.

The group generating section 13 classifies the main image data pieces from the image data inputting section 11 into groups according to the date and time information pieces therein.

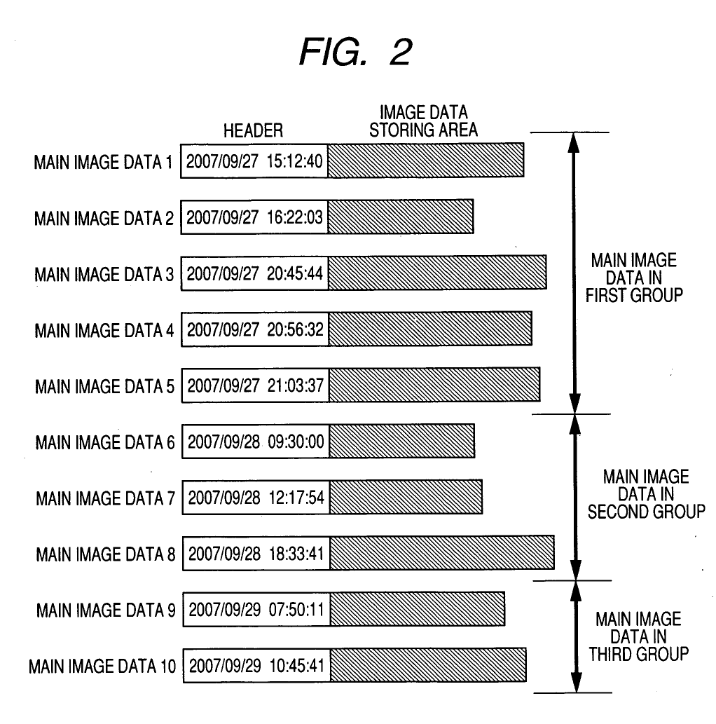

With reference to FIG. 2, there are main image data pieces “1”, “2”, . . . , and “10” arranged in the order of date and time and each having a header and an image data storing area following the header. The headers of the main image data pieces “1”, “2”, . . . , and “10” store date and time information pieces, respectively. Each of the date and time information pieces represents the inputting date and time or the recording date and time of the corresponding main image data piece. The group generating section 13 obtains the date and time information pieces from the headers of the main image data pieces “1”, “2”, . . . , and “10”, and classifies the main image data pieces “1”, “2”, . . . , and “10” into groups according to the dates and times represented by the date and time information pieces therein. The classification is on a day-dependent basis. Specifically, the main image data pieces “1”, “2”, “3”, “4”, and “5” each having a date and time in a day of Sep. 27, 2007 are separated into a first group. The main image data pieces “6”, “7”, and “8” each having a date and time in a day of Sep. 28, 2007 are separated into a second group. The main image data pieces “9” and “10” each having a date and time in a day of Sep. 29, 2007 are separated into a third group.

The main image data pieces “1”, “2”, . . . , and “10” may be grouped in one of the following other ways. In the first other way, the main image data pieces “1”, “2”, . . . , and “10” are classified into 6 groups corresponding to the morning of Sep. 27, 2007, the afternoon of Sep. 27, 2007, the morning of Sep. 28, 2007, the afternoon of Sep. 28, 2007, the morning of Sep. 29, 2007, and the afternoon of Sep. 29, 2007 respectively. In the second other way, the main image data pieces “1”, “2”, . . . , and “10” are classified into groups corresponding to different fixed time ranges respectively.

In the third other way, the main image data pieces “1”, “2”, . . . , and “10” are classified into groups according to the intervals in date and time therebetween. The inputting or recording dates and times of the main image data pieces “1”, “2”, . . . , and “10” are labeled as the starting dates and times thereof. The play times of the main image data pieces “1”, “2”, . . . , and “10” are detected. The ending dates and times of the main image data pieces “1”, “2”, . . . , and “10” are calculated by adding the detected play times to the starting dates and times. The time intervals between the main image data pieces “1”, “2”, . . . , and “10” are calculated by subtracting the ending dates and times from the subsequent starting dates and times. For example, when the main image data piece “1” has a play time of 2 minutes and 30 seconds, the ending date and time of the main image data piece “1” is equal to 15-hour 15-minute 10-second in Sep. 27, 2007, that is, 2 minutes and 30 seconds plus 15-hour 12-minute 40-second in Sep. 27, 2007 (the starting date and time). The starting date and time of the main image data piece “2” is 16-hour 22-minute 3-second in Sep. 27, 2007. The difference between the ending date and time of the main image data piece “1” and the starting date and time of the main image data piece “2” is equal to 1 hour, 6 minutes, and 53 seconds. This difference is labeled as the interval between the main image data pieces “1” and “2”. The intervals between the main image data pieces “1”, “2”, . . . , and “10” are compared with a fixed value equal to, for example, 6 hours or 12 hours. Preferably, a signal representing the fixed value is stored in a memory provided in the group generating section 13. When the interval between two neighboring main image data pieces is equal to or greater than the fixed value, the main image data pieces are separated into different groups respectively. On the other hand, when the interval between two neighboring main image data pieces is smaller than the fixed value, the main image data pieces are placed in a same group.

The image data recording apparatus 10 may be provided with a GPS receiver. In this case, for every generated main image data piece, the image data inputting section 11 obtains a positional information piece from the GPS receiver. The obtained positional information piece represents the position (the shooting position) at which the shooting to generate the main image data piece is performed. The image data inputting section 11 places the positional information piece in the previously-mentioned field. In this case, the group generating section 13 may classify the main image data pieces from the image data inputting section 11 into groups according to the positional information pieces therein rather than the date and time information pieces. Specifically, the group generating section 13 computes the distances among the shooting positions of the main image data pieces. The group generating section 13 compares the computed distances with a fixed value. Preferably, a signal representing the fixed value is stored in a memory provided in the group generating section 13. When the distance between the shooting positions of two main image data pieces is equal to greater than the fixed value, the main image data pieces are separated into different groups respectively. On the other hand, when the distance between the shooting positions of two main image data pieces is smaller than the fixed value, the main image data pieces are placed in a same group.

The image data recording apparatus 10 may be provided with an operation unit which can be actuated by a user. In this case, for each main image data piece, the user inputs an attribute information piece into the image data recording apparatus 10 by actuating the operation unit. The attribute information piece represents the quality of images represented by the main image data piece and the type of the main image data piece. In this case, the group generating section 13 may classify the main image data pieces from the image data inputting section 11 into groups according to the attribute information pieces rather than the date and time information pieces.

It should be noted that the date and time information pieces may be incorporated into the attribute information pieces. In this case, the group generating section 13 classifies the main image data pieces into groups according to the attribute information pieces.

The grouping of main image data pieces may be designed so that the number of main image data pieces in each group will always be equal to a predetermined value (for example, 10). The grouping of main image data pieces may be designed so that the main image data pieces will be separated into a predetermined number of groups, and that the number of main image data pieces in each of the groups will be equal to a same value. Preferably, a signal representing the predetermined group number is stored in a memory provided in the group generating section 13. Main image data pieces may be separated into groups so that the number of main image data pieces in each of the groups will be approximately equal to a same value. Preferably, a signal representing the same value is stored in a memory provided in the group generating section 13.

The group generating section 13 generates main list files for the respective groups, and records the generated main list files on the recording medium 18 through the use of the recording section 17. The main list files have a predetermined format or structure. The group generating section 13 gives different file names (or different ID numbers) to the main list files respectively. For example, the group generating section 13 gives the file name “list file 001” to the main list file for the first group.

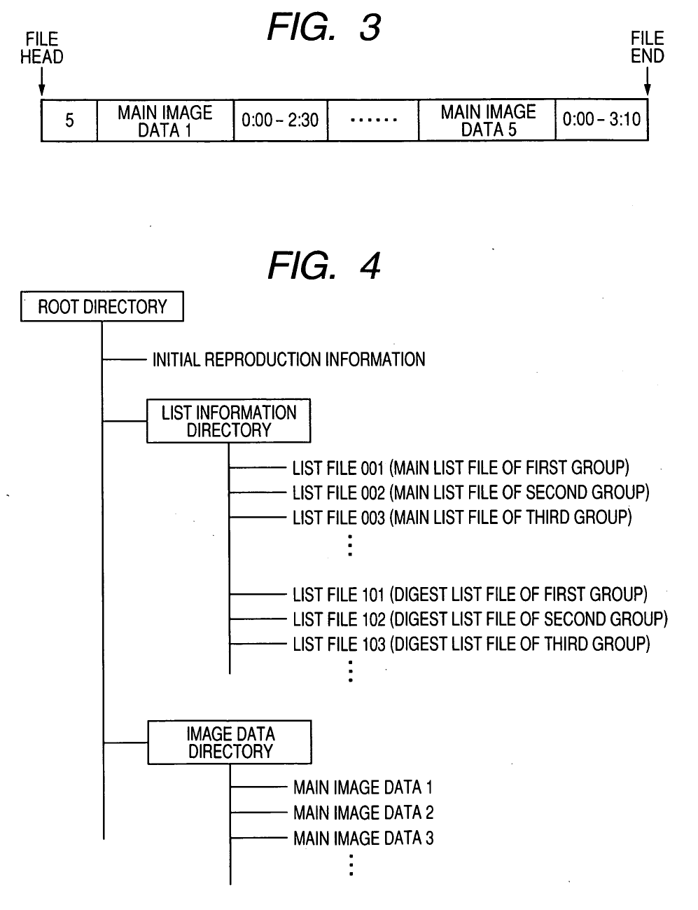

FIG. 3 shows an example of the structure of the main list file for the first group in FIG. 2. As shown in FIG. 3, the main list file is divided into sequentially-arranged segments representing “5” (the number of the main image data pieces in the first group), the file name of the main image data piece “1” (the file name of the first one among the main image data pieces in the first group), “0:00-2:30” (the reproduction range for the first one among the main image data pieces in the first group), the file name of the second one among the main image data pieces in the first group, the reproduction range for the second one among the main image data pieces in the first group, . . . , the file name of the main image data piece “5” (the file name of the last one among the main image data pieces in the first group), and “0:00-3:10” (the reproduction range for the last one among the main image data pieces in the first group), respectively.

In each main list file, the file names of the main image data pieces may be replaced by information pieces for identifying the main image data pieces. In each main list file, the file names of the main image data pieces may be replaced by information pieces representing the on-recording-medium places in which the main image data pieces are recorded respectively. In each main list file, the file names of the main image data pieces may be replaced by the file name of another file storing information pieces for identifying the main image data pieces.

The reproduction range for a main image data piece means the reproduction interval or the play interval between the start of the reproduction (playback) of the main image data piece and the end thereof. The reproduction range may be the on-file position of the main image data piece. The reproduction range may be the number of bytes, the number of GOPs, or the number of frames of the main image data piece which is measured from its head. The reproduction range may be the time elapsed from the moment corresponding to the head of the main image data piece.

The reproduction range for a main image data piece may be expressed by a pair of the reproduction start position and the reproduction end position. The reproduction range may be expressed by a pair of the reproduction start position and the length of the reproduction interval without using the reproduction end position.

In the case where each main image data piece is always reproduced from its head to its tail, the reproduction ranges may be omitted from the main list files.

The group generating section 13 gives the file name “list file 002” to the main file list for the second group. The main list file for the second group in FIG. 2 is divided into sequentially-arranged segments representing “3” (the number of the main image data pieces in the second group), the file name of the main image data piece “6” (the file name of the first one among the main image data pieces in the second group), the reproduction range for the first one among the main image data pieces in the second group, the file name of the second one among the main image data pieces in the second group, the reproduction range for the second one among the main image data pieces in the second group, . . . , the file name of the main image data piece “8” (the file name of the last one among the main image data pieces in the second group), and the reproduction range for the last one among the main image data pieces in the second group, respectively.

The group generating section 13 gives the file name “list file 003” to the main file list for the third group. The main list file for the third group in FIG. 2 is divided into sequentially-arranged segments representing “2” (the number of the main image data pieces in the third group), the file name of the main image data piece “9” (the file name of the first one among the main image data pieces in the third group), the reproduction range for the first one among the main image data pieces in the third group, the file name of the main image data piece “10” (the file name of the last one among the main image data pieces in the third group), and the reproduction range for the last one among the main image data pieces in the third group, respectively.

As previously mentioned, the group generating section 13 generates the main list files for the respective groups, and records the generated main list files on the recording medium 18 through the use of the recording section 17.

The order along which the file names and the reproduction ranges are sequentially arranged in each main list file will be used as the order of sequential reproduction of the main image data pieces mentioned therein.

With reference to FIG. 4, the recording medium 18 is provided with a route directory under which a list information directory and an image data directory are located. Preferably, the main list files are recorded on a recording-medium domain under the list information directory.

The digest generating section 14 generates digest list files for the respective groups on the basis of the main list files generated by the group generating section 13. The structure of the digest list files is similar to that of the main list files. The digest generating section 14 records the digest list files on the recording medium 18 through the use of the recording section 17. Preferably, the digest list files are recorded on the recording-medium domain under the list information directory as shown in FIG. 4.

Digest image data pieces are formed by extracting portions from the main image data pieces. The portions are called the cuts also. The extracted portions or cuts are sequentially connected to form a sequence of the digest image data pieces. The contents of the sequence of the digest image data pieces are continuously reproduced or played back.

The digest generating section 14 sets a total digest play time to a prescribed value equal to, for example, 1 minute. The digest generating section 14 may set the total digest play time depending on the total play time of the main image data pieces.

The image data recording apparatus 10 may be provided with a display in addition to the operation unit. Numeral keys may be formed on the operation unit. In this case, the total digest play time may be decided by actuating the numeral keys on the operation unit.

The image data recording apparatus 10 may be provided with a GUI (Graphical User Interface) associated with the operation unit and the display. In this case, the operation unit has selection keys and a decision key. The selection keys are, for example, cross keys. A GUI-based picture for inputting the total digest play time is indicated on the display. The selection keys and the decision key on the operation unit are actuated to decide the total digest play time.

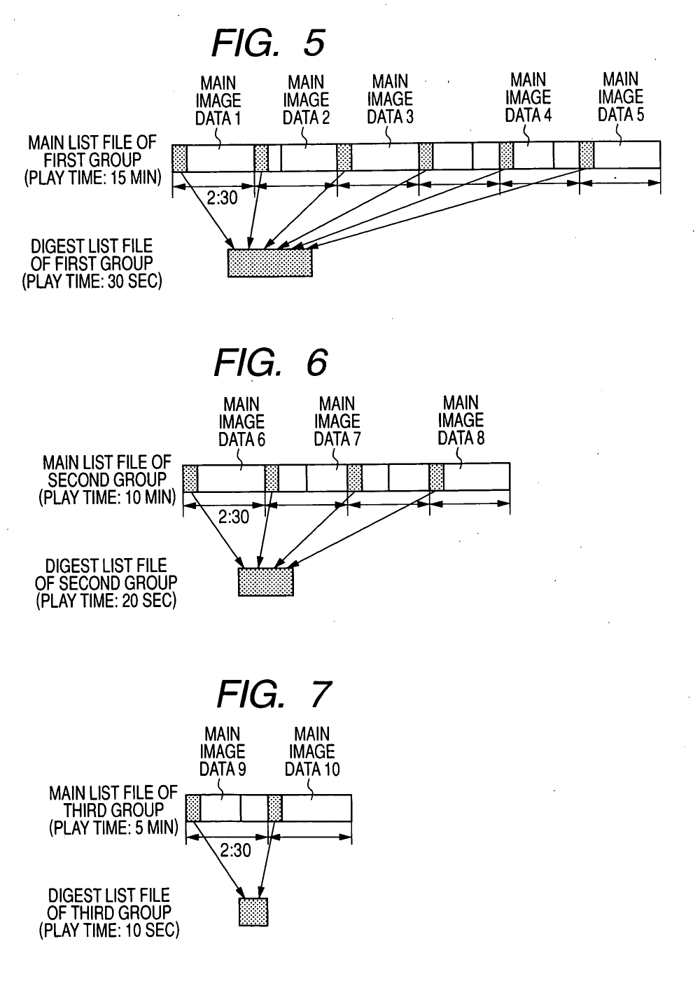

The digest generating section 14 distributes the total digest play time to the groups. Preferably, the distribution of the total digest play time to the groups depends on the ratio in play time among the groups. As shown in FIG. 5, the sum of the play times of the main image data pieces “1”, “2”, “3”, “4”, and “5” in the first group is equal to 15 minutes. As shown in FIG. 6, the sum of the play times of the main image data pieces “6”, “7”, and “8” in the second group is equal to 10 minutes. As shown in FIG. 7, the sum of the play times of the main image data pieces “9” and “10” in the third group is equal to 5 minutes. Accordingly, the ratio in play time among the first, second, and third groups is 3:2:1. The digest generating section 14 divides a total digest play time of 1 minute (60 seconds) into 30 seconds, 20 seconds, and 10 seconds in accordance with the above-indicated ratio “3:2:1”. The digest generating section 14 assign 30 seconds, 20 seconds, and 10 seconds to the first, second, and third groups respectively as per-group digest play times. Preferably, one cut has a play time of 5 seconds. In this case, the digest generating section 14 assigns 6 cuts, 4 cuts, and 2 cuts to the first, second, and third groups, respectively.

The digest generating section 14 may set the play time of one cut to a value depending on the total play time of the main image data pieces in all the groups. The play time of one cut may be decided by the user through the actuation of the numeral keys on the operation unit.

For each of the groups, the digest generating section 14 decides positions in the in-group main image data pieces from which cuts should be extracted respectively. Specifically, for each of the groups, the digest generating section 14 virtually connects the in-group main image data pieces in series. Then, the digest generating section 14 decides equally-spaced positions in the series of the in-group main image data pieces to be positions from which cuts should be extracted. The first one of the equally-spaced positions coincides with the position of the head of the series.

As previously mentioned, for the first group, the sum of the play times of the in-group main image data pieces is equal to 15 minutes, and 6 cuts should be extracted from the in-group main image data pieces. Thus, as shown in FIG. 5, the digest generating section 14 decides 6 positions in the series of the in-group main image data pieces to be those from which 6 cuts should be extracted respectively. The 6 positions are spaced at intervals of 2 minutes and 30 seconds, and start from the head of the series. Each of the cuts has a play time of 5 seconds.

For the second group, the sum of the play times of the in-group main image data pieces is equal to 10 minutes, and 4 cuts should be extracted from the in-group main image data pieces. Thus, as shown in FIG. 6, the digest generating section 14 decides 4 positions in the series of the in-group main image data pieces to be those from which 4 cuts should be extracted respectively. The 4 positions are spaced at intervals of 2 minutes and 30 seconds, and start from the head of the series. Each of the cuts has a play time of 5 seconds.

For the third group, the sum of the play times of the in-group main image data pieces is equal to 5 minutes, and 2 cuts should be extracted from the in-group main image data pieces. Thus, as shown in FIG. 7, the digest generating section 14 decides 2 positions in the series of the in-group main image data pieces to be those from which 2 cuts should be extracted respectively. The 2 positions are spaced at an interval of 2 minutes and 30 seconds, and start from the head of the series. Each of the cuts has a play time of 5 seconds.

The digest generating section 14 may actually extract the cuts from the in-group main image data pieces, and connect the extracted cuts in series to generate an actual digest image data piece for each of the first, second, and third groups. In this case, the digest generating section 14 re-encodes the series of the extracted cuts to generate actual data forming the digest image data piece for each of the first, second, and third groups. The digest generating section 14 sends the generated digest image data pieces to the recording section 17.

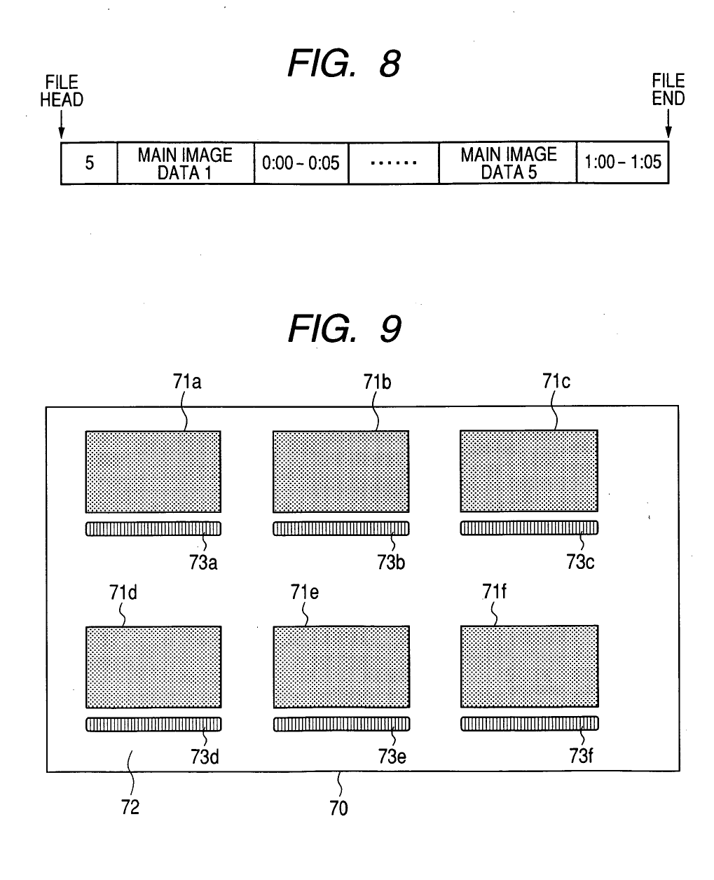

Preferably, instead of generating actual data forming the digest image data piece for the first group, the digest generating section 14 generates a digest list file having a structure shown in FIG. 8. The digest list file structure in FIG. 8 is similar to the main list file structure in FIG. 3. The digest generating section 14 gives the file name “list file 101” to the digest list file for the first group. With reference to FIG. 8, the digest list file has segments representing the number of cuts for the first group, the sequentially-arranged file names of the main image data pieces from which the cuts should be extracted, and the sequentially-arranged reproduction ranges for the cuts. Thus, the digest list file mentions the digest image data pieces (the cuts to be extracted from the main image data pieces). In the digest list file, the file names of the main image data pieces may be replaced by information pieces for identifying the main image data pieces. The reproduction range for a cut means the reproduction interval or the play interval between the start of the reproduction (playback) of the corresponding portion of the original main image data piece and the end thereof. Preferably, the reproduction range is expressed by the on-file position of the corresponding portion of the original main image data piece. In the case where the play time of each cut is set to 5 seconds, each reproduction range may be expressed by only the reproduction start position. In this case, an image data reproducing apparatus is designed to implement reproduction for 5 seconds from each reproduction start position. The order along which the file names and the reproduction ranges are sequentially arranged in the digest list file will be used as the order of sequential reproduction of the cuts described therein.

The digest generating section 14 generates a digest list file for the second group which is similar to that for the first group. The digest generating section 14 gives the file name “list file 102” to the digest list file for the second group. The digest list file has segments representing the number of cuts for the second group, the sequentially-arranged file names of the main image data pieces from which the cuts should be extracted, and the sequentially-arranged reproduction ranges for the cuts. Thus, the digest list file mentions the digest image data pieces (the cuts to be extracted from the main image data pieces).

The digest generating section 14 generates a digest list file for the third group which is similar to that for the first group. The digest generating section 14 gives the file name “list file 103” to the digest list file for the third group. The digest list file has segments representing the number of cuts for the third group, the sequentially-arranged file names of the main image data pieces from which the cuts should be extracted, and the sequentially-arranged reproduction ranges for the cuts. Thus, the digest list file mentions the digest image data pieces (the cuts to be extracted from the main image data pieces).

The digest generating section 14 records the generated digest list files for the respective groups on the recording medium 18 through the use of the recording section 17. The digest generating section 14 may further record the generated digest image data pieces for the respective groups on the recording medium 18 through the use of the recording section 17. Preferably, as shown in FIG. 4, the digest list files are recorded on the recording-medium domain under the list information directory. As previously mentioned, the main list files are also recorded on the recording-medium domain under the list information directory.

The recording section 17 records the main image data pieces, which are referred to by the recorded main list files and the recorded digest list files, on the recording medium 18 in a domain under the image data directory (see FIG. 4). Even for a main image data piece referred to by both a recorded main list file and a recorded digest list file, the main image data piece is recorded on the recording medium 18 as a single file under the image data directory. In other words, two files of the main image data pieces, that is, a file to be referred to by the recorded main list file and a file to be referred to by the recorded digest list file, are not recorded on the recording medium 18. This design results in a reduction of the used capacity of the recording medium 18. The recorded main image data pieces in the recording medium 18 are referred to by the main list files and the digest list files.

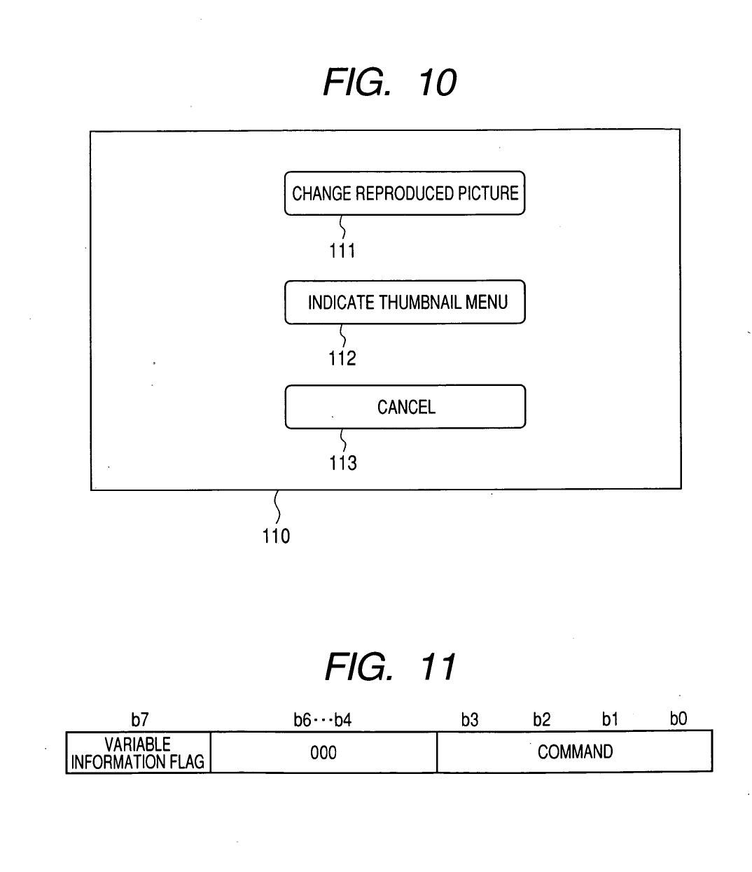

The menu picture data managing section 15 generates thumbnail menu picture data representative of a thumbnail menu picture 70 (see FIG. 9) and inclusive of control information, and reproduction change menu picture data representative of a reproduction change menu picture 110 (see FIG. 10) and inclusive of control information on the basis of the main list files and the digest list files generated by the group generating section 13 and the digest generating section 14. The menu picture data managing section 15 records the generated thumbnail menu picture data and the generated reproduction change menu picture data on the recording medium 18 through the use of the recording section 17.

The thumbnail menu picture 70 represented by the thumbnail menu picture data, the control information in the thumbnail menu picture data, the reproduction change menu picture 110 represented by the reproduction change menu picture data, and the control information in the reproduction change menu picture data may be uniquely predetermined and recorded on every recording medium. In this case, the menu picture data managing section 15 includes a memory storing the thumbnail menu picture data and the reproduction change menu picture data. The thumbnail menu picture data and the reproduction change menu picture data are read from the memory before being recorded on the recording medium 18.

FIG. 9 shows an example of the thumbnail menu picture 70 represented by the thumbnail menu picture data. The thumbnail menu picture 70 is designed so that one can be selected from main list files and digest list files, and reproduction will be started regarding the selected list file. The thumbnail menu picture data contains display picture information and the control information. The display picture information represents the thumbnail menu picture 70. The display picture information conforms to the format for the recorded and reproduced image data pieces. As shown in FIG. 9, the thumbnail menu picture 70 consists of thumbnail pictures 71a-71f, a background picture 72, and button pictures 73a-73f. The thumbnail menu picture 70 may have a cursor. Preferably, the thumbnail pictures 71a-71f are arranged in rows and columns. The button pictures 73a-73f are located directly below the thumbnail pictures 71a-71f, respectively. The thumbnail pictures 71a-71f and the button pictures 73a-73f extend in the background picture 72.

The thumbnail picture 71a is a reduced picture originating from one picture represented by the main image data pieces in the first group. The thumbnail picture 71b is a reduced picture originating from one picture represented by the main image data pieces in the second group. The thumbnail picture 71c is a reduced picture originating from one picture represented by the main image data pieces in the third group. The thumbnail picture 71d is a reduced picture originating from one picture represented by the cuts of the main image data pieces in the first group. The thumbnail picture 71e is a reduced picture originating from one picture represented by the cuts of the main image data pieces in the second group. The thumbnail picture 71f is a reduced picture originating from one picture represented by the cuts of the main image data pieces in the third group.

Accordingly, the thumbnail pictures 71a, 71b, and 71c correspond to the main list files, respectively. The thumbnail pictures 71d, 71e, and 71f correspond to the digest list files, respectively.

The control information in the thumbnail menu picture data is designed to enable the button pictures 73a-73f to be used for controlling reproduction. The button pictures 73a-73f are associated or related with the thumbnail pictures 71a-71f, respectively. Thus, the number of the button pictures 73a-73f is equal to that of the thumbnail pictures 71a-71f.

The display picture information representing the thumbnail pictures 71a-71f, the background picture 72, and the button pictures 73a-73f include first information pieces indicating the contents of the pictures 71a-71f, 72, and 73a-73f, and second information pieces indicating the positions of the pictures 71a-71f, 72, and 73a-73f relative to the display screen.

The thumbnail pictures 71a-71f and the button pictures 73a-73f are indicated in such a manner as to make it clear that the button pictures 73a-73f are related with the thumbnail pictures 71a-71f respectively. The button pictures 73a-73f may be located at one sides (for example, right-hand sides) of the thumbnail pictures 71a-71f, respectively. Alternatively, the button pictures 73a-73f may be located at borders enclosing the thumbnail pictures 71a-71f, respectively. The file name of each of the main list files and the digest list files, the date and time at which each of the main list files and the digest list files is generated, the inputting date and time or the recording date and time of each main image data piece may be additionally indicated in the thumbnail menu picture 70.

The control information in the thumbnail menu picture data relates to the button pictures 73a-73f and has segments which represent control commands and statuses as follows:
the number of buttons=6:
(a) picture selection button 73a:

up button=none;

down button=move to button 73d;

right button=move to button 73b;

left button=none;

the number of command information pieces=3;

command information piece 1=record value indicative of thumbnail menu into menu memory;

command information piece 2=reproduce main list file named “list file 001”;

command information piece 3=end;
(b) picture selection button 73b:

up button=none;

down button=move to button 73e;

right button=move to button 73c;

left button=move to button 73a;

the number of command information pieces=3;

command information piece 1=record value indicative of thumbnail menu into menu memory;

command information piece 2=reproduce main list file named “list file 002”;

command information piece 3=end;
(c) picture selection button 73c:

up button=none;

down button=move to button 73f;

right button=none;

left button=move to button 73b;

the number of command information pieces=3;

command information piece 1=record value indicative of thumbnail menu into menu memory;

command information piece 2=reproduce main list file named “list file 003”;

command information piece 3=end;
(d) picture selection button 73d:

up button=move to button 73a;

down button=none;

right button=move to button 7e;

left button=none;

the number of command information pieces=4;

command information piece 1=record value indicative of reproduction change menu into menu memory;

command information piece 2=record value indicative of digest list file into reproduced picture selection memory;

command information piece 3=reproduce digest list file named “list file 101”;

command information piece 4=end;
(e) picture selection button 73e:

up button=move to button 73b;

down button=none;

right button=move to button 73f;

left button=move to button 73d;

the number of command information pieces=4;

command information piece 1=record value indicative of reproduction change menu into menu memory;

command information piece 2=record value indicative of digest list file into reproduced picture selection memory;

command information piece 3=reproduce digest list file named “list file 102”;

command information piece 4=end;
(f) picture selection button 73f:

up button=move to button 73c;

down button=none;

right button=none;

left button=move to button 73e;

the number of command information pieces=4;

command information piece 1=record value indicative of reproduction change menu into menu memory;

command information piece 2=record value indicative of digest list file into reproduced picture selection memory;

command information piece 3=reproduce digest list file named “list file 103”;

command information piece 4=end.

The above segments of the control information in the thumbnail menu picture data form computer program portions which can be used by the image data reproducing apparatus.

The menu picture data managing section 15 generates pieces of the control information which correspond to the button pictures respectively. Accordingly, the number of the control information pieces is equal to that of the button pictures or that of the main list files and the digest list files. The picture selection buttons 73a-73f mentioned in the control information correspond to the button pictures 73a-73f in FIG. 9, respectively.

As previously mentioned, the display picture information in the thumbnail menu picture data includes information pieces indicating the contents of the button pictures 73a-73f respectively. These information pieces may further have added data pieces representing the names or the ID numbers of the button pictures 73a-73f, respectively. The added data pieces are designed to designate which of the button pictures indicated in the thumbnail menu picture 70 each of the pieces of the control information corresponds to. In this case, an image data reproducing apparatus can detect the correspondence between the button pictures and the pieces of the control information by referring to the added data pieces.

Alternatively, the pieces of the control information may further have added data pieces representing the positions of the corresponding buttons pictures 73a-73f, respectively. The added data pieces serve to indicate which of the button pictures indicated in the thumbnail menu picture 70 each of the pieces of the control information corresponds to.

The above-indicated segments of the control information in the thumbnail menu picture data have direction information pieces and command information pieces. The direction information pieces for each of the picture selection buttons 73a-73f represent to which of the buttons 73a-73f movements from the present button should be made in response to inputted requests for up, down, left, and right movements.

The up, down, right, and left buttons mentioned in the control information in the thumbnail menu picture data correspond to cross keys, that is, up, down, right, and left keys in an image data reproducing apparatus, respectively. The direction information pieces for each of the picture selection buttons 73a-73f represent to which of the buttons 73a-73f movements from the present button should be made when the up, down, right, and left keys are depressed in the case where the thumbnail menu picture 70 is indicated on the display in the image data reproducing apparatus.

It is assumed that the thumbnail menu picture 70 is indicated in the image data reproducing apparatus, and that the button picture 73a is selected. In this case, when a request for right movement is inputted by depressing the right key in the image data reproducing apparatus, the selected button is changed from the button 73a to the button 73b according to the corresponding direction information piece in the control information. In the thumbnail menu picture 70, the button picture 73b extends immediately rightward of the button picture 73a (see FIG. 9). On the other hand, when a request for up movement is inputted by depressing the up key in the image data reproducing apparatus, the corresponding direction information piece in the control information is “none” so that the button 73a continues to be selected one. In the thumbnail menu picture 70, no button picture extends immediately upward of the button picture 73a (see FIG. 9).

Preferably, the control information has a field for storing the name of first selected one (initially selected one) of the buttons 73a-73f which occurs before a request for button selection is inputted. Preferably, two different pictures are prepared for each of the buttons 73a-73f. In this case, one of the two pictures is used and indicated when the corresponding button is selected. The other picture is used and indicated when the corresponding button is not selected. Accordingly, it is possible to easily discriminate the selected button from the non-selected buttons. For each of the buttons 73a-73f, the control information has a field for storing a value designating the button picture used and indicated when the corresponding button is selected, and a field storing a value designating the button picture used and indicated when the corresponding button is not selected. Preferably, the two pictures for each of the buttons 73a-73f are assigned different ID numbers, respectively.

The image data reproducing apparatus may be provided with an input device via which the ID number of desired one of the buttons 73a-73f can be inputted. In this case, when the ID number of desired one of the buttons 73a-73f is inputted via the input device, the image data reproducing apparatus handles the desired one as selected one.

In the previously-indicated segments of the control information in the thumbnail menu picture data, “non” may be replaced by the name or the ID number of the related picture selection button. For example, “none” at each of the up button and the left button in the paragraph assigned to the picture selection button 73a is replaced by the name of the picture selection button 73a. In this case, the name of the picture selection button 73a at each of the up button and the left button denotes that the picture selection button 73a remains selected even when the up button or the left button is depressed.

As previously mentioned, the above-indicated segments of the control information in the thumbnail menu picture data have command information pieces. The command information pieces for each of the picture selection buttons 73a-73f represent the number of commands and the contents of the commands which can be issued when the related picture selection button is selected. The commands are designed for reproduction control implemented in response to requests inputted via the cross keys and a decision button in the image data reproducing apparatus.

For each of the picture selection buttons 73a, 73b, and 73c indicated below the thumbnail pictures 71a, 71b, and 71c (see FIG. 9), the menu picture data managing section 15 provides command information pieces “1”, “2”, and “3”. The command information piece “1” represents a command to record a value indicative of a thumbnail menu into a menu memory. The command information piece “2” represents a command to reproduce the main list file corresponding to the present picture selection button. The command information piece “2” may represent the file name of the to-be-reproduced main list file. The command information piece “3” represents an end command.

For each of the picture selection buttons 73d, 73e, and 73f indicated below the thumbnail pictures 71d, 71e, and 71f (see FIG. 9), the menu picture data managing section 15 provides command information pieces “1”, “2”, “3”, and “4”. The command information piece “1” represents a command to record a value indicative of a reproduction change menu into a menu memory. The command information piece “2” represents a command to record a value indicative of a digest list file into a reproduced picture selection memory. The command information piece “3” represents a command to reproduce the digest list file corresponding to the present picture selection button. The command information piece “3” may represent the file name of the to-be-reproduced digest list file. The command information piece “4” represents an end command.

Preferably, each of the command information pieces “1”, “2”, “3”, and “4” has a sequence of 16 bits in which 8 higher bits are assigned to command information indicative of a command, and 8 lower bits are assigned to variable information indicative of a value used by the command.

FIG. 11 shows an example of the assignment of the 8 higher bits b7, b6, . . . , b0 to portions of the command information. With reference to FIG. 1 1, the bit b7 is assigned to a variable information flag. The variable information flag b7 being “0” indicates a variable information field formed by the 8 lower bits is unused. On the other hand, the variable information flag b7 being “1” indicates the variable information field is used. The bits b6, b5, and b4 are always set to “0”. The bits b3, b2, b1, and b0 are assigned to one changeable among different commands.

With reference to FIG. 12, the bits b3, b2, b1, and b0 being “0000” represent a command to record a value of variable information into a menu memory. The bits b3, b2, b1, and b0 being “0001” represent a command to record a value of variable information into a reproduced picture memory. The bits b3, b2, b1, and b0 being “0010” represent a command to reproduce a list file identified by a value of variable information. The bits b3, b2, b1, and b0 being “1111” represent an end command.

In the case where the value indicative of a thumbnail menu is set as the value “2” of the variable information (00000010), the 16-bit sequences forming the command information pieces “1”, “2”, and “3” concerning the picture selection button 73a are in the following binary states.
command information piece “1”=1000 0000 0000 0010
command information piece “2”=1000 0010 0000 0001
command information piece “3”=0000 1111 0000 0000

In the case where the value indicative of a reproduction change menu is set as the value “1” of the variable information (00000001) and the value indicative of a digest list file is set as the value “100” of the variable information (01100100), the 16-bit sequences forming the command information pieces “1”, “2”, “3”, and “4” concerning the picture selection button 73f are in the following binary states.
command information piece “1”=1000 0000 0000 0001
command information piece “2”=1000 0001 0110 0100
command information piece “3”=1000 0010 0110 0111
command information piece “4”=0000 1111 0000 0000

As previously mentioned, the variable information flag b7 being “0” indicates a variable information field formed by the 8 lower bits is unused. Accordingly, the command information piece “3” for the picture selection button 73a and the command information piece “4” concerning the picture selection button 73f may be shortened to “0000 1111”.

FIG. 10 shows an example of the reproduction change menu picture 110 represented by the reproduction change menu picture data. The reproduction change menu picture data contains display picture information and the control information. The display picture information represents the reproduction change menu picture 110. As shown in FIG. 10, the reproduction change menu picture 110 consists of a reproduction change button picture 111, a thumbnail menu call button picture 112, a cancel button picture 113, and a background picture. The reproduction change menu picture 110 may have a cursor. Preferably, the button pictures 111, 112, and 113 are arranged in a vertical line. The button pictures 11 1, 112, and 113 extend in the background picture.

An image data reproducing apparatus indicates the reproduction change menu picture 110 on its display when, for example, a menu indication button in the apparatus is depressed. The reproduction change button picture 111 in the reproduction change menu picture 110 is used for a process of implementing the following actions. In the case where the image data reproducing apparatus reproduces main image data pieces mentioned in a main list file, when the reproduction change button picture 111 is selected, the reproduction of a current main image data piece is suspended and is then replaced with the reproduction of a digest image data piece. In the case where the image data reproducing apparatus reproduces digest image data pieces mentioned in a digest list file, when the reproduction change button picture 111 is selected, the reproduction of a current digest image data piece is suspended and is then replaced with the reproduction of a main image data piece. The thumbnail menu call button picture 112 in the reproduction change menu picture 110 is used for calling and indicating the thumbnail menu picture 70.

The control information in the reproduction change menu picture data has portions corresponding to the button pictures 111, 112, and 113 respectively. One can be selected from the button pictures 111, 112, and 113 in accordance with user's request inputted via cross keys in an image data reproducing apparatus. The selection can be decided in accordance with user's request inputted via a decision button in the image data reproducing apparatus. The button-corresponding portions of the control information are designed for reproduction control implemented by the image data reproducing apparatus in response to the button selection and the selection decision.

The display picture information in the reproduction change menu picture data conforms to the format for the recorded and reproduced image data pieces.

The control information in the reproduction change menu picture data relates to the button pictures 111, 112, and 113 and has segments which represent control commands and statuses as follows: the number of buttons=3:
(a) reproduction change button 111:

up button=none;

down button=move to button 112;

right button=none;

left button=none;

the number of command information pieces=11;

command information piece 1=record value indicative of reproduction change menu into menu memory;

command information piece 2=move to next command information piece when value indicative of main list file is recorded in reproduced picture selection memory (ignore next command information piece and move to second next command information piece in other cases);

command information piece 3=move to command information piece 8;

command information piece 4=record value indicative of main list file into reproduced picture selection memory;

command information piece 5=obtain number N that is list file name recorded in resume memory;

command information piece 6=reproduce list file having name equal to obtained number N minus 100;

command information piece 7=move to command information piece 11;

command information piece 8=record value indicative of digest list file into reproduced picture selection memory;

command information piece 9=obtain number N that is list file name recorded in resume memory;

command information piece 10=reproduce list file having name equal to obtained number N plus 100;

command information piece 11=end;
(b) thumbnail menu call button 112:

up button=move to button 111;

down button=move to button 113;

right button=none;

left button=none;

the number of command information pieces=2;

command information piece 1=reproduce thumbnail menu picture;

command information piece 2=end;
(c) cancel button 113:

up button=move to button 112;

down button=none;

right button=none;

left button=none;

the number of command information pieces=3;

command information piece 1=record value indicative of reproduction change menu into menu memory;

command information piece 2=reproduce from position recorded in resume memory;

command information piece 3=end.

The above segments of the control information in the reproduction change menu picture data form computer program portions which can be used by the image data reproducing apparatus.

The menu picture data managing section 15 generates portions of the control information which correspond to the button 111, 112, and 113 respectively. The display picture information in the reproduction change menu picture data has portions representing the button pictures 111, 112, and 113 in the reproduction change menu picture 110. The ID numbers of the buttons 111, 112, and 113 are mentioned in not only the button-corresponding portions of the control information but also the button-representing portions of the display picture information so as to provide a correspondence between the button-corresponding portions of the control information and the button-representing portions of the display picture information.

The above-indicated segments of the control information in the reproduction change menu picture data have direction information pieces and command information pieces. The direction information pieces for each of the buttons 111, 112, and 113 represent to which of the buttons 111, 112, and 113 movements from the present button should be made in response to inputted requests for up, down, left, and right movements.

The up, down, right, and left buttons mentioned in the control information in the reproduction change menu picture data correspond to cross keys, that is, up, down, right, and left keys in an image data reproducing apparatus, respectively. The direction information pieces for each of the buttons 111, 112, and 113 represent to which of the buttons 111, 112, and 113 movements from the present button should be made when the up, down, right, and left keys are depressed in the case where the reproduction change menu picture 110 is indicated in the image data reproducing apparatus. The ID numbers of destination buttons are mentioned in the direction information pieces.

It is assumed that the reproduction change menu picture 110 is indicated in the image data reproducing apparatus, and that the button picture 111 is selected. In this case, when a request for down movement is inputted by depressing the down key in the image data reproducing apparatus, the selected button is changed from the button 111 to the button 112 according to the corresponding direction information piece in the control information. In the reproduction change menu picture 110, the button picture 112 extends immediately below the button picture 111 (see FIG. 10). On the other hand, when a request for up, right, or left movement is inputted by depressing the up, right, or left key in the image data reproducing apparatus, the corresponding direction information piece in the control information is “none” so that the button 111 continues to be selected one. In the reproduction change menu picture 110, no button picture extends upward, rightward, or leftward of the button picture 111 (see FIG. 10).

Each of the control information portions for the buttons 111, 112, and 113 has fields storing the direction information pieces corresponding to “up”, “down”, “right”, and “left” respectively. In the case where the direction information pieces related to the right and left buttons for each of the button pictures 111, 112, and 113 are “none”, the fields for storing the direction information pieces related to the right and left buttons may be omitted. Preferably, the control information has a field for storing the name of first selected one (initially selected one) of the buttons 111, 112, and 113 which occurs before a request for button selection is inputted. Preferably, two different pictures are prepared for each of the buttons 111, 112, and 113. In this case, one of the two pictures is used and indicated when the corresponding button is selected. The other picture is used and indicated when the corresponding button is not selected. Accordingly, it is possible to easily discriminate the selected button from the non-selected buttons. For each of the buttons 111, 112, and 113, the control information has a field for storing a value designating the button picture used and indicated when the corresponding button is selected, and a field storing a value designating the button picture used and indicated when the corresponding button is not selected. Preferably, the two pictures for each of the buttons 111, 112, and 113 are assigned different ID numbers, respectively.

The image data reproducing apparatus may be provided with an input device via which the ID number of desired one of the buttons 111, 112, and 113 can be inputted. In this case, when the ID number of desired one of the buttons 111, 112, and 113 is inputted via the input device, the image data reproducing apparatus handles the desired one as selected one.

In the previously-indicated segments of the control information in the thumbnail menu picture data, “non” may be replaced by the ID number of the related button. For example, “none” at each of the up button, the right button, and the left button in the paragraph assigned to the button 111 is replaced by the ID number of the button 111. In this case, the ID number of the button 111 at each of the up button, the right button, and the left button denotes that the button 111 remains selected even when the up button, the right button, or the left button is depressed.

As previously mentioned, the above-indicated segments of the control information in the reproduction change menu picture data have command information pieces. The command information pieces for each of the buttons 111, 112, and 113 represent the number of commands and the contents of the commands which can be issued when the related button is selected. The commands are designed for reproduction control implemented in response to requests inputted via the cross keys and the decision button in the image data reproducing apparatus.

For the reproduction change button 111, the menu picture data managing section 15 provides command information pieces for replacing the reproduction of a main image data piece with the reproduction of a digest image data piece, and replacing the reproduction of a digest image data piece with the reproduction of a main image data piece. For the thumbnail menu picture call button 112, the menu picture data managing section 15 provides a command information piece for indicating the thumbnail menu picture 70. For the cancel button 113, the menu picture data managing section 15 provides a command information piece for reproducing the remaining part of the image data piece which has been partially reproduced before the indication of the reproduction change menu picture 110.

Preferably, each of the command information pieces for the buttons 111, 112, and 113 has a sequence of 16 bits in which 8 higher bits are assigned to command information indicative of a command, and 8 lower bits are assigned to variable information indicative of a value used by the command. The structure of the 8 higher bits b7, b6, . . . , b0 assigned to the command information is similar to that in FIG. 11. Accordingly, the bit b7 is assigned to a variable information flag. The bits b6, b5, and b4 are always set to “0”. The bits b3, b2, b1, and b0 are assigned to one changeable among different commands.

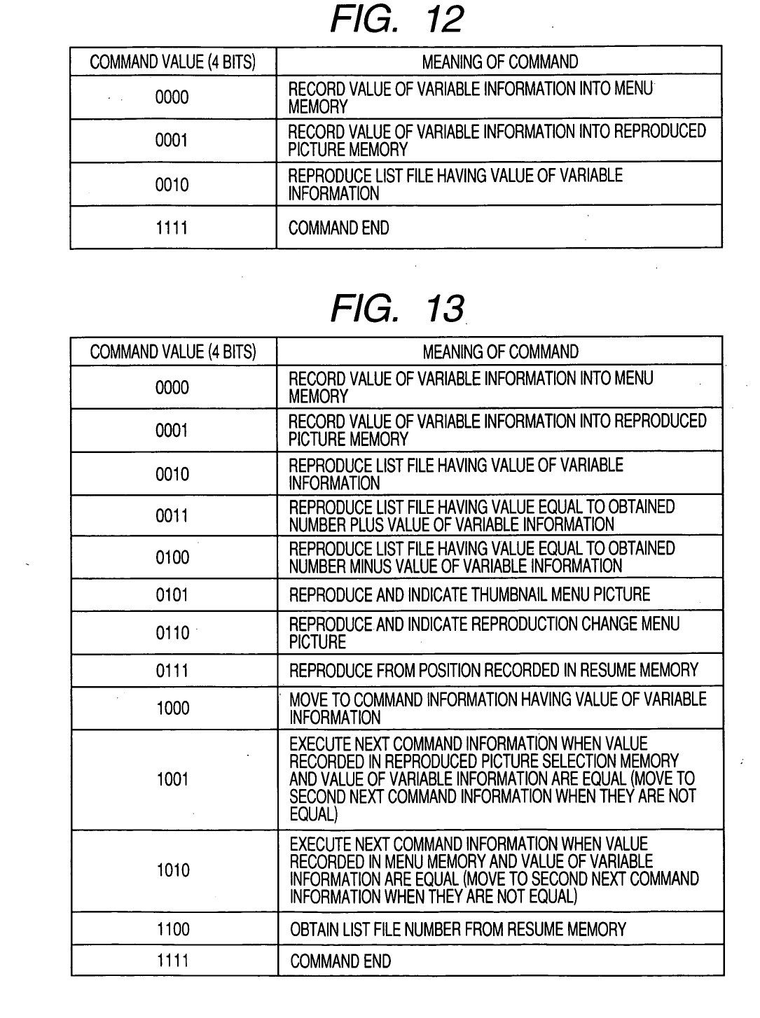

With reference to FIG. 13, the bits b3, b2, b1, and b0 being “0000” represent a command to record a value of variable information into a menu memory. The bits b3, b2, b1, and b0 being “0001” represent a command to record a value of variable information into a reproduced picture memory. The bits b3, b2, b1, and b0 being “0010” represent a command to reproduce a list file identified by a value of variable information. The bits b3, b2, b1, and b0 being “0011” represent a command to reproduce a list file having an ID number equal to an obtained number plus a value of variable information. The bits b3, b2, b1, and b0 being “0100” represent a command to reproduce a list file having an ID number equal to an obtained number minus a value of variable information. The bits b3, b2, b1, and b0 being “0101” represent a command to reproduce and indicate the thumbnail menu picture 70. The bits b3, b2, b1, and b0 being “0110” represent a command to reproduce and indicate the reproduction change menu picture 110. The bits b3, b2, b1, and b0 being “0111” represent a command to start reproduction from a position recorded in a resume memory (a resuming-purpose memory). The bits b3, b2, b1, and b0 being “1000” represent a command for movement to a command information piece corresponding to a value of variable information. The bits b3, b2, b1, and b0 being “1001” represent a command to make movement to a next command information piece when a value recorded in a reproduced picture selection memory and a value of variable information are equal, and a command to ignore the next command information piece and to make movement to a second next command information piece when the value recorded in the reproduced picture selection memory and the value of variable information are not equal. The bits b3, b2, b1, and b0 being “1010” represent a command to make movement to a next command information piece when a value recorded in a menu memory and a value of variable information are equal, and a command to ignore the next command information piece and to make movement to a second next command information piece when the value recorded in the menu memory and the value of variable information are not equal. The bits b3, b2, b1, and b0 being “1100” represent a command to obtain the ID number of a list file from the resume memory. The bits b3, b2, b1, and b0 being “1111” represent an end command.

The 16-bit sequences forming the command information pieces “1” “2”, “3”, . . . , and “11” for the reproduction change button 111 are in the following binary states.
command information piece “1”=1000 0000 0000 0001
command information piece “2”=1000 1001 0000 0000
command information piece “3”=1000 1000 0000 1000
command information piece “4”=1000 0001 0000 0000
command information piece “5”=0000 1100 0000 0000
command information piece “6”=1000 0100 0110 0100
command information piece “7”=1000 1000 0000 1011
command information piece “8”=1000 0001 0110 0100
command information piece “9”=0000 1100 0000 0000
command information piece “10”=1000 0011 0110 0100
command information piece “11”=0000 1111 0000 0000

The 16-bit sequences forming the command information pieces “1” and “2” for the thumbnail menu picture call button 112 are in the following binary states.
command information piece “1”=0000 0101 0000 0000
command information piece “2”=0000 1111 0000 0000

The 16-bit sequences forming the command information pieces “1”, “2”, and “3” for the cancel button 113 are in the following binary states.
command information piece “1”=1000 0000 0000 0001
command information piece “2”=0000 0111 0000 0000
command information piece “3”=0000 1111 0000 0000

As previously mentioned, the variable information flag b7 being “0” indicates a variable information field formed by the 8 lower bits is unused. Accordingly, the field for variable information may be omitted from each command information piece in which the variable information flag b7 is “0”.

The menu picture data managing section 15 records the thumbnail menu picture data and the reproduction change menu picture data into the recording medium 18 through the use of the recording section 17.

The initial reproduction information generating section 16 generates the initial reproduction information inclusive of control information. The initial reproduction information generating section 16 sends the initial reproduction information to the recording section 17. The recording section 17 records the initial reproduction information on the recording medium 18.

The initial reproduction information includes command information pieces for enabling an image data reproducing apparatus to implement reproduction control when the reproduction of recorded image data from the recording medium 18 is performed by the apparatus for the first time, and command information pieces for enabling the image data reproducing apparatus to implement reproduction control when a request to indicate a menu picture is inputted. The initial reproduction information forms computer program portions which can be used by the image data reproducing apparatus.

The initial reproduction information has segments which represent control commands and statuses as follows:
the number of command information pieces=6:

command information piece 1=move to next command information piece when value indicative of reproduction change menu is recorded in menu memory (ignore next command information piece and move to second next command information piece in other cases);

command information piece 2=move to command information piece 5;

command information piece 3=reproduce and indicate thumbnail menu picture;

command information piece 4=move to command information piece 6;

command information piece 5=reproduce and indicate reproduction change menu picture;

command information piece 6=end.

Preferably, each of the command information pieces in the initial reproduction information has a sequence of 16 bits in which 8 higher bits are assigned to command information indicative of a command, and 8 lower bits are assigned to variable information indicative of a value used by the command. The structure of the 8 higher bits b7, b6, . . . , b0 assigned to the command information is similar to that in FIG. 11. Accordingly, the bit b7 is assigned to a variable information flag. The bits b6, b5, and b4 are always set to “0”. The bits b3, b2, b1, and b0 are assigned to one changeable among different commands chosen from those in FIG. 13.

The 16-bit sequences forming the command information pieces 1 “2”, “3”, . . . , and “6” in the initial reproduction information are in the following binary states.
command information piece “1”=1000 1010 0000 0001
command information piece “2”=1000 1000 0000 0101
command information piece “3”=0000 0101 0000 0000
command information piece “4”=1000 1000 0000 0110
command information piece “5”=0000 0110 0000 0000
command information piece “6”=0000 1111 0000 0000

As previously mentioned, the initial reproduction information generated by the initial reproduction information generating section 16 is recorded on the recording medium 18 through the recording section 17.

The command information pieces in the initial reproduction information may be uniquely predetermined. In this case, the initial reproduction information generating section 16 may include a memory storing the command information pieces. The command information pieces are read from the memory before being recorded on the recording medium 18 as the initial reproduction information.

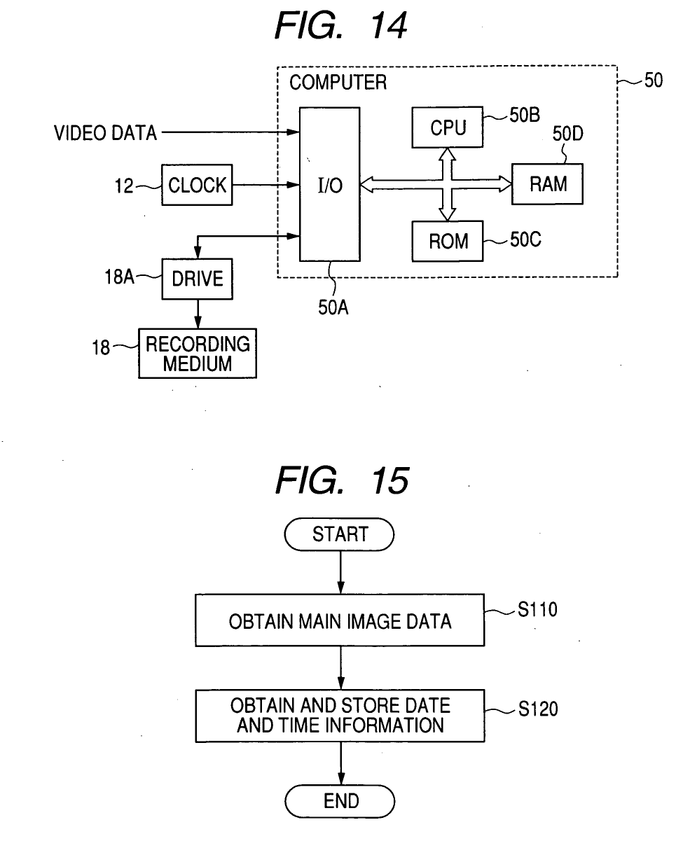

FIG. 14 shows the hardware structure of the image data recording apparatus 10. As shown in FIG. 14, the image data recording apparatus 10 includes a computer 50. A part of the image data inputting section 11, the group generating section 13, the digest generating section 14, the menu picture data managing section 15, the initial reproduction information generating section 16, and a part of the recording section 17 in FIG. 1 are implemented by the computer 50.

The computer 50 has an I/O port 50A, a CPU 50B, a ROM 50C, and a RAM 50D which are connected by a bus. The clock 12 is connected with the I/O port 50A of the computer 50.

The image data recording apparatus 10 includes a drive 18A for the recording medium 18. The drive 18A is connected with the I/O port 50A of the computer 50. The recording section 17 in FIG. 1 is partially implemented by the drive 18A.

There is an image capturing section (not shown) connected with the I/O port 50A of the computer 50. During every shooting, the image capturing section repetitively captures an image of a subject or a target scene, and generates a video data piece representing a stream of moving pictures or a set of still pictures formed by the respective captured images. The image capturing section outputs each video data piece to the I/O port 50A of the computer 50.

The computer 50 or the CPU 50B operates in accordance with a control program (a computer program) stored in the ROM 50C or the RAM 50D. The control program is designed to enable the computer 50 or the CPU 50B to implement actions mentioned hereafter.

During a main data recording mode of operation of the image data recording apparatus 10, the computer 50 receives each video data piece from the image capturing section, and encodes the received video data piece to generate a main image data piece (a main image data sequence, a main image data block, or a main image data file). The computer 50 controls the drive 18A to record the generated main image data piece on the recording medium 18.

For each main image data piece recorded on the recording medium 18, the computer 50 obtains or generates a management information piece representing the ID number or name (file name), logical address (block address), inputting date and time, recording date and time, play time, and image quality of the main image data piece. Specifically, by referring to the output signal from the clock 12, the computer 50 detects the date and time (the inputting date and time) at which the video data piece corresponding to the main image data piece is inputted thereto, the date and time (the recording date and time) at which the main image data piece is recorded on the recording medium 18, and the play time of the main image data piece. The logical address denotes a position on the recording medium 18 at which the recorded main image data piece is located. The computer 50 controls the drive 18A to record the management information piece on the recording medium 18. The computer 50 may add the management information piece to the corresponding main image data piece before recording the resultant main image data piece on the recording medium 18 through the drive 18A.

FIG. 15 is a flowchart of a segment of the control program for the computer 50 (the CPU 50B) which is executed for each video data piece inputted to the image data recording apparatus 10. As shown in FIG. 15, a first step S 110 of the program segment receives an inputted video data piece. The step S110 encodes the received video data piece into a main image data piece. A step S120 following the step S110 refers to the output signal from the clock 12, and thereby obtains an information piece representing the date and time at which the video data piece is inputted. The step S120 stores the obtained date and time information piece into a field prescribed by a data recording format for the recording medium 18 or a picture format. After the step S120, the current execution cycle of the program segment ends.

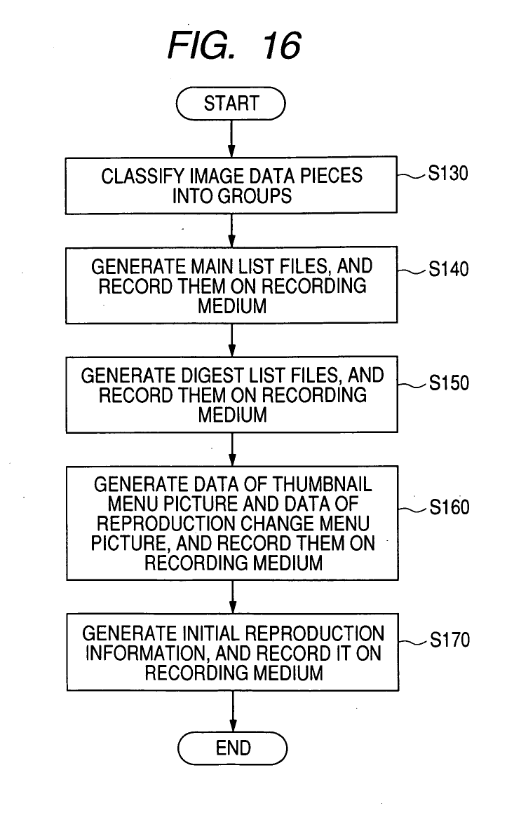

FIG. 16 is a flowchart of another segment of the control program for the computer 50 (the CPU 50B) which is generally executed after a plurality of main image data pieces and a plurality of corresponding management information pieces are recorded on the recording medium 18.

With reference to FIG. 16, a first step S130 of the program segment controls the drive 18A to read the management information pieces from the recording medium 18. The step S130 detects the inputting dates and times or the recording dates and times, and the play times of the recorded main image data pieces from the read management information pieces. The step S130 classifies the main image data pieces into groups according to the detected inputting dates and times or the detected recording dates and times, and the detected play times thereof as the group generating section 13 in FIG. 1 does.

A step S140 following the step S130 generates main list files for the respective groups on the basis of the read management information pieces as the group generating section 13 in FIG. 1 does. Each of the generated main list file indicates the ID numbers (the names) of and the reproduction ranges (the reproduction intervals or the play intervals) for the main image data pieces in the related group. Preferably, the reproduction ranges are expressed by the addresses of the main image data pieces on the recording medium 18. The step S140 controls the drive 18A to record the generated main list files on the recording medium 18.

A step S150 subsequent to the step S140 generates digest list files for the respective groups on the basis of the read management information pieces as the digest generating section 14 in FIG. 1 does. Each of the generated digest list file indicates the ID numbers (the names) of ones, from which cuts should be extracted, of the main image data pieces in the related group, and the cut-corresponding reproduction ranges (the cut-corresponding reproduction intervals or the cut-corresponding play intervals) for the main image data pieces. Preferably, the cut-corresponding reproduction ranges are expressed by the addresses of portions, which should be extracted as cuts, of the main image data pieces on the recording medium 18. The step S150 controls the drive 18A to record the generated digest list files on the recording medium 18.

A step S160 following the step S 150 generates data representative of the thumbnail menu picture 70 and data representative of the reproduction change menu picture 110 on the basis of the main list files and the digest list files as the menu picture data managing section 15 in FIG. 1 does. The step S160 controls the drive 18A to record the thumbnail menu picture data and the reproduction change menu data on the recording medium 18.

A step S170 subsequent to the step S160 generates initial reproduction information as the initial reproduction information generating section 16 in FIG. 1 does. The step S170 controls the drive 18A to record the generated initial reproduction information on the recording medium 18. After the step S170, the current execution cycle of the program segment ends.

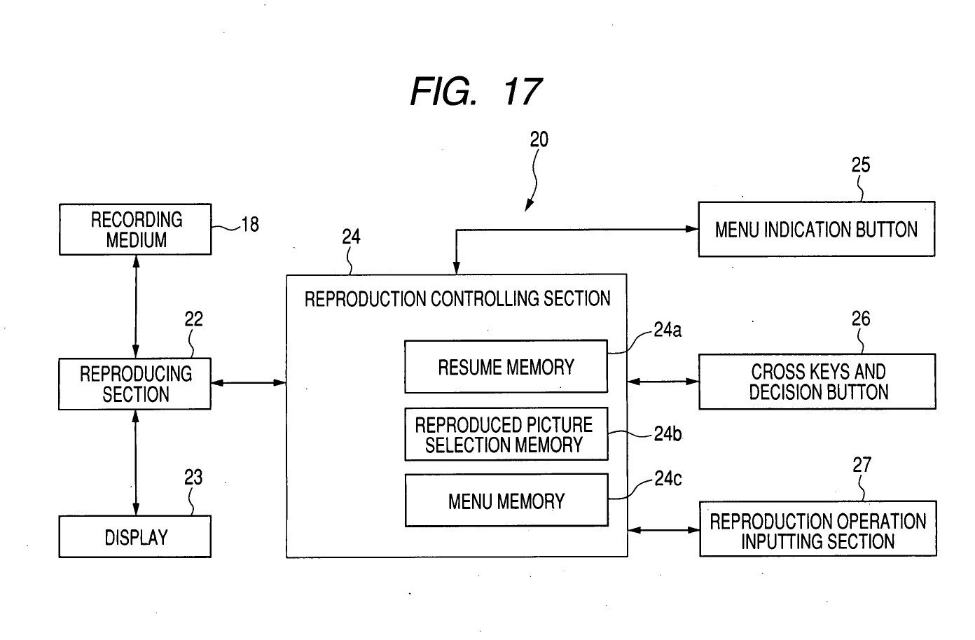

FIG. 17 shows an image data reproducing apparatus 20 according to the first embodiment of this invention. It should be noted that a portion of FIG. 17 shows the operation of the image data reproducing apparatus 20 rather than the hardware structure thereof.

With reference to FIG. 17, there are a reproducing section 22, a display 23, a reproduction controlling section 24, a menu indication button 25, cross keys and decision button 26, and a reproduction operation inputting section 27.

The reproducing section 22 serves to read main image data pieces, digest image data pieces (portions of the main image data pieces), main list files, digest list files, thumbnail menu picture data, reproduction change menu picture data, and initial reproduction information from a recording medium 18 which have been recorded thereon by, for example, the image data recording apparatus 10. It is preferable to read either digest image data pieces or digest list files. The reproducing section 22 sends the main image data pieces, the digest image data pieces, the thumbnail menu picture data, and the reproduction change menu picture data to the display 23. The reproducing section 22 sends the control information in the thumbnail menu picture data, the control information in the reproduction change menu picture data, and the initial reproduction information to the reproduction controlling section 24.

The display 23 serves to indicate the contents of the main image data pieces, the digest image data pieces, the thumbnail menu picture data, and the reproduction change menu picture data.

The menu indication button 25, the cross keys and decision button 26, and the reproduction operation inputting section 27 can be actuated by a user. User's requests can be inputted to the reproduction controlling section 24 by actuating the menu indication button 25, the cross keys and decision button 26, and the reproduction operation inputting section 27.

The reproduction controlling section 24 implements reproduction control through the reproducing section 22 in response to the initial reproduction information, the control information in the thumbnail menu picture data, the control information in the reproduction change menu picture data, and user's requests inputted via the menu indication button 25, the cross keys and decision button 26, and the reproduction operation inputting section 27. The user can input desired requests into the image data reproducing apparatus 20 via the menu indication button 25, the cross keys and decision button 26, and the reproduction operation inputting section 27 while monitoring the thumbnail menu picture 70 or the reproduction change menu picture 110 indicated on the display 23.

The reproduction controlling section 24 includes a resume memory (a resuming-purpose memory) 24a, a reproduced picture selection memory 24b, and a menu memory 24c in which information used for reproduction control is recorded. The memories 24a-24c may be located outside the reproduction controlling section 24 provided that the reproduction controlling section 24 obtains the reproduction control information therefrom. The memories 24a-24c may be formed by a common memory. The reproduction controlling section 24 initializes the memories 24a-24c when the recording medium 18 is replaced with new one, when the recording medium 18 is inserted into the apparatus 20, or when a power supply in the apparatus 20 is changed to an on state or an off state. The initialization is implemented by recording signals of initial values into the memories 24a-24c. Preferably, the initial values differ from normal values recorded in the memories 24a-24c during the usual operation of the apparatus 20. For example, the initial values are equal to zero or negative integers in the case where the normal values recorded in the memories 24a-24c are positive integers. The initial values used upon the insertion of the recording medium 18 into the apparatus 20 or the change of the power supply to the on state may be equal to preset values.

The image data recording apparatus 10 or another apparatus has recorded the main image data pieces, the main list files, the digest list files, the thumbnail menu picture data, the reproduction change menu picture data, and the initial reproduction information on the recording medium 18.

The reproducing section 22 is designed for the recording medium 18. Specifically, the reproducing section 22 includes an accessing unit for successively reading recorded signals from the recording medium 18. The accessing unit is a magnetic head when the recording medium 18 is a hard disc. The accessing unit is an optical pickup when the recording medium 18 is an optical disc. The accessing unit is a reader when the recording medium 18 is a memory. The reproducing section 22 further includes a unit for controlling the position of the accessing unit relative to the recording medium 18, a motor for rotating the recording medium 18, a unit for controlling rotation of the motor (that is, rotation of the recording medium 18), a signal processor for subjecting every signal read from the recording medium 18 by the accessing unit to demodulation, and a decoder for decoding every demodulation-result signal in harmony with the encoding scheme for the signals recorded on the recording medium 18.

User's requests for reproduction start (playback start), reproduction stop (playback stop), rewinding, and fast feed can be inputted to the reproduction controlling section 24 via the reproduction operation inputting section 27. The reproduction controlling section 24 responds to user's requests inputted via the menu indication button 25, the cross keys and decision button 26, and the reproduction operation inputting section 27.

When user's request for reproduction start is inputted via the reproduction operation inputting section 27, the reproduction controlling section 24 controls the reproducing section 22 to read a desired main image data piece or a desired digest image data piece from the recording medium 18 and decode the read main image data piece or the read digest image data piece into a video signal. The reproducing section 22 sends the video signal to the display 23. The display 23 indicates the contents of the video signal.

When user's request for indicating a menu picture is inputted via the menu indication button 25, the reproduction controlling section 24 suspends the reproduction of a desired main image data piece or a desired digest image data piece via the reproducing section 22 and records, into the resume memory 24a, information for identifying the reproduction-suspended position in the desired main image data piece or the desired digest image data piece.

The cross keys and decision button 26 are used for moving a cursor to desired one of the buttons in the thumbnail menu picture 70 or the reproduction change menu picture 110 indicated on the display 23 and thereby selecting the desired button, and for deciding the button selection. When one of the up, down, right, and left keys in the cross keys and decision button 26 is depressed, the reproduction controlling section 24 processes the direction information piece corresponding to the depressed key to implement desired movement from one button to another button. When the decision button in the cross keys and decision button 26 is depressed, the reproduction controlling section 24 processes the command information piece or pieces corresponding to the currently-selected button.

The menu indication button 25, the cross keys and decision button 26, and the reproduction operation inputting section 27 may be provided on an infrared-based remote control device. In this case, the image data reproducing apparatus 20 includes an interface for receiving signals from the remote control device.

### (1) Initial-Reproduction-Information Responsive Operation

The image data reproducing apparatus 20 starts operating in an initial-reproduction-information responsive mode when user's request for reproduction start is inputted to the reproduction controlling section 24 via the reproduction operation inputting section 27 or when user's request for indicating a menu picture is inputted to the reproduction controlling section 24 via the menu indication button 25 during the reproduction of a main image data piece or a digest image data piece from the recording medium 18.

The initial-reproduction-information responsive mode of operation of the apparatus 20 is as follows. First, the reproduction controlling section 24 obtains the initial reproduction information from the recording medium 18 through the use of the reproducing section 22. When the recording medium 18 is connected with or inserted into the apparatus 20, the reproduction controlling section 24 may obtain the initial reproduction information from the recording medium 18 and then record the obtained initial reproduction information into a memory within the section 24. In this case, the reproduction controlling section 24 fetches the initial reproduction information from the memory upon the later inputting of user's request for reproduction start or user's request for indicating a menu picture.

As previously mentioned, the initial reproduction information has the command information pieces “1”, “2”, “3”, “4”, “5”, and “6”. The reproduction controlling section 24 sequentially executes ones among the commands in the command information pieces “1”, “2”, “3”, “4”, “5”, and “6” in that order. Thereby, the reproduction controlling section 24 implements signal processing for reproduction in accordance with the initial reproduction information.

First, the reproduction controlling section 24 executes the command in the command information piece “1”. As previously mentioned, the command in the command information piece “1” is to move to the next command information piece (the command information piece “2”) when the value indicative of the reproduction change menu is recorded in the menu memory 24c, and is to ignore the next command information piece and move to the second next command information piece (the command information piece “3”) in the other cases. The reproduction controlling section 24 decides whether or not the value indicative of the reproduction change menu is recorded in the menu memory 24c. In the case where the initial value different from the value indicative of the reproduction change menu is stored in the menu memory 24c, the reproduction controlling section 24 decides that the value indicative of the reproduction change menu is not recorded in the menu memory 24c. Accordingly, in this case, the reproduction controlling section 24 ignores the next command information piece (the command information piece “2”) and executes the command in the second next command information piece (the command information piece “3”).

As previously mentioned, the command information piece “3” is to reproduce and indicate the thumbnail menu picture 70. Accordingly, the reproduction controlling section 24 controls the reproducing section 22 to read the thumbnail menu picture data from the recording medium 18 and send the thumbnail menu picture data to the display 23. The display 23 indicates the thumbnail menu picture 70 represented by the thumbnail menu picture data.

Thereafter, the reproduction controlling section 24 executes the command in the command information piece “4”. As previously mentioned, the command information piece “4” is to move to the command information piece “6”. Accordingly, the reproduction controlling section 24 executes the command in the command information piece “6”. Since the command in the command information piece “6” is “end” as previously mentioned, the reproduction controlling section 24 terminates the initial-reproduction-information responsive mode of operation of the apparatus 20. The thumbnail menu picture 70 continues to be indicated on the display 23 until the reproduction controlling section 24 implements reproduction control for the next time.

On the other hand, in the case where the reproduction controlling section 24 decides that the value indicative of the reproduction change menu is recorded in the menu memory 24c, the reproduction controlling section 24 moves from the operation state about the command information piece “1” to the operation state about the command information piece “2” (the next command information piece). As previously mentioned, the command information piece “2” is to move to the command information piece “5”. Accordingly, the reproduction controlling section 24 executes the command in the command information piece “5”. As previously mentioned, the command information piece “5” is to reproduce and indicate the reproduction change menu picture 110. Accordingly, the reproduction controlling section 24 controls the reproducing section 22 to read the reproduction change menu picture data from the recording medium 18 and send the reproduction change menu picture data to the display 23. The display 23 indicates the reproduction change menu picture 110 represented by the reproduction change menu picture data. Thereafter, the reproduction controlling section 24 executes the command in the command information piece “6”. Since the command in the command information piece “6” is “end”, the reproduction controlling section 24 terminates the initial-reproduction-information responsive mode of operation of the apparatus 20. The reproduction change menu picture 110 continues to be indicated on the display 23 until the reproduction controlling section 24 implements reproduction control for the next time.

The value indicative of the reproduction change menu is recorded into the menu memory 24c in each of the following first, second, and third cases. The first case is that one of the button pictures 73d, 73e, and 73f is selected in the thumbnail menu picture 70 and user's request for deciding this selection is inputted via the cross keys and decision button 26, and therefore the commands in the command information pieces “1”, “2”, “3”, and “4” relating to the selected button pictures 73d, 73e, or 73f are sequentially executed. The second case is that the button 111 is selected in the reproduction change menu picture 110 and user's request for deciding this selection is inputted via the cross keys and decision button 26, and therefore ones among the commands in the command information pieces “1”-“11” relating to the selected button 111 are sequentially executed. The third case is that the button 113 is selected in the reproduction change menu picture 110 and user's request for deciding this selection is inputted via the cross keys and decision button 26, and therefore ones among the commands in the command information pieces “1”, “2”, and “3” relating to the selected button 113 are sequentially executed.

The image data reproducing apparatus 20 starts a reproduction procedure when user's request for reproduction start is inputted via the reproduction operation inputting section 27. Then, the thumbnail menu picture 70 is indicated on the display 23. When the reproduction of a digest image data piece is requested, the value indicative of the reproduction change menu is recorded into the menu memory 24c. In this case, upon the inputting of user's request for indicating a menu picture via the menu indication button 25, the reproduction controlling section 24 decides that the value indicative of the reproduction change menu is recorded in the menu memory 24c. Therefore, the reproduction change menu picture 110 is indicated on the display 23 instead of the thumbnail menu picture 70.

During the execution of the commands in the initial reproduction information, none of the thumbnail menu picture 70 and the reproduction change menu picture 110 may be indicated while the contents of a main image data piece or a digest image data piece are reproduced and indicated. When the initial value different from the values indicative of the thumbnail menu and the reproduction change menu is recorded in the menu memory 24c, the reproduction of a main image data piece or a digest image data piece may be started.

### (2) Image-Data Reproduction Requested on Thumbnail Menu

The image data reproducing apparatus 20 starts operating in an image-data reproducing mode when one of the button pictures 73a, 73b, and 73c is selected in the thumbnail menu picture 70 and user's request for deciding this selection is inputted via the cross keys and decision button 26, or when one of the button pictures 73a, 73b, and 73c is selected in the thumbnail menu picture 70 and user's request for reproduction start is inputted via the reproduction operation inputting section 27.

The image-data reproducing mode of operation of the apparatus 20 is as follows. First, the reproduction controlling section 24 obtains the command information pieces “1”, “2”, and “3” concerning the selected button picture 73a, 73b, or 73c from the recording medium 18 via the reproducing section 22. The reproduction controlling section 24 sequentially executes the commands in the obtained command information pieces “1”, “2”, and “3”.

The reproduction controlling section 24 may obtain the command information pieces “1”, “2”, and “3” concerning the button pictures 73a, 73b, and 73c from the recording medium 18 via the reproducing section 22 before one of the button pictures 73a, 73b, and 73c is selected in the thumbnail menu picture 70 and user's request for deciding this selection is inputted via the cross keys and decision button 26, or before one of the button pictures 73a, 73b, and 73c is selected in the thumbnail menu picture 70 and user's request for reproduction start is inputted via the reproduction operation inputting section 27. In this case, the reproduction controlling section 24 records the obtained command information pieces “1”, “2”, and “3” concerning the button pictures 73a, 73b, and 73c into an internal memory. When one of the button pictures 73a, 73b, and 73c is selected in the thumbnail menu picture 70 and user's request for deciding this selection is inputted via the cross keys and decision button 26, or when one of the button pictures 73a, 73b, and 73c is selected in the thumbnail menu picture 70 and user's request for reproduction start is inputted via the reproduction operation inputting section 27, the reproduction controlling section 24 fetches the command information pieces “1”, “2”, and “3” concerning the selected button picture 73a, 73b, or 73c from the internal memory.

A further description will be given of the case where the button picture 73a is selected in the thumbnail menu picture 70 and user's request for deciding this selection is inputted via the cross keys and decision button 26. First, the reproduction controlling section 24 executes the command in the command information piece “1” concerning the selected button picture 73a. As previously mentioned, the command in the command information piece “1” takes the binary state “1000 0000 0000 0010” and is to record the value indicative of the thumbnail menu into the menu memory 24c. Accordingly, the reproduction controlling section 24 records the value “0000 0010”, that is, the value indicative of the thumbnail menu picture into the menu memory 24c.

Second, the reproduction controlling section 24 executes the command in the command information piece “2” concerning the selected button picture 73a. As previously mentioned, the command in the command information piece “2” is to reproduce the main list file named “list file 001”. Accordingly, the reproduction controlling section 24 obtains the main list file “001” from the recording medium 18 via the reproducing section 22. By referring to the obtained main list file “001”, the reproduction controlling section 24 controls the reproducing section 22 to sequentially read the main image data pieces in the first group from the recording medium 18 and send the read main image data pieces to the display 23. The contents of the main image data pieces in the first group are sequentially reproduced by the display 23.

In the case where the button picture 73b or 73c is selected in the thumbnail menu picture 70 and user's request for deciding this selection is inputted via the cross keys and decision button 26, the main image data pieces in the second or third group are reproduced similarly to the above-mentioned reproduction of those in the first group.

On the other hand, in the case where one of the button pictures 73d, 73e, and 73f is selected in the thumbnail menu picture 70 and user's request for deciding this selection is inputted via the cross keys and decision button 26, the reproduction controlling section 24 obtains the command information pieces “1”, “2”, “3”, and “4” concerning the selected button picture 73d, 73e, or 73f from the recording medium 18 via the reproducing section 22. The reproduction controlling section 24 sequentially executes the commands in the obtained command information pieces “1”, “2”, “3”, and “4”. According to the command in the command information piece “1” concerning the selected button picture 73d, 73e, or 73f, the reproduction controlling section 24 records the value indicative of the reproduction change menu into the menu memory 24c. As previously mentioned, the command in the command information piece “1” takes the binary state “1000 0000 0000 0001”. Thus, the value indicative of the reproduction change menu is “0000 0001”. Subsequently, according to the command in the command information piece “2” concerning the selected button picture 73d, 73e, or 73f, the reproduction controlling section 24 records the value indicative of a digest list file into the reproduced picture selection memory 24b. The digest list file corresponds to the group related to the selected button picture 73d, 73e, or 73f. When the command in the command information piece “2” takes the binary state “1000 0001 0110 0100”, the value indicative of the digest list file is “0110 0100”. Thereafter, according to the command in the command information piece “3” concerning the selected button picture 73d, 73e, or 73f, the reproduction controlling section 24 obtains the related digest list file from the recording medium 18 via the reproducing section 22. By referring to the obtained digest list file, the reproduction controlling section 24 controls the reproducing section 22 to sequentially read the digest image data pieces in the first, second, or third group from the recording medium 18 and send the read digest image data pieces to the display 23. The contents of the digest image data pieces in the first, second, or third group are sequentially reproduced by the display 23. The group to which the reproduced digest image data pieces belong is related to the selected button picture 73d, 73e, or 73f.

As previously mentioned, when one of the button pictures 73a-73f is selected in the thumbnail menu picture 70 and user's request for deciding this selection is inputted via the cross keys and decision button 26, or when one of the button pictures 73a-73f is selected in the thumbnail menu picture 70 and user's request for reproduction start is inputted via the reproduction operation inputting section 27, the main image data pieces or the digest image data pieces are reproduced according to the main list file or the digest list file corresponding to the selected button picture. Before the reproduction of the main image data pieces or the digest image data pieces is started, the value indicative of the thumbnail menu or the reproduction change menu is recorded into the menu memory 24c.

Thereby, upon the inputting of user's request for indicating a menu picture via the menu indication button 25 during the reproduction of the main image data pieces or the digest image data pieces, the reproduction controlling section 24 obtains the initial reproduction information from the recording medium 18 via the reproducing section 22. Then, the reproduction controlling section 24 operates to indicate the thumbnail menu picture 70 or the reproduction change menu picture 110 on the display 23 in response to the recorded value in the menu memory 24c according to the obtained initial reproduction information.

In the absence of the inputting of user's request for indicating a menu picture via the menu indication button 25 during the reproduction of the main image data pieces or the digest image data pieces, the reproduction is continued until being completed. Thereafter, the reproduction controlling section 24 executes the command in the last one of the command information pieces “1”, “2”, and “3” concerning the button pictures 73a, 73b, and 73c or the command in the last one of the command information pieces “1”, “2”, “3”, and “4” concerning the button pictures 73d, 73e, and 73f. As previously mentioned, the command in the last command information piece is “end”. Accordingly, the reproduction controlling section 24 terminates the action for the reproduction of the main image data pieces or the digest image data pieces. At this time, the reproduction controlling section 24 may operate to indicate, on the display 23, a blue back picture or a message that reproduction has been completed and stopped. Alternatively, the reproduction controlling section 24 may further process the initial reproduction information.

On the other hand, in the presence of the inputting of user's request for indicating a menu picture via the menu indication button 25 during the reproduction of the main image data pieces or the digest image data pieces, the reproduction controlling section 24 controls the reproducing section 22 to suspend the reproduction. Since the digest image data pieces are the portions of the main image data pieces, suspending the reproduction of the digest image data pieces means suspending the reproduction of the portions of the main image data pieces. The reproduction controlling section 24 detects the ID number (the file name) of the main list file or the digest list file mentioning the reproduction-suspended main image data piece, the ID number of the reproduction-suspended main image data piece, and the reproduction-suspended position in the reproduction-suspended main image data piece. The reproduction-suspended position is expressed by the number of frames, GOPs, or bytes counted from the head of the reproduction-suspended main image data piece. The reproduction-suspended position may be expressed by the time elapsed from the moment corresponding to the head of the reproduction-suspended main image data piece. The reproduction controlling section 24 records, into the resume memory 24a, reproduction-suspension point information representative of the detected ID number (the file name) of the main list file or the digest list file, the detected ID number of the reproduction-suspended main image data piece, and the detected reproduction-suspended position.

As understood from the above description, a desired main image data piece can be selected by referring to the thumbnail menu picture 70 indicated on the display 23. Usually, the selected main image data piece is reproduced so that the contents thereof are indicated on the display 23 instead of the thumbnail menu picture 70. During the reproduction of the selected main image data piece, the value indicative of the thumbnail menu is recorded in the menu memory 24c. When user's request for indicating a menu picture is inputted via the menu indication button 25 in these conditions, the reproduction of the selected main image data piece is suspended and then the image data reproducing apparatus 20 starts operating in the initial-reproduction-information responsive mode. During the initial-reproduction-information responsive mode of operation, the reproduction controlling section 24 decides that the value indicative of the reproduction change menu is not recorded in the menu memory 24c. As a result, the reproduction controlling section 24 operates to indicate the thumbnail menu picture 70 on the display 23 again. By referring to the indicated thumbnail menu picture 70, the user can select a desired main image data piece or a digest image data piece. The selected main image data piece or the selected digest image data piece can be reproduced.

As understood from the above description, a desired digest image data piece can be selected by referring to the thumbnail menu picture 70 indicated on the display 23. Usually, the selected digest image data piece is reproduced so that the contents thereof are indicated on the display 23 instead of the thumbnail menu picture 70. During the reproduction of the selected digest image data piece, the value indicative of the reproduction change menu is recorded in the menu memory 24c. When user's request for indicating a menu picture is inputted via the menu indication button 25 in these conditions, the reproduction of the selected digest image data piece is suspended and then the image data reproducing apparatus 20 starts operating in the initial-reproduction-information responsive mode. During the initial-reproduction-information responsive mode of operation, the reproduction controlling section 24 decides that the value indicative of the reproduction change menu is recorded in the menu memory 24c. As a result, the reproduction controlling section 24 operates to indicate the reproduction change menu picture 110 on the display 23. By referring to the indicated reproduction change menu picture 110, reproduction changes (reproduction switching) can be implemented as will be mentioned later.

The command in the command information piece “1” concerning the button pictures 73a, 73b, and 73c may be to record the value indicative of the reproduction change menu into the menu memory 24c. In this case, in the presence of the inputting of user's request for indicating a menu picture via the menu indication button 25 during the reproduction of selected main image data pieces, the reproduction change menu picture 110 is indicated on the display 23.

The command information pieces “1”, “2”, and “3” concerning the button picture 73a may be replaced by the following command information pieces “1”, “2”, “3”, “4”, and “5”:

command information piece 1=record value indicative of thumbnail menu into menu memory;

command information piece 2=reproduce main list file named “list file 001”;

command information piece 3=reproduce main list file named “list file 002”;

command information piece 4=reproduce main list file named “list file 003”;

command information piece 3=end.

In this case, all the main image data pieces recorded on the recording medium 18 can be reproduced by selecting the button picture 73a and then deciding the selection.

### (3) Image-Data Reproduction Requested on Reproduction Change Menu

When the thumbnail menu call button picture 112 is selected in the reproduction change menu picture 110 indicated on the display 23 and user's request for deciding this selection is inputted via the cross keys and decision button 26, the reproduction controlling section 24 controls the reproducing section 22 to read, from the recording medium 18, the command information pieces “1” and “2” concerning the thumbnail menu call button picture 112. Then, the reproduction controlling section 24 sequentially executes the commands in the read command information pieces “1” and “2”.

As previously mentioned, the command in the command information piece “1” concerning the thumbnail menu call button picture 112 is to indicate the thumbnail menu picture 70. Accordingly, the reproduction controlling section 24 operates to indicate the thumbnail menu picture 70 on the display 23. Specifically, the reproduction controlling section 24 controls the reproducing section 22 to read the thumbnail menu picture data from the recording medium 18 and send the read thumbnail menu picture data to the display 23. The display 23 indicates the thumbnail menu picture 70 represented by the thumbnail menu picture data. As previously mentioned, the command in the command information piece “2” concerning the thumbnail menu call button picture 112 is “end”. Thus, the reproduction controlling section 24 terminates operating in response to the commands concerning the thumbnail menu call button picture 112.

Therefore, the user can easily replace the reproduction change menu picture 110 indicated on the display 23 with the thumbnail menu picture 70 by selecting the thumbnail menu call button picture 112 and deciding this selection through the use of the cross keys and decision button 26.

As previously mentioned, when one of the button pictures 73a, 73b, and 73c is selected in the indicated thumbnail menu picture 70 and this selection is decided, the main image data pieces in the group corresponding to the selected button picture are reproduced. When one of the button pictures 73d, 73e, and 73f is selected in the indicated thumbnail menu picture 70 and this selection is decided, the digest image data pieces in the group corresponding to the selected button picture are reproduced.

When the cancel button picture 113 is selected in the reproduction change menu picture 110 indicated on the display 23 and user's request for deciding this selection is inputted via the cross keys and decision button 26, the reproduction controlling section 24 sequentially executes the commands in the command information pieces “1”, “2”, and “3” concerning the cancel button picture 113.

As previously mentioned, the command in the command information piece “1” concerning the cancel button picture 113 is “record value indicative of reproduction change menu into menu memory”. Accordingly, the reproduction controlling section 24 records the value indicative of the reproduction change menu into the menu memory 24c. As previously mentioned, the command in the command information piece “2” concerning the cancel button picture 113 is “reproduce from position recorded in resume memory”. Accordingly, the reproduction controlling section 24 fetches the reproduction-suspension point information from the resume memory 24a. Then, the reproduction controlling section 24 derives, from the fetched reproduction-suspension point information, the ID number (the file name) of the main list file mentioning the reproduction-suspended main image data piece or the digest list file mentioning the reproduction-suspended main image data piece, the ID number of the reproduction-suspended main image data piece, and the reproduction-suspended position in the reproduction-suspended main image data piece. Subsequently, the reproduction controlling section 24 controls the reproducing section 22 to read, from the recording medium 18, the main list file or the digest list file having the derived ID number (the derived file name). Thereafter, by referring to the read main list file or the read digest list file, the reproduction controlling section 24 controls the reproducing section 22 to restart the reproduction of the reproduction-suspended main image data piece from the recording medium 18 at the derived reproduction-suspended position. Thus, the reproduction of the main image data pieces or the digest image data pieces from the recording medium 18 is restarted according to the read main list file or the read digest list file. As previously mentioned, the command in the command information piece “3” concerning the cancel button picture 113 is “end”. Thus, the reproduction controlling section 24 terminates operating in response to the commands concerning the cancel button picture 113.

As previously mentioned, the reproduction of the main image data pieces mentioned in the main list file or the reproduction of the digest image data pieces mentioned in the digest list file is suspended when user's request for indicating a menu picture is inputted via the menu indication button 25. At this time, on the display 23, the contents of the main image data pieces or the digest image data pieces are replaced by the reproduction change menu picture 110. As understood from the previous description, the user can easily restart the reproduction of the main image data pieces or the digest image data pieces from the reproduction-suspension point by selecting the cancel button 113 and then deciding this selection through the use of the cross keys and decision button 26.

When the reproduction change button picture 111 is selected in the reproduction change menu picture 110 indicated on the display 23 and user's request for deciding this selection is inputted via the cross keys and decision button 26, the reproduction controlling section 24 sequentially executes ones among the commands in the command information pieces “1”-“11” concerning the reproduction change button picture 111.

As previously mentioned, the command in the command information piece “1” concerning the reproduction change button picture 111 is “record value indicative of reproduction change menu into menu memory”. Accordingly, the reproduction controlling section 24 records the value indicative of the reproduction change menu into the menu memory 24c.

As previously mentioned, the command in the command information piece “2” concerning the reproduction change button picture 111 is “move to next command information piece when value indicative of main list file is recorded in reproduced picture selection memory (ignore next command information piece and move to second next command information piece in other cases)”. Accordingly, the reproduction controlling section 24 decides whether or not the value indicative of a main list file is recorded in the reproduced picture selection memory 24b. This decision is to determine which of a main image data piece and a digest image data piece is reproduced before the reproduction change menu picture 110 is indicated on the display 23 in response to the inputting of user's request for indicating a menu picture via the menu indication button 25.

In the case where the value indicative of a main list file is recorded in the reproduced picture selection memory 24b, that is, in the case where a main image data piece is reproduced before the indication of the reproduction change menu picture 110, the reproduction controlling section 24 moves from the operation state about the command information piece “2” to the operation state about the command information piece “3” (the next command information piece). As previously mentioned, the command information piece “3” concerning the reproduction change picture button 111 is to move to the command information piece “8”. Accordingly, the reproduction controlling section 24 executes the command in the command information piece “8”.

As previously mentioned, the command in the command information piece “8” concerning the reproduction change picture button 111 is “record value indicative of digest list file into reproduced picture selection memory”. Accordingly, the reproduction controlling section 24 erases the value indicative of the main list file from the reproduced picture selection memory 24b, and then writes the value indicative of the digest list file thereinto. The digest list file corresponds to the same group as that relating to the main list file. The reproduction controlling section 24 may write the value indicative of the digest list file over the value indicative of the main list file in the reproduced picture selection memory 24b.

As previously mentioned, the command in the command information piece “9” concerning the reproduction change picture button 111 is “obtain number N that is list file name recorded in resume memory”. Accordingly, the reproduction controlling section 24 fetches the ID number (the file name) of the main list file from the resume memory 24a. The main list file having the fetched ID number mentions the reproduction-suspended main image data piece.

As previously mentioned, the command in the command information piece “10” concerning the reproduction change picture button 111 is “reproduce list file having name equal to obtained number N plus 100”. Accordingly, the reproduction controlling section 24 adds “100” to the fetched ID number of the main list file. The reproduction controlling section 24 controls the reproducing section 22 to read, from the recording medium 18, the digest list file having an ID number equal to the result of the addition. The read digest list file corresponds to the same group as that relating to the main list file. Then, the reproduction controlling section 24 controls the reproducing section 22 to read digest image data pieces from the recording medium 18 according to the read digest list file. The reproducing section 22 sends the read digest image data pieces to the display 23. The display 23 indicates the contents of the digest image data pieces. In this way, digest image data pieces are reproduced according to the read digest list file.

As previously mentioned, the command in the command information piece “11” concerning the reproduction change button picture 111 is “end”. Thus, the reproduction controlling section 24 terminates operating in response to the commands concerning the reproduction change button picture 111.

While the value indicative of a main list file is recorded in the reproduced picture selection memory 24b and one among the main image data pieces mentioned in the main list file is being reproduced, the user can input a request for indicating a menu picture via the menu indication button 25. Upon the inputting of user's request for indicating a menu picture, the reproduction of the current main image data piece is suspended and the reproduction change menu picture 110 is indicated on the display 23. When the reproduction change button picture 111 is selected in the indicated reproduction change menu picture 110 and this selection is decided by the user through the use of the cross keys and decision button 26, the reproduction of the digest image data pieces mentioned in the digest list file corresponding to the same group as that relating to the above main list file is started. In this way, the reproduction of the main image data pieces mentioned in the main list file is replaced by the reproduction of the digest image data pieces mentioned in the digest list file corresponding to the same group as that relating to the main list file.

When the reproduction of the main image data piece is suspended in response to the inputting of user's request for indicating a menu picture via the menu indication button 25, the reproduction controlling section 24 records, into the resume memory 24a, reproduction-suspension point information representative of the ID number (the file name) of the main list file mentioning the reproduction-suspended main image data piece, the ID number of the reproduction-suspended main image data piece, and the reproduction-suspended position in the reproduction-suspended main image data piece. At this time, the reproduction change menu picture 110 starts to be indicated on the display 23. When the reproduction change button picture 111 is selected in the indicated reproduction change menu picture 110 and this selection is decided, the reproduction-suspension point information is fetched from the resume memory 24a. The ID number of the main list file mentioning the reproduction-suspended main image data piece, the ID number of the reproduction-suspended main image data piece, and the reproduction-suspended position in the reproduction-suspended main image data piece are detected from the fetched reproduction-suspension point information. Then, the digest list file having an ID number equal to “100” plus the detected ID number of the main list file is obtained from the recording medium 18. Subsequently, by referring to the obtained digest list file, the reproduction of the reproduction-suspended main image data piece is restarted from a position close or corresponding to the detected reproduction-suspended position. Accordingly, the image data reproducing apparatus 20 is convenient to the user.

As previously mentioned, regarding the command in the command information piece “2” concerning the reproduction change button picture 111, the reproduction controlling section 24 decides whether or not the value indicative of a main list file is recorded in the reproduced picture selection memory 24b. In the case where the value indicative of a digest list file is recorded in the reproduced picture selection memory 24b, that is, in the case where a digest image data piece is reproduced before the indication of the reproduction change menu picture 110, the reproduction controlling section 24 moves from the operation state about the command information piece “2” to the operation state about the command information piece “4” (the second next command information piece).

As previously mentioned, the command in the command information piece “4” concerning the reproduction change picture button 111 is “record value indicative of main list file into reproduced picture selection memory”. Accordingly, the reproduction controlling section 24 records the value indicative of the main list file into the reproduced picture selection memory 24b. As previously mentioned, the command in the command information piece “5” concerning the reproduction change picture button 111 is “obtain number N that is list file name recorded in resume memory”. Accordingly, the reproduction controlling section 24 fetches the ID number (the file name) of the digest list file from the resume memory 24a. The digest list file having the fetched ID number mentions the reproduction-suspended main image data piece.

As previously mentioned, the command in the command information piece “6” concerning the reproduction change picture button 111 is “reproduce list file having name equal to obtained number N minus 100”. Accordingly, the reproduction controlling section 24 subtracts “100” from the fetched ID number of the digest list file. The reproduction controlling section 24 controls the reproducing section 22 to read, from the recording medium 18, the main list file having an ID number equal to the result of the subtraction. The read main list file corresponds to the same group as that relating to the digest list file. For example, when the fetched ID number of the digest list file is “101”, the ID number of the read main list file is “001” (equal to “101” minus “100”). Then, the reproduction controlling section 24 controls the reproducing section 22 to read main image data pieces from the recording medium 18 according to the read main list file. The reproducing section 22 sends the read main image data pieces to the display 23. The display 23 indicates the contents of the main image data pieces. In this way, the main image data pieces are reproduced according to the read main list file.

As previously mentioned, the command information piece “7” concerning the reproduction change picture button 111 is to move to the command information piece “11”. Accordingly, the reproduction controlling section 24 executes the command in the command information piece “11”. As previously mentioned, the command in the command information piece “11” concerning the reproduction change button picture 111 is “end”. Thus, the reproduction controlling section 24 terminates operating in response to the commands concerning the reproduction change button picture 111.

While the value indicative of a digest list file is recorded in the reproduced picture selection memory 24b and one among the digest image data pieces mentioned in the digest list file is being reproduced, the user can input a request for indicating a menu picture via the menu indication button 25. Upon the inputting of user's request for indicating a menu picture, the reproduction of the current digest image data piece is suspended and the reproduction change menu picture 110 is indicated on the display 23. When the reproduction change button picture 111 is selected in the indicated reproduction change menu picture 110 and this selection is decided by the user through the use of the cross keys and decision button 26, the reproduction of the main image data pieces mentioned in the main list file corresponding to the same group as that relating to the above digest list file is started. In this way, the reproduction of the digest image data pieces mentioned in the digest list file is replaced by the reproduction of the main image data pieces mentioned in the main list file corresponding to the same group as that relating to the digest list file. An outline of the contents of the main image data pieces can be grasped through the reproduction of the digest image data pieces. When a desired picture is found, the reproduction of a digest image data piece can be replaced by the reproduction of a main image data piece corresponding to the found desired picture. Thereafter, the reproduction of the main image data piece can be replaced by the reproduction of the digest image data piece.

When the reproduction of the current digest image data piece (the portion of a main image data piece) is suspended in response to the inputting of user's request for indicating a menu picture via the menu indication button 25, the reproduction controlling section 24 records, into the resume memory 24a, reproduction-suspension point information representative of the ID number of the digest list file mentioning the reproduction-suspended main image data piece, the ID number of the reproduction-suspended main image data piece, and the reproduction-suspended position in the reproduction-suspended main image data piece. At this time, the reproduction change menu picture 110 starts to be indicated on the display 23. When the reproduction change button picture 111 is selected in the indicated reproduction change menu picture 110 and this selection is decided, the reproduction-suspension point information is fetched from the resume memory 24a. The ID number of the digest list file mentioning the reproduction-suspended main image data piece, the ID number of the reproduction-suspended main image data piece, and the reproduction-suspended position in the reproduction-suspended main image data piece are detected from the fetched reproduction-suspension point information. Then, the main list file having an ID number equal to the detected ID number of the digest list file minus “100” is obtained from the recording medium 18. Subsequently, by referring to the obtained main list file, the reproduction of the reproduction-suspended main image data piece is restarted from the detected reproduction-suspended position. Accordingly, the image data reproducing apparatus 20 is convenient to the user.

When switching between the reproduction of main image data pieces and the reproduction of digest image data pieces is performed as previously mentioned, the reproduction controlling section 24 implements the following procedure. First, the reproduction controlling section 24 decides whether or not user's request for indicating a menu picture is inputted via the menu indication button 25. In the absence of the inputting of user's request for indicating a menu picture, the reproduction of the main image data pieces or the digest image data pieces is continued until being completed. Thereafter, the reproduction controlling section 24 executes the command in the last one of the command information pieces “1”, “2”, and “3” concerning the button pictures 73a, 73b, and 73c or the command in the last one of the command information pieces “1”, “2”, “3”, and “4” concerning the button pictures 73d, 73e, and 73f. As previously mentioned, the command in the last command information piece is “end”. Accordingly, the reproduction controlling section 24 terminates the reproduction of the main image data pieces or the digest image data pieces.

On the other hand, in the presence of the inputting of user's request for indicating a menu picture via the menu indication button 25 during the reproduction of the main image data pieces or the digest image data pieces, the reproduction controlling section 24 suspends the reproduction. Since the digest image data pieces are the portions of the main image data pieces, suspending the reproduction of the digest image data pieces means suspending the reproduction of the portions of the main image data pieces. The reproduction controlling section 24 detects the ID number (the file name) of the main list file mentioning the reproduction-suspended main image data piece or the digest list file mentioning the reproduction-suspended main image data piece, the ID number of the reproduction-suspended main image data piece, and the reproduction-suspended position in the reproduction-suspended main image data piece. The reproduction-suspended position is expressed by the number of frames, GOPs, or bytes counted from the head of the reproduction-suspended main image data piece. The reproduction-suspended position may be expressed by the time elapsed from the moment corresponding to the head of the reproduction-suspended main image data piece. The reproduction controlling section 24 records, into the resume memory 24a, reproduction-suspension point information representative of the detected ID number (the detected file name) of the main list file or the digest list file, the detected ID number of the reproduction-suspended main image data piece, and the detected reproduction-suspended position. Then, the image data reproducing apparatus 20 starts operating in the initial-reproduction-information responsive mode.

In these cases, the reproduction controlling section 23 always records the value indicative of the reproduction change menu into the menu memory 24c in response to the selection of the reproduction change button picture 111 or the cancel button picture 113 and the decision of this selection before the initial-reproduction-information responsive mode of operation is started. Thus, during the initial-reproduction-information responsive mode of operation, the reproduction controlling section 24 decides that the value indicative of the reproduction change menu is recorded in the menu memory 24c. As a result, the reproduction controlling section 24 operates to indicate the reproduction change menu picture 110 on the display 23.

In this way, when the reproduction change button picture 111 or the cancel button picture 113 is selected in the indicated reproduction change menu picture 110 and this selection is decided, the reproduction of main image data pieces or digest image data pieces is started. Thereafter, upon the inputting of user's request for indicating a menu picture, the reproduction change menu picture 110 is always indicated on the display 23 again. By selecting the reproduction change button picture 111 in the indicated reproduction change menu picture 110 and deciding this selection, switching between the reproduction of the main image data pieces and the reproduction of the digest image data pieces is performed. Accordingly, it is possible to easily implement two-way switching between the reproduction of the main image data pieces and the reproduction of the digest image data pieces.

As previously mentioned, in the case where the reproduction change menu button 111 is selected in the indicated reproduction change menu picture 110 and this selection is decided after the reproduction of a main image data piece is suspended, the reproduction of a digest image data piece is started from a position close or corresponding to the reproduction-suspended position in the reproduction-suspended main image data piece. On the other hand, in the case where the reproduction change menu button 111 is selected in the indicated reproduction change menu picture 110 and this selection is decided after the reproduction of a digest image data piece is suspended, the reproduction of a main image data piece is started from the reproduction-suspended position. Therefore, it is possible to implement two-way switching between the reproduction of main image data pieces and the reproduction of digest image data pieces. The image data reproducing apparatus 20 is convenient.

Thus, switching between the reproduction of first image data pieces (main image data pieces) in a group and the reproduction of second image data pieces (digest image data pieces) in a group corresponding to that having the first image data pieces can be performed. Therefore, switching between multiple angles can be implemented. Regarding a move in which first and second characters exist, switching between the playback of a stream of pictures featuring the first character and the playback of a stream of pictures featuring the second character can be performed.

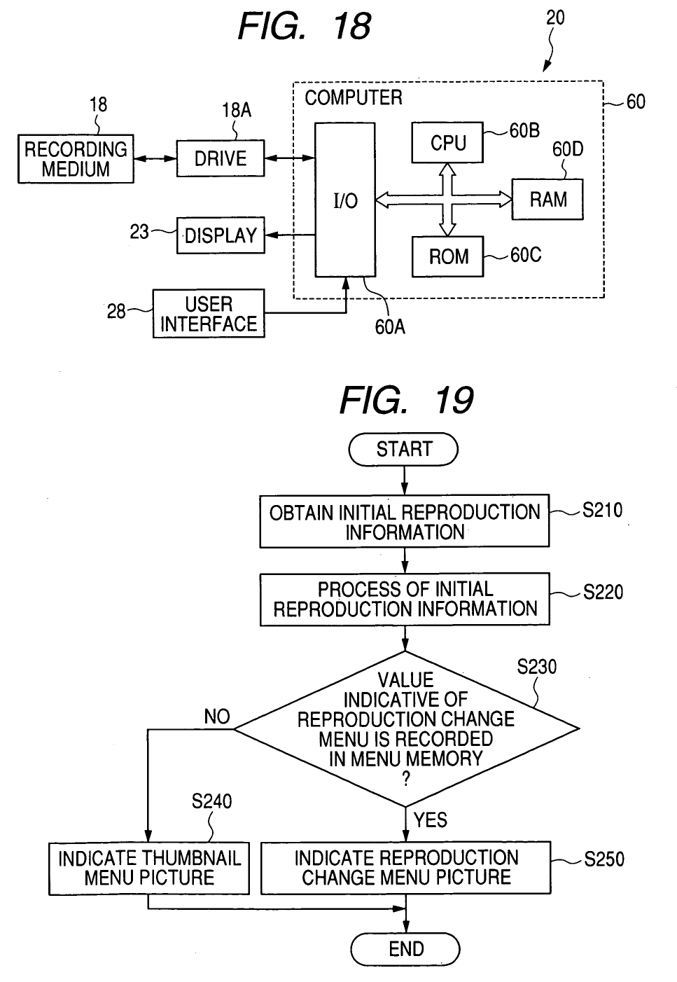

FIG. 18 shows the hardware structure of the image data reproducing apparatus 20. As shown in FIG. 18, the image data reproducing apparatus 20 includes a computer 60. The reproduction controlling section 24 and a part of the reproducing section 22 in FIG. 17 are implemented by the computer 60.

The computer 60 has an I/O port 60A, a CPU 60B, a ROM 60C, and a RAM 60D which are connected by a bus. The display 23 is connected with the I/O port 60A of the computer 60.

The image data reproducing apparatus 20 includes the drive 18A for the recording medium 18. The drive 18A is connected with the I/O port 60A of the computer 60. The reproducing section 22 in FIG. 17 is partially implemented by the drive 18A.

The image data reproducing apparatus 20 includes a user interface 28 connected with the I/O port 60A of the computer 60. The user interface 28 contains the menu indication button 25, the cross keys and decision button 26, and the reproduction operation inputting section 27 in FIG. 17. The user can input various requests into the computer 60 via the user interface 28.

The computer 60 or the CPU 60B operates in accordance with a control program (a computer program) stored in the ROM 60C and the RAM 60D. The control program is designed to enable the computer 60 or the CPU 60B to implement actions mentioned hereafter.

The computer 60 or the CPU 60B provides the resume memory 24a, the reproduced picture selection memory 24b, and the menu memory 24c in the RAM 60D.

FIG. 19 is a flowchart of a first segment of the control program for the computer 60 (the CPU 60B) which relates to the initial-reproduction-information responsive mode of operation of the image data reproducing apparatus 20.

As shown in FIG. 19, a first step S210 of the program segment controls the drive 18A to obtain the initial reproduction information from the recording medium 18.

A step S220 following the step S2 10 incorporates the obtained initial reproduction information into a later part of the present program segment.

A step S230 subsequent to the step S220 decides whether or not the value indicative of the reproduction change menu is recorded in the menu memory 24c. The step S230 relates to the command information piece “1” in the initial reproduction information. When the value indicative of the reproduction change menu is recorded in the menu memory 24c, the program advances from the step S230 to a step S250. Otherwise, the program advances from the step S230 to a step S240.

The step S240 controls the drive 18A to read the main portion of the thumbnail menu picture data from the recording medium 18. The step S240 feeds the read main portion of thumbnail menu picture data to the display 23, and controls the display 23 to indicate the thumbnail menu picture 70 represented by the fed main portion of the thumbnail menu picture data. The step S240 is provided by the command information piece “3” in the initial reproduction information. After the step S240, the current execution cycle of the program segment ends.

The step S250 controls the drive 18A to read the main portion of the reproduction change menu picture data from the recording medium 18. The step S250 feeds the read main portion of the reproduction change menu picture data to the display 23, and controls the display 23 to indicate the reproduction change menu picture 110 represented by the fed main portion of the reproduction change menu picture data. The step S250 is provided by the command information piece “5” in the initial reproduction information. After the step S250, the current execution cycle of the program segment ends.

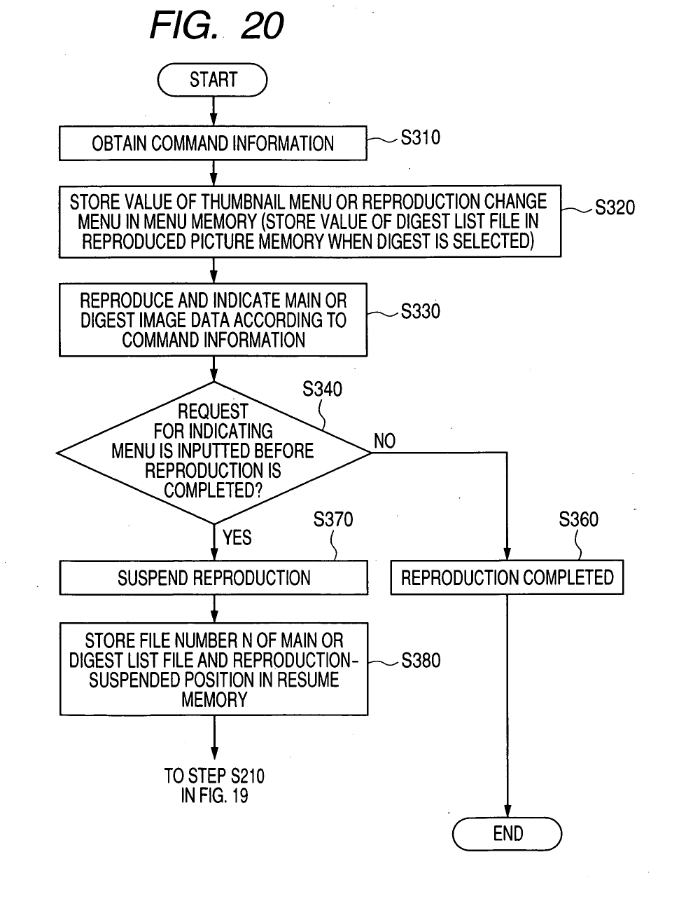

FIG. 20 is a flowchart of a second segment of the control program for the computer 60 (the CPU 60B) which relates to the image-data reproducing mode of operation of the image data reproducing apparatus 20 in response to the selection of one from the button pictures 73a-73f in the indicated thumbnail menu picture 70 and the decision of this selection, or in response to the selection of one from the button pictures 73a-73f in the indicated thumbnail menu picture 70 and the inputting of user's request for reproduction start.

As shown in FIG. 20, a first step S310 of the program segment controls the drive 18A to obtain the command information pieces concerning the selected button picture from the recording medium 18. The step S310 incorporates the obtained command information pieces into a later part of the program segment.

A step S320 following the step S310 writes the value indicative of the thumbnail menu into the menu memory 24c when the selected button picture is one of the button pictures 73a, 73b, and 73c. The step S320 writes the value indicative of the reproduction change menu into the menu memory 24c when the selected button picture is one of the button pictures 73d, 73e, and 73f. The step S320 writes the value indicative of a digest list file into the reproduced picture selection memory 24b when the selected button picture is one of the button pictures 73d, 73e, and 73f. The digest list file corresponds to the group relating to the selected button picture 73d, 73e, or 73f. The step S320 is provided by the command information piece “1” when the selected button picture is one of the button pictures 73a, 73b, and 73c. The step S320 is provided by the command information pieces “1” and “2” when the selected button picture is one of the button pictures 73d, 73e, and 73f.

A step S330 subsequent to the step S320 controls the drive 18A to obtain, from the recording medium 18, the main list file or the digest list file corresponding to the selected button picture. The step S330 controls the drive 18A to start reproducing main image data pieces or digest image data pieces from the recording medium 18 according to the obtained main list file or the obtained digest list file. The step S330 controls the display 23 to indicate the contents of the reproduced main image data pieces or the reproduced digest image data pieces. The step S330 is provided by the command information piece “2” when the selected button picture is one of the button pictures 73a, 73b, and 73c. The step S330 is provided by the command information piece “3” when the selected button picture is one of the button pictures 73d, 73e, and 73f.

A step S340 following the step S330 decides whether or not user's request for indicating a menu picture is inputted via the user interface 28 before the completion of the reproduction of the main image data pieces or the digest image data pieces. When the step S340 decides that user's request for indicating a menu picture is inputted, the program advances from the step S340 to a step S370. Otherwise, the program advances from the step S340 to a step S360.

Provided that the reproduction of the main image data pieces or the digest image data pieces has been completed, the program advances from the step S340 to the step S360. The step S360 deactivates the drive 18A to terminate the reproducing action. After the step S360, the current execution cycle of the program segment ends.

The step S370 deactivates the drive 18A to suspend the reproduction of the current main image data piece or the current digest image data piece. Since the digest image data piece is the portion of the main image data piece, suspending the reproduction of the digest image data piece means suspending the reproduction of the portion of the main image data piece.

A step S380 subsequent to the step S370 detects the ID number of the main list file mentioning the reproduction-suspended main image data piece or the digest list file mentioning the reproduction-suspended main image data piece, the ID number of the reproduction-suspended main image data piece, and the reproduction-suspended position in the reproduction-suspended main image data piece. The step S380 writes, into the resume memory 24a, reproduction-suspension point information representative of the detected ID number of the main list file or the digest list file, the detected ID number of the reproduction-suspended main image data piece, and the detected reproduction-suspended position. After the step S380, the program segment advances to the step S210 in FIG. 19.

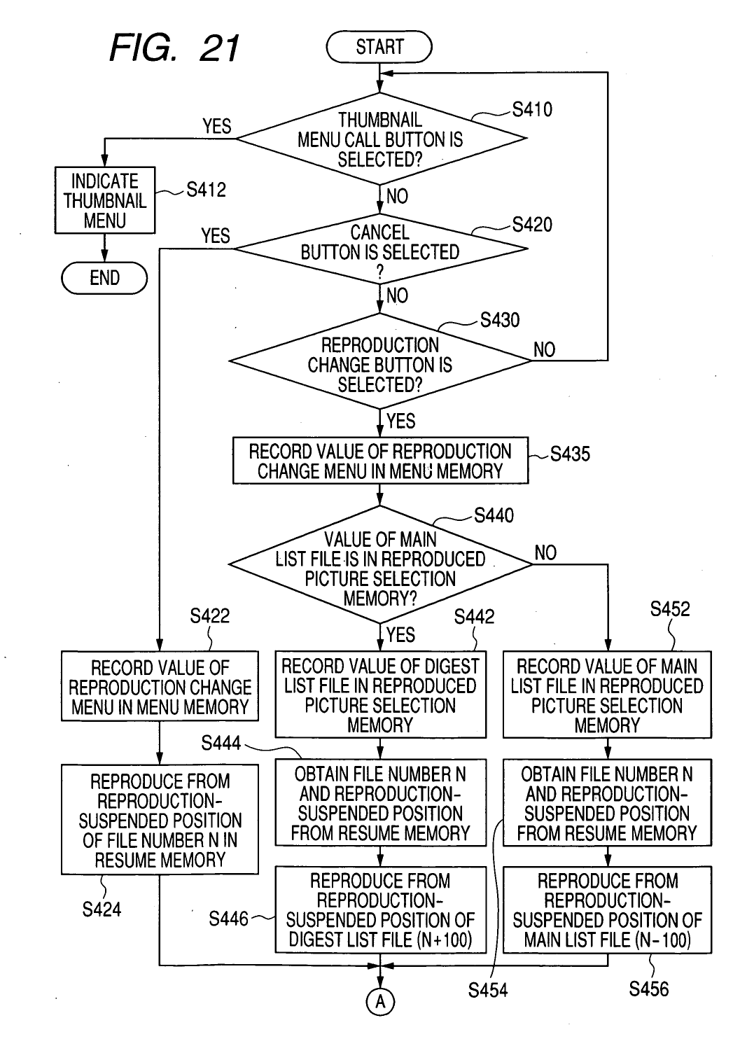

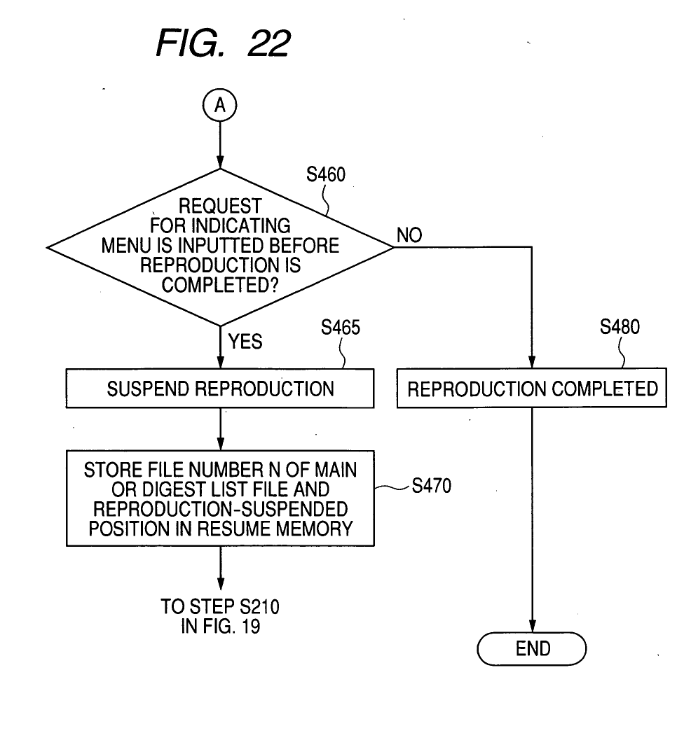

FIGS. 21 and 22 are a flowchart of a third segment of the control program for the computer 60 (the CPU 60B) which relates to the image-data reproducing mode of operation of the image data reproducing apparatus 20 in response to the selection of one from the button pictures 111, 112, and 113 in the indicated reproduction change menu picture 110 and the decision of this selection.

As shown in FIG. 21, a first step S410 of the program segment determines whether or not the thumbnail menu call button picture 112 is selected and this selection is decided on the basis of the output signals from the user interface 28. When the thumbnail menu call button picture 112 is selected and this selection is decided, the program advances from the step S410 to a step S412. Otherwise, the program advances from the step S410 to a step S420.

The step S412 controls the drive 18A to read, from the recording medium 18, the command information pieces “1” and “2” concerning the thumbnail menu call button picture 112. The S412 incorporates the read command information pieces “1” and “2” into a later part of the program segment. Then, the step S412 controls the drive 18A to read the main portion of the thumbnail menu picture data from the recording medium 18. The step S412 controls the display 23 to indicate the thumbnail menu picture 70 represented by the read main portion of the thumbnail menu picture data. The step S412 is partially provided by the command information piece “1” concerning the thumbnail menu call button picture 112. After the step S412, the current execution cycle of the program segment ends.

The step S420 determines whether or not the cancel button picture 113 is selected and this selection is decided on the basis of the output signals from the user interface 28. When the cancel button picture 113 is selected and this selection is decided, the program advances from the step S420 to a step S422. Otherwise, the program advances from the step S420 to a step S430.

The step S422 controls the drive 18A to read, from the recording medium 18, the command information pieces “1”, “2”, and “3” concerning the cancel button picture 113. The S422 incorporates the read command information pieces “1”, “2”, and “3” into a later part of the program segment. Then, the step S422 writes the value indicative of the reproduction change menu into the menu memory 24c. The step S422 is partially provided by the command information piece “1” concerning the cancel button picture 113.

A step S424 following the step S422 reads the reproduction-suspension point information from the resume memory 24a. The step S424 derives, from the read reproduction-suspension point information, the ID number of the main list file mentioning the reproduction-suspended main image data piece or the digest list file mentioning the reproduction-suspended main image data piece, the ID number of the reproduction-suspended main image data piece, and the reproduction-suspended position in the reproduction-suspended main image data piece. Then, the step S424 controls the drive 18A to read, from the recording medium 18, the main list file or the digest list file having the derived ID number. Subsequently, by referring to the read main list file or the read digest list file, the step S424 controls the drive 18A to restart reproducing the reproduction-suspended main image data piece from the recording medium 18 at the reproduction-suspended position or a position close or corresponding to the reproduction-suspended position. Thus, the step S424 restarts the reproduction of the main image data pieces or the digest image data pieces from the recording medium 18 according to the read main list file or the read digest list file. The step S424 controls the display 23 to indicate the contents of the reproduced main image data pieces or the reproduced digest image data pieces. The step S424 is provided by the command information piece “2” concerning the cancel button picture 113. After the step S424, the program advances to a step S460 in FIG. 22.

The step S430 determines whether or not the reproduction change button picture 111 is selected and this selection is decided on the basis of the output signals from the user interface 28. When the reproduction change button picture 111 is selected and this selection is decided, the program advances from the step S430 to a step S435. Otherwise, the program returns from the step S430 to the step S410.

The step S435 controls the drive 18A to read, from the recording medium 18, the command information pieces “1”-“11” concerning the reproduction change button picture 111. The S435 incorporates the read command information pieces “1”-“11” into a later part of the program segment. Then, the step S435 writes the value indicative of the reproduction change menu into the menu memory 24c. The step S435 is partially provided by the command information piece “1” concerning the reproduction change button picture 111.

A step S440 following the step S435 decides whether or not the value indicative of a main list file is stored in the reproduced picture selection memory 24b. The step S440 relates to the command information piece “2” concerning the reproduction change button picture 111. When the value indicative of a main list file is stored in the reproduced picture selection memory 24b, the program advances from the step S440 to a step S442. Otherwise, the program advances from the step S440 to a step S452.

The step S442 writes the value indicative of a digest list file into the reproduced picture selection memory 24b. The digest list file corresponds to the same group as that relating to the main list file mentioning the reproduction-suspended main image data piece. The step S442 is provided by the command information piece “8” concerning the reproduction change button picture 111.

A step S444 subsequent to the step S442 reads the reproduction-suspension point information from the resume memory 24a. The step S444 derives, from the read reproduction-suspension point information, the ID number of the main list file mentioning the reproduction-suspended main image data piece, the ID number of the reproduction-suspended main image data piece, and the reproduction-suspended position in the reproduction-suspended main image data piece. The step S444 is partially provided by the command information piece “9” concerning the reproduction change button picture 111.

A step S446 following the step S444 adds “100” to the derived ID number of the main list file mentioning the reproduction-suspended main image data piece. The step S446 controls the drive 18A to read, from the recording medium 18, the digest list file having an ID number equal to the result of the addition. Then, according to the read digest list file, the step S446 controls the drive 18A to start reproducing digest image data pieces from the recording medium 18 at a position close or corresponding to the derived reproduction-suspended position in the reproduction-suspended main image data piece. The step S446 controls the display 23 to indicate the contents of the reproduced digest image data pieces. The step S446 is provided by the command information piece “10” concerning the reproduction change button picture 111. After the step S446, the program advances to the step S460 in FIG. 22.

The step S452 writes the value indicative of a main list file into the reproduced picture selection memory 24b. The main list file corresponds to the same group as that relating to the digest list file mentioning the reproduction-suspended main image data piece. The step S452 is provided by the command information piece “4” concerning the reproduction change button picture 111.

A step S454 subsequent to the step S452 reads the reproduction-suspension point information from the resume memory 24a. The step S454 derives, from the read reproduction-suspension point information, the ID number of the digest list file mentioning the reproduction-suspended main image data piece, the ID number of the reproduction-suspended main image data piece, and the reproduction-suspended position in the reproduction-suspended main image data piece. The step S454 is partially provided by the command information piece “5” concerning the reproduction change button picture 111.

A step S456 following the step S454 subtracts “100” from the derived ID number of the digest list file mentioning the reproduction-suspended main image data piece. The step S456 controls the drive 18A to read, from the recording medium 18, the main list file having an ID number equal to the result of the subtraction. Then, according to the read main list file, the step S456 controls the drive 18A to start reproducing main image data pieces from the recording medium 18 at the derived reproduction-suspended position. The step S456 controls the display 23 to indicate the contents of the reproduced main image data pieces. The step S456 is provided by the command information piece “6” concerning the reproduction change button picture 111. After the step S456, the program advances to the step S460 in FIG. 22.

As shown in FIG. 22, the step S460 decides whether or not user's request for indicating a menu picture is inputted via the user interface 28 before the completion of the reproduction of the main image data pieces or the digest image data pieces. When the step S460 decides that user's request for indicating a menu picture is inputted, the program advances from the step S460 to a step S465. Otherwise, the program advances from the step S460 to a step S480.

Provided that the reproduction of the main image data pieces or the digest image data pieces has been completed, the program advances from the step S460 to the step S480. The step S480 deactivates the drive 18A to terminate the reproducing action. After the step S480, the current execution cycle of the program segment ends.

The step S465 deactivates the drive 18A to suspend the reproduction of the current main image data piece or the current digest image data piece. Since the digest image data piece is the portion of the main image data piece, suspending the reproduction of the digest image data piece means suspending the reproduction of the portion of the main image data piece.

A step S470 subsequent to the step S465 detects the ID number of the main list file mentioning the reproduction-suspended main image data piece or the digest list file mentioning the reproduction-suspended main image data piece, the ID number of the reproduction-suspended main image data piece, and the reproduction-suspended position in the reproduction-suspended main image data piece. The step S470 writes, into the resume memory 24a, reproduction-suspension point information representative of the detected ID number of the main list file or the digest list file, the detected ID number of the reproduction-suspended main image data piece, and the detected reproduction-suspended position. After the step S470, the program segment advances to the step S210 in FIG. 19.

### Second Embodiment

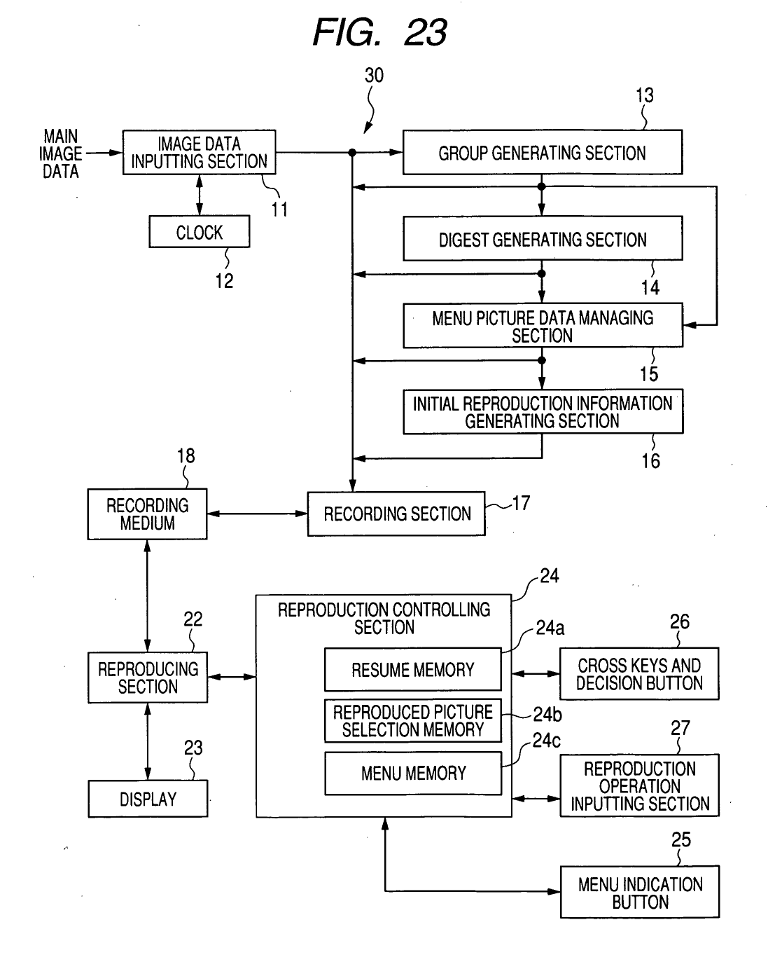

FIG. 23 shows an image data recording and reproducing apparatus 30 according to a second embodiment of this invention. The image data recording and reproducing apparatus 30 includes a combination of the image data recording apparatus 10 in FIG. 1 and the image data reproducing apparatus 20 in FIG. 17.

### Third Embodiment

A third embodiment of this invention is similar to the first or second embodiment thereof except for design changes mentioned hereafter.

In the third embodiment of this invention, the image data reproducing apparatus 20 implements a reproduction starting procedure when user's request for reproduction start is inputted into the apparatus 20 by depressing a reproduction start button on the reproduction operation inputting section 27. User's request for reproduction start may be inputted into the apparatus 20 by selecting a reproduction start button picture indicated on the display 23 and deciding this selection through the use of the cross keys and decision button 26.

The image data reproducing apparatus 20 may implement the reproduction starting procedure when a power supply to the apparatus 20 is turned on or when the recording medium 18 is connected with or inserted into the apparatus 20.

During the reproduction starting procedure, the reproduction controlling section 24 obtains the initial reproduction information from the recording medium 18 through the use of the reproducing section 22. As previously mentioned, the initial reproduction information has the command information pieces “1”, “2”, “3”, “4”, “5”, and “6”. The reproduction controlling section 24 sequentially executes ones among the commands in the command information pieces “1”, “2”, “3”, “4”, “5”, and “6” in that order. Thereby, the reproduction controlling section 24 implements reproduction control in accordance with the initial reproduction information.

First, the reproduction controlling section 24 executes the command in the command information piece “1”. As previously mentioned, the command in the command information piece “1” is to move to the next command information piece (the command information piece “2”) when the value indicative of the reproduction change menu is recorded in the menu memory 24c, and is to ignore the next command information piece and move to the second next command information piece (the command information piece “3”) in the other cases. Normally, an initial value different from the value indicative of the reproduction change menu is recorded in the menu memory 24c. Therefore, the reproduction controlling section 24 ignores the command information piece “2”, and then executes the command in the command information piece “3”.

As previously mentioned, the command information piece “3” is to reproduce and indicate the thumbnail menu picture 70. Accordingly, the reproduction controlling section 24 controls the reproducing section 22 to read the thumbnail menu picture data from the recording medium 18 and send the thumbnail menu picture data to the display 23. The display 23 indicates the thumbnail menu picture 70 represented by the thumbnail menu picture data.

Thereafter, the reproduction controlling section 24 executes the command in the command information piece “4”. As previously mentioned, the command information piece “4” is to move to the command information piece “6”. Accordingly, the reproduction controlling section 24 executes the command in the command information piece “6”. Since the command in the command information piece “6” is “end” as previously mentioned, the reproduction controlling section 24 terminates the reproduction control which responds to the initial reproduction information. Preferably, the thumbnail menu picture 70 continues to be indicated on the display 23 until the reproduction controlling section 24 implements reproduction control for the next time.

The thumbnail menu picture 70 indicated on the display 23 has the thumbnail pictures 71a-71f and the button pictures 73a-73f. The button pictures 73a-73f correspond to the thumbnail pictures 71a-71f, respectively. Generally, when the user finds desired one among the thumbnail pictures 71a-71f, the user selects one, which corresponds to the desired thumbnail picture, from the button pictures 73a-73f and then decides this selection through the use of the cross keys and decision button 26. The control information in the thumbnail menu picture data has the direction information pieces for each of the button pictures 73a-73f. The direction information pieces represent to which of the button pictures 73a-73f movements from the present button should be made in response to inputted requests for up, down, left, and right movements. The user's request inputted via the cross keys and decision button 26 corresponds to one of the inputted requests for up, down, left, and right movements, and relates to one among the up, down, right, and left buttons relating to the selected button picture.

For example, when the button picture 73a is selected and user's request for right movement is inputted via the cross keys and decision button 26, the button picture 73b is newly selected. Then, when user's request for down movement is inputted via the cross keys and decision button 26, the button picture 73e is newly selected. In the case where the selection of the button picture 73e is decided through the use of the cross keys and decision button 26, the reproduction controlling section 24 starts sequentially executing the commands in the command information pieces “1”, “2”, “3”, and “4” concerning the button picture 73e.

The control information in the thumbnail menu picture data may have a piece denoting predetermined one among the button pictures 73a-73f which should be selected first upon the indication of the thumbnail menu picture 70 on the display 23. In this case, when the thumbnail menu picture 70 is indicated, the predetermined one among the button pictures 73a-73f is selected first.

By referring to the output signal from the cross keys and decision button 26, the reproduction controlling section 24 decides whether one of the button pictures 73a, 73b, and 73c or one of the button pictures 73d, 73e, and 73f is selected in the indicated thumbnail menu picture 70 and user's request for deciding this selection is inputted.

When one of the button pictures 73a, 73b, and 73c is selected in the thumbnail menu picture 70 and user's request for deciding this selection is inputted via the cross keys and decision button 26, the main image data pieces in the group corresponding to the selected button picture are reproduced from the recording medium 18.

In the case where the button picture 73a is selected in the thumbnail menu picture 70 and user's request for deciding this selection is inputted via the cross keys and decision button 26, the main image data pieces in the first group are reproduced from the recording medium 18. Specifically, the reproduction controlling section 24 obtains the command information pieces “1”, “2”, and “3” concerning the selected button picture 73a from the recording medium 18 via the reproducing section 22. The reproduction controlling section 24 sequentially executes the commands in the obtained command information pieces “1”, “2”, and “3”.

First, the reproduction controlling section 24 executes the command in the command information piece “1” concerning the selected button picture 73a. As previously mentioned, the command in the command information piece “1” takes the binary state “1000 0000 0000 0010” and is to record the value indicative of the thumbnail menu into the menu memory 24c. Accordingly, the reproduction controlling section 24 records the value “0000 0010”, that is, the value indicative of the thumbnail menu picture into the menu memory 24c.

Second, the reproduction controlling section 24 executes the command in the command information piece “2” concerning the selected button picture 73a. As previously mentioned, the command in the command information piece “2” is to reproduce the main list file named “list file 001”. Accordingly, the reproduction controlling section 24 obtains the main list file “001” from the recording medium 18 via the reproducing section 22. By referring to the obtained main list file “001”, the reproduction controlling section 24 controls the reproducing section 22 to sequentially read the main image data pieces in the first group from the recording medium 18 and send the read main image data pieces to the display 23. The contents of the main image data pieces in the first group are sequentially reproduced by the display 23.

In the absence of the inputting of user's request for indicating a menu picture via the menu indication button 25 during the reproduction of the main image data pieces in the first group, the reproduction is continued until being completed. Thereafter, the reproduction controlling section 24 executes the command in the command information piece “3” concerning the selected button picture 73a. As previously mentioned, the command in the command information piece “3” is “end”. Accordingly, the reproduction controlling section 24 terminates operating in response to the commands concerning the selected button picture 73a. At this time, the reproduction controlling section 24 may operate to indicate, on the display 23, a blue back picture or a message that reproduction has been completed and stopped.

On the other hand, in the presence of the inputting of user's request for indicating a menu picture via the menu indication button 25 during the reproduction of the main image data pieces in the first group, the reproduction controlling section 24 controls the reproducing section 22 to suspend the reproduction. At this time, the reproduction controlling section 24 detects the ID number (the file name) of the main list file mentioning the reproduction-suspended main image data piece, the ID number of the reproduction-suspended main image data piece, and the reproduction-suspended position in the reproduction-suspended main image data piece. The reproduction-suspended position is expressed by the number of frames, GOPs, or bytes counted from the head of the reproduction-suspended main image data piece. The reproduction-suspended position may be expressed by the time elapsed from the moment corresponding to the head of the reproduction-suspended main image data piece. The reproduction controlling section 24 records, into the resume memory 24a, reproduction-suspension point information representative of the detected ID number (the detected file name) of the main list file, the detected ID number of the reproduction-suspended main image data piece, and the detected reproduction-suspended position. Then, the image data reproducing apparatus 20 starts operating in the initial-reproduction-information responsive mode.

In this way, the value indicative of the thumbnail menu is recorded into the menu memory 24c according to the command in the command information piece “1” concerning the selected button picture 73a and the reproduction-suspension point information representative of the detected ID number (the list file “001”) of the main list file is recorded into the resume memory 24a before the image data reproducing apparatus 20 starts operating in the initial-reproduction-information responsive mode.

During the initial-reproduction-information responsive mode of operation, the reproduction controlling section 24 sequentially executes ones among the commands in the command information pieces “1”, “2”, “3”, “4”, “5”, and “6” in the initial reproduction information. First, the reproduction controlling section 24 executes the command in the command information piece “1”. As previously mentioned, the command in the command information piece “1” is to move to the next command information piece (the command information piece “2”) when the value indicative of the reproduction change menu is recorded in the menu memory 24c, and is to ignore the next command information piece and move to the second next command information piece (the command information piece “3”) in the other cases. Since the value indicative of the thumbnail menu which differs from the value indicative of the reproduction change menu is recorded in the menu memory 24c, the reproduction controlling section 24 ignores the command information piece “2”, and then executes the command in the command information piece “3”. As previously mentioned, the command information piece “3” is to reproduce and indicate the thumbnail menu picture 70. Accordingly, the reproduction controlling section 24 controls the reproducing section 22 to read the thumbnail menu picture data from the recording medium 18 and send the thumbnail menu picture data to the display 23. The display 23 indicates the thumbnail menu picture 70 represented by the thumbnail menu picture data. Thereafter, the reproduction controlling section 24 executes the command in the command information piece “4”. As previously mentioned, the command information piece “4” is to move to the command information piece “6”. Accordingly, the reproduction controlling section 24 executes the command in the command information piece “6”. Since the command in the command information piece “6” is “end” as previously mentioned, the reproduction controlling section 24 terminates the reproduction control which responds to the initial reproduction information.

The command in the command information piece “1” concerning each of the button pictures 73a, 73b, and 73c may be changed from “record value indicative of thumbnail menu into menu memory” to “record value indicative of reproduction change menu into menu memory”. In this case, during the initial-reproduction-information responsive mode of operation which is triggered by the inputting of user's request for indicating a menu picture via the menu indication button 25, the reproduction change menu picture 110 is indicated on the display 23 instead of the thumbnail menu picture 70.

The command information pieces “1”, “2”, and “3” concerning the button picture 73a may be replaced by the following command information pieces “1”, “2”, “3”, “4”, and “5”:

command information piece 1=record value indicative of thumbnail menu into menu memory;

command information piece 2=reproduce main list file named “list file 001”;

command information piece 3=reproduce main list file named “list file 002”;

command information piece 4=reproduce main list file named “list file 003”;

command information piece 3=end.

In this case, all the main image data pieces recorded on the recording medium 18 can be reproduced by selecting the button picture 73a and then deciding the selection.

When one of the button pictures 73d, 73e, and 73f is selected in the indicated thumbnail menu picture 70 and user's request for deciding this selection is inputted via the cross keys and decision button 26, the digest image data pieces in the group corresponding to the selected button picture are reproduced from the recording medium 18.

In the case where the button picture 73d is selected in the thumbnail menu picture 70 and user's request for deciding this selection is inputted via the cross keys and decision button 26, the digest image data pieces in the first group are reproduced from the recording medium 18. Specifically, the reproduction controlling section 24 obtains the command information pieces “1”, “2”, “3”, and “4” concerning the selected button picture 73d from the recording medium 18 via the reproducing section 22. The reproduction controlling section 24 sequentially executes the commands in the obtained command information pieces “1”, “2”, “3”, and “4”. According to the command in the command information piece “1” concerning the selected button picture 73d, the reproduction controlling section 24 records the value indicative of the reproduction change menu into the menu memory 24c. Subsequently, according to the command in the command information piece “2” concerning the selected button picture 73d, the reproduction controlling section 24 records the value indicative of the digest list file into the reproduced picture selection memory 24b. The digest list file corresponds to the group relating to the selected button picture 73d. Thereafter, according to the command in the command information piece “3” concerning the selected button picture 73d, the reproduction controlling section 24 obtains the related digest list file (list file 101”) from the recording medium 18 via the reproducing section 22. By referring to the obtained digest list file, the reproduction controlling section 24 controls the reproducing section 22 to sequentially read the digest image data pieces in the first group from the recording medium 18 and send the read digest image data pieces to the display 23. The contents of the digest image data pieces in the first group are sequentially reproduced by the display 23.

In the presence of the inputting of user's request for indicating a menu picture via the menu indication button 25 during the reproduction of the main image data pieces or the digest image data pieces, the reproduction controlling section 24 controls the reproducing section 22 to suspend the reproduction. Since the digest image data pieces are the portions of the main image data pieces, suspending the reproduction of the digest image data pieces means suspending the reproduction of the portions of the main image data pieces. The reproduction controlling section 24 detects the ID number (the file name) of the digest list file mentioning the reproduction-suspended main image data piece, the ID number of the reproduction-suspended main image data piece, and the reproduction-suspended position in the reproduction-suspended main image data piece. The reproduction-suspended position is expressed by the number of frames, GOPs, or bytes counted from the head of the reproduction-suspended main image data piece. The reproduction-suspended position may be expressed by the time elapsed from the moment corresponding to the head of the reproduction-suspended main image data piece. The reproduction controlling section 24 records, into the resume memory 24a, reproduction-suspension point information representative of the detected ID number (the file name) of the digest list file, the detected ID number of the reproduction-suspended main image data piece, and the detected reproduction-suspended position. Then, the image data reproducing apparatus 20 starts operating in the initial-reproduction-information responsive mode.

In this way, the value indicative of the reproduction change menu is recorded into the menu memory 24c according to the command in the command information piece “1” concerning the selected button picture 73d and the reproduction-suspension point information representative of the detected ID number of the digest list file is recorded into the resume memory 24a before the image data reproducing apparatus 20 starts operating in the initial-reproduction-information responsive mode.

During the initial-reproduction-information responsive mode of operation, the reproduction controlling section 24 sequentially executes ones among the commands in the command information pieces “1”, “2”, “3”, “4”, “5”, and “6” in the initial reproduction information. First, the reproduction controlling section 24 executes the command in the command information piece “1”. As previously mentioned, the command in the command information piece “1” is to move to the next command information piece (the command information piece “2”) when the value indicative of the reproduction change menu is recorded in the menu memory 24c, and is to ignore the next command information piece and move to the second next command information piece (the command information piece “3”) in the other cases. Since the value indicative of the reproduction change menu is recorded in the menu memory 24c, the reproduction controlling section 24 executes the command in the command information piece “2”. As previously mentioned, the command in the command information piece “2” is “move to command information piece 5”. Accordingly, the reproduction controlling section 24 executes the command in the command information piece “5”. As previously mentioned, the command in the command information piece “5” is “reproduce and indicate reproduction change menu picture”. Accordingly, the reproduction controlling section 24 controls the reproducing section 22 to read the reproduction change menu picture data from the recording medium 18 and send the read reproduction change menu picture data to the display 23. The display 23 indicates the reproduction change menu picture 110 represented by the reproduction change menu picture data. Thereafter, the reproduction controlling section 24 executes the command in the command information piece “6”. Since the command in the command information piece “6” is “end” as previously mentioned, the reproduction controlling section 24 terminates the reproduction control which responds to the initial reproduction information.

When the cancel button picture 113 is selected in the reproduction change menu picture 110 indicated on the display 23 and user's request for deciding this selection is inputted via the cross keys and decision button 26, the reproduction controlling section 24 sequentially executes the commands in the command information pieces “1”, “2”, and “3” concerning the cancel button picture 113.

As previously mentioned, the command in the command information piece “1” concerning the cancel button picture 113 is “record value indicative of reproduction change menu into menu memory”. Accordingly, the reproduction controlling section 24 records the value indicative of the reproduction change menu into the menu memory 24c. As previously mentioned, the command in the command information piece “2” concerning the cancel button picture 113 is “reproduce from position recorded in resume memory”. Accordingly, the reproduction controlling section 24 fetches the reproduction-suspension point information from the resume memory 24a. Then, the reproduction controlling section 24 derives, from the fetched reproduction-suspension point information, the ID number (the file name) of the digest list file mentioning the reproduction-suspended main image data piece, the ID number of the reproduction-suspended main image data piece, and the reproduction-suspended position in the reproduction-suspended main image data piece. Subsequently, the reproduction controlling section 24 controls the reproducing section 22 to read, from the recording medium 18, the digest list file having the derived ID number (the derived file name). Thereafter, by referring to the read digest list file, the reproduction controlling section 24 controls the reproducing section 22 to restart the reproduction of the reproduction-suspended main image data piece from the recording medium 18 at the derived reproduction-suspended position. Thus, the reproduction of the digest image data pieces from the recording medium 18 is restarted according to the read digest list file. Therefore, the indication of the contents of the digest image data pieces on the display 23 is restarted also.

In this way, when the cancel button picture 113 is selected in the reproduction change menu picture 110 indicated on the display 23 and user's request for deciding this selection is inputted via the cross keys and decision button 26, the indication of the contents of the digest image data piece on the display 23 is restarted from the reproduction-suspended position.

When the thumbnail menu call button picture 112 is selected in the reproduction change menu picture 110 indicated on the display 23 and user's request for deciding this selection is inputted via the cross keys and decision button 26, the reproduction controlling section 24 controls the reproducing section 22 to read, from the recording medium 18, the command information pieces “1” and “2” concerning the thumbnail menu call button picture 112. Then, the reproduction controlling section 24 sequentially executes the commands in the read command information pieces “1” and “2”.

As previously mentioned, the command in the command information piece “1” concerning the thumbnail menu call button picture 112 is to indicate the thumbnail menu picture 70. Accordingly, the reproduction controlling section 24 operates to indicate the thumbnail menu picture 70 on the display 23. Specifically, the reproduction controlling section 24 controls the reproducing section 22 to read the thumbnail menu picture data from the recording medium 18 and send the read thumbnail menu picture data to the display 23. The display 23 indicates the thumbnail menu picture 70 represented by the thumbnail menu picture data. As previously mentioned, the command in the command information piece “2” concerning the thumbnail menu call button picture 112 is “end”. Thus, the reproduction controlling section 24 terminates operating in response to the commands concerning the thumbnail menu call button picture 112.

When the reproduction change button picture 111 is selected in the reproduction change menu picture 110 indicated on the display 23 and user's request for deciding this selection is inputted via the cross keys and decision button 26, the reproduction controlling section 24 sequentially executes ones among the commands in the command information pieces “1”-“11” concerning the reproduction change button picture 111.

As previously mentioned, the command in the command information piece “1” concerning the reproduction change button picture 111 is “record value indicative of reproduction change menu into menu memory”. Accordingly, the reproduction controlling section 24 records the value indicative of the reproduction change menu into the menu memory 24c.

As previously mentioned, the command in the command information piece “2” concerning the reproduction change button picture 111 is “move to next command information piece when value indicative of main list file is recorded in reproduced picture selection memory (ignore next command information piece and move to second next command information piece in other cases)”. In the case where the button picture 73d is selected in the indicated thumbnail menu picture 70 and this selection is decided so that the digest image data pieces mentioned in the digest list file “101” are reproduced from the recording medium 18, the value indicative of the digest list file is recorded in the reproduced picture selection memory 24b. Thus, in this case, the reproduction controlling section 24 ignores the command information piece “3” and moves to the operation state about the command information piece “4”. As previously mentioned, the command in the command information piece “4” concerning the reproduction change picture button 111 is “record value indicative of main list file into reproduced picture selection memory”. Accordingly, the reproduction controlling section 24 records the value indicative of the main list file into the reproduced picture selection memory 24b. The main list file corresponds to the group relating to the digest list file mentioning the reproduction-suspended main image data piece. At this time, the reproduction controlling section 24 erases the value indicative of the digest list file from the reproduced picture selection memory 24b.

As previously mentioned, the command in the command information piece “5” concerning the reproduction change picture button 111 is “obtain number N that is list file name recorded in resume memory”. Accordingly, the reproduction controlling section 24 fetches the ID number (101:the file name) of the digest list file from the resume memory 24a. The digest list file having the fetched ID number mentions the reproduction-suspended main image data piece. As previously mentioned, the command in the command information piece “6” concerning the reproduction change picture button 111 is “reproduce list file having name equal to obtained number N minus 100”. Accordingly, the reproduction controlling section 24 subtracts “100” from the fetched ID number (101) of the digest list file. The result of the subtraction is “001”. The reproduction controlling section 24 controls the reproducing section 22 to read, from the recording medium 18, the main list file having the ID number “001”. Then, the reproduction controlling section 24 controls the reproducing section 22 to read the main image data pieces from the recording medium 18 according to the read main list file. The reproducing section 22 sends the read main image data pieces to the display 23. The display 23 indicates the contents of the main image data pieces. In this way, the main image data pieces mentioned in the main list file having the ID number “001”, that is, the main image data pieces in the first group are reproduced from the recording medium 18.

When the reproduction of the main image data pieces in the first group from the recording medium 18 is completed, the reproduction controlling section 24 moves to the operation state about the command information piece “7” concerning the reproduction change picture button 111. As previously mentioned, the command information piece “7” is to move to the command information piece “11”. Accordingly, the reproduction controlling section 24 executes the command in the command information piece “11”. As previously mentioned, the command in the command information piece “11” concerning the reproduction change button picture 111 is “end”. Thus, the reproduction controlling section 24 terminates operating in response to the commands concerning the reproduction change button picture 111.

In the absence of the inputting of user's request for indicating a menu picture via the menu indication button 25 during the reproduction of the digest image data pieces mentioned in the digest list file “101”, the reproduction is continued until being completed. Thereafter, the reproduction controlling section 24 executes the command in the command information piece “4” concerning the button picture 73d. As previously mentioned, the command in the command information piece “4” is “end”. Accordingly, the reproduction controlling section 24 terminates the action for the reproduction of the digest image data pieces.

The command information pieces “1”, “2”, “3”, and “4” concerning the button picture 73d may be replaced by the following command information pieces “1”, “2”, “3”, “4”, “5”, and “6”:

command information piece 1=record value indicative of reproduction change menu into menu memory;

command information piece 2=record value indicative of digest list file into reproduced picture selection memory;

command information piece 3=reproduce digest list file named “list file 101 ”;

command information piece 4=reproduce digest list file named “list file 102”;

command information piece 5=reproduce digest list file named “list file 103”;

command information piece 6=end.

In this case, all the digest image data pieces in the first, second, and third groups can be reproduced from the recording medium 18 by selecting the button picture 73d and then deciding the selection. In the presence of the inputting of user's request for indicating a menu picture via the menu indication button 25 during the reproduction of a digest image data piece, the reproduction controlling section 24 controls the reproducing section 22 to suspend the reproduction and replace the reproduction of the digest image data piece with the reproduction of the main image data piece in the same group as that having the digest image data piece. Then, in the presence of the inputting of user's request for indicating a menu picture via the menu indication button 25 during the reproduction of a main image data piece, the reproduction controlling section 24 controls the reproducing section 22 to suspend the reproduction and records, into the resume memory 24a, reproduction-suspension point information representative of the ID number (the file name) of the main list file mentioning the reproduction-suspended main image data piece, the ID number of the reproduction-suspended main image data piece, and the reproduction-suspended position in the reproduction-suspended main image data piece. For example, the ID number of the main list file mentioning the reproduction-suspended main image data piece is “001”. Then, the image data reproducing apparatus 20 starts operating in the initial-reproduction-information responsive mode.

During the initial-reproduction-information responsive mode of operation, the reproduction controlling section 24 sequentially executes ones among the commands in the command information pieces “1”, “2”, “3”, “4”, “5”, and “6” in the initial reproduction information. First, the reproduction controlling section 24 executes the command in the command information piece “1”. As previously mentioned, the command in the command information piece “1” is to move to the next command information piece (the command information piece “2”) when the value indicative of the reproduction change menu is recorded in the menu memory 24c, and is to ignore the next command information piece and move to the second next command information piece (the command information piece “3”) in other cases. Since the value indicative of the reproduction change menu has been recorded in the menu memory 24c according to the command information piece “1” concerning the reproduction change button picture 111, the reproduction controlling section 24 moves to the operation state about the command information piece “2” in the initial reproduction information. The reproduction controlling section 24 executes the command in the command information piece “2”. As previously mentioned, the command in the command information piece “2” is “move to command information piece 5”. Accordingly, the reproduction controlling section 24 moves to the operation state about the command information piece “5”. The reproduction controlling section 24 executes the command in the command information piece “5”. As previously mentioned, the command in the command information piece “5” is “reproduce and indicate reproduction change menu picture”. Accordingly, the reproduction controlling section 24 controls the reproducing section 22 to read the reproduction change menu picture data from the recording medium 18 and send the read reproduction change menu picture data to the display 23. The display 23 indicates the reproduction change menu picture 110 represented by the reproduction change menu picture data. Thereafter, the reproduction controlling section 24 executes the command in the command information piece “6”. Since the command in the command information piece “6” is “end” as previously mentioned, the reproduction controlling section 24 terminates the reproduction control which responds to the initial reproduction information.

As previously mentioned, when one of the button pictures 73a, 73b, and 73c is selected in the indicated thumbnail menu picture 70 and this selection is decided via the cross keys and decision button 26, the main image data pieces mentioned in the main list file corresponding to the selected button picture are reproduced. In the presence of the inputting of user's request for indicating a menu picture via the menu indication button 25 during the reproduction of the main image data pieces, the thumbnail menu picture 70 is indicated on the display 23.

On the other hand, in the presence of the inputting of user's request for indicating a menu picture via the menu indication button 25 during the reproduction of the digest image data pieces, the reproduction change menu picture 110 is indicated on the display 23. When the reproduction change button picture 111 is selected in the indicated reproduction change menu picture 110 and this selection is decided via the cross keys and decision button 26, the reproduction of the main image data pieces is implemented. In the presence of the inputting of user's request for indicating a menu picture via the menu indication button 25 during the reproduction of the main image data pieces, the reproduction change menu picture 110 is indicated on the display 23.

When the thumbnail menu call button picture 112 or the cancel button picture 113 is selected in the indicated reproduction change menu picture 110 and this selection is decided via the cross keys and decision button 26, the reproduction controlling section 24 implements a processing sequence similar to the above-mentioned one performed regarding the reproduction of the digest image data pieces.

On the other hand, when the reproduction change button picture 111 is selected in the indicated reproduction change menu picture 110 and this selection is decided via the cross keys and decision button 26, the reproduction controlling section 24 sequentially executes ones among the commands in the command information pieces “1”-“11” concerning the reproduction change button picture 111.

As previously mentioned, the command in the command information piece “1” concerning the reproduction change button picture 111 is “record value indicative of reproduction change menu into menu memory”. Accordingly, the reproduction controlling section 24 records the value indicative of the reproduction change menu into the menu memory 24c.

As previously mentioned, the command in the command information piece “2” concerning the reproduction change button picture 111 is “move to next command information piece when value indicative of main list file is recorded in reproduced picture selection memory (ignore next command information piece and move to second next command information piece in other cases)”. In the case of the replacement of the reproduction of the digest image data pieces mentioned in the digest list file “101” with the reproduction of the main image data pieces mentioned in the main list file “001”, the value indicative of the main list file has been recorded in the reproduced picture selection memory 24b according to the command information piece “4” concerning the reproduction change button picture 111. Accordingly, the reproduction controlling section 24 moves to the operation state about the command information piece “3”. The reproduction controlling section 24 executes the command in the command information piece “3”. As previously mentioned, the command information piece “3” concerning the reproduction change picture button 111 is to move to the command information piece “8”. Accordingly, the reproduction controlling section 24 moves to the operation state about the command information piece “8”. The reproduction controlling section 24 executes the command in the command information piece “8”. As previously mentioned, the command in the command information piece “8” concerning the reproduction change picture button 111 is “record value indicative of digest list file into reproduced picture selection memory”. Accordingly, the reproduction controlling section 24 erases the value indicative of the main list file from the reproduced picture selection memory 24b, and then writes the value indicative of the digest list file thereinto. The digest list file corresponds to the same group as that relating to the digest list file.

As previously mentioned, the command in the command information piece “9” concerning the reproduction change picture button 111 is “obtain number N that is list file name recorded in resume memory”. Accordingly, the reproduction controlling section 24 fetches the ID number (001:the file name) of the main list file from the resume memory 24a. As previously mentioned, the command in the command information piece “10” concerning the reproduction change picture button 111 is “reproduce list file having name equal to obtained number N plus 100”. Accordingly, the reproduction controlling section 24 adds “100” to the fetched ID number of the main list file. The result of the addition is “101”. The reproduction controlling section 24 controls the reproducing section 22 to read, from the recording medium 18, the digest list file having the ID number “101”. Then, the reproduction controlling section 24 controls the reproducing section 22 to read the digest image data pieces from the recording medium 18 according to the read digest list file. The reproducing section 22 sends the read digest image data pieces to the display 23. The display 23 indicates the contents of the digest image data pieces. In this way, the digest image data pieces mentioned in the digest list file “101”, that is, the digest image data pieces in the first group are reproduced from the recording medium 18, and are visualized by the display 23. As previously mentioned, the command in the command information piece “11” concerning the reproduction change button picture 111 is “end”. Thus, the reproduction controlling section 24 terminates operating in response to the commands concerning the reproduction change button picture 111.

As previously mentioned, when one of the button pictures 73d, 73e, and 73f is selected in the indicated thumbnail menu picture 70 and this selection is decided via the cross keys and decision button 26, the digest image data pieces mentioned in the digest list file corresponding to the selected button picture start being reproduced from the recording medium 18. Then, in the presence of the inputting of user's request for indicating a menu picture via the menu indication button 25, the reproduction of the current digest image data piece is suspended. In this case, the reproduction-suspension point information representative of the ID number (the file name) of the digest list file mentioning the reproduction-suspended main image data piece, the ID number of the reproduction-suspended main image data piece, and the reproduction-suspended position in the reproduction-suspended main image data piece is recorded into the resume memory 24a. Thereafter, the reproduction change menu picture 110 is indicated on the display 23. When the reproduction change button picture 111 is selected in the indicated reproduction change menu picture 110 and this selection is decided via the cross keys and decision button 26, the reproduction of the main image data pieces in the same group as that having the reproduction-suspended main image data piece is started from the reproduction-suspended position.

Then, in the presence of the inputting of user's request for indicating a menu picture via the menu indication button 25, the reproduction of the current main image data piece is suspended. In this case, the reproduction-suspension point information representative of the ID number (the file name) of the main list file mentioning the reproduction-suspended main image data piece, the ID number of the reproduction-suspended main image data piece, and the reproduction-suspended position in the reproduction-suspended main image data piece is recorded into the resume memory 24a. Thereafter, the reproduction change menu picture 110 is indicated on the display 23. When the reproduction change button picture 111 is selected in the indicated reproduction change menu picture 110 and this selection is decided via the cross keys and decision button 26, the reproduction of the digest image data pieces in the same group as that having the reproduction-suspended main image data piece is started from a position close or corresponding to the reproduction-suspended position in the reproduction-suspended main image data piece.

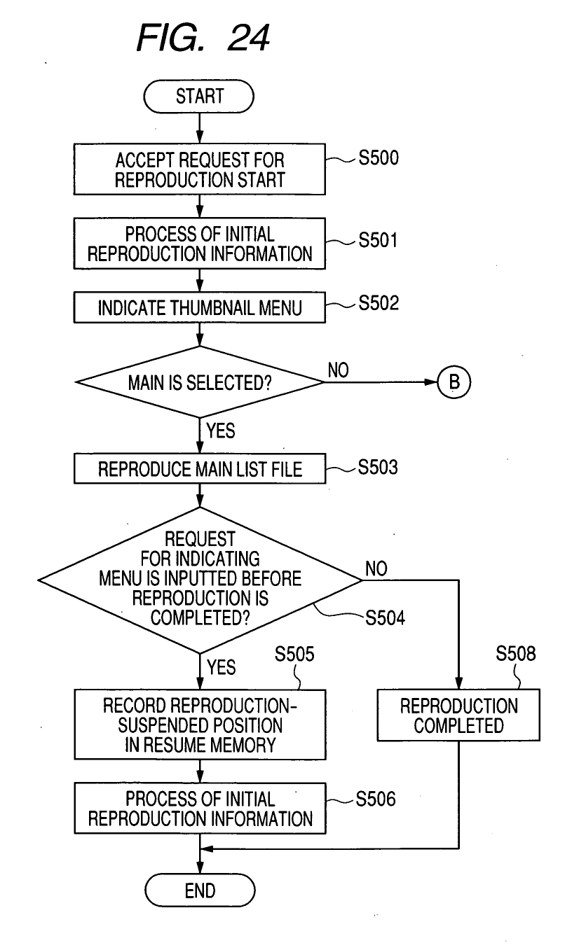

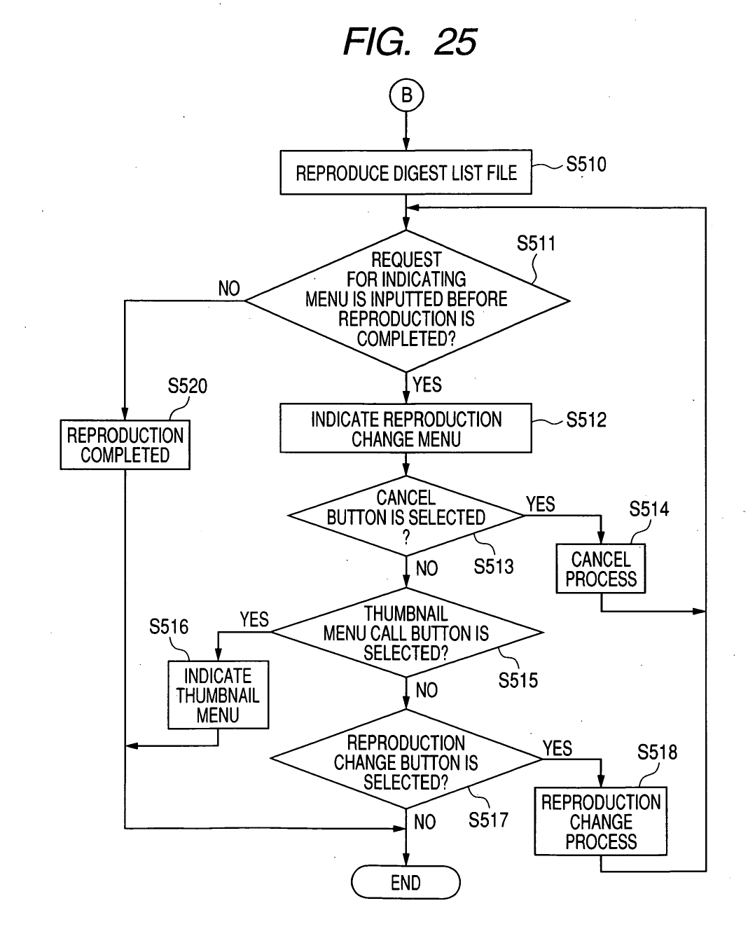

FIGS. 24 and 25 are a flowchart of a segment of the control program for the computer 60 (the CPU 60B) which is started when user's request for reproduction start is inputted into the computer 60 via the user interface 28.

As shown in FIG. 24, a first step S500 accepts the inputted user's request for reproduction start.

A step S501 following the step S500 controls the drive 18A to obtain the initial reproduction information from the recording medium 18. The step S501 incorporates the obtained initial reproduction information into a later part of the program segment. Then, the step S501 decides whether or not the value indicative of the reproduction change menu is recorded in the menu memory 24c. This decision by the step S501 relates to the command information piece “1” in the initial reproduction information. In this case, the value indicative of the reproduction change menu is not recorded in the menu memory 24c, and the program advances from the step S501 to a step S502.

The step S502 controls the drive 18A to read the main portion of the thumbnail menu picture data from the recording medium 18. The step S502 feeds the read data to the display 23, and controls the display 23 to indicate the thumbnail menu picture 70 represented by the fed data. The step S240 is provided by the command information piece “3” in the initial reproduction information.

A step S503A subsequent to the step S502 refers to the output signals from the user interface 28 and thereby determines whether one of the button pictures 73a, 73b, and 73c or one of the button pictures 73d, 73e, and 73f is selected in the indicated thumbnail menu picture 70 and user's request for deciding this selection is inputted. When one of the button pictures 73a, 73b, and 73c is selected and user's request for deciding this selection is inputted, the program advances from the step S503A to a step S503. On the other hand, when one of the button pictures 73d, 73e, and 73f is selected and user's request for deciding this selection is inputted, the program advances from the step S503A to a step S510 in FIG. 25.

The step S503 controls the drive 18A to obtain the command information pieces concerning the selected button picture from the recording medium 18. The step S503 incorporates the obtained command information pieces into a later part of the program segment. Then, the step S503 writes the value indicative of the thumbnail menu into the menu memory 24c. This writing action is provided by the command information piece “1” concerning the selected button picture. The step S503 controls the drive 18A to obtain, from the recording medium 18, the main list file corresponding to the selected button picture. The step S503 controls the drive 18A to start reproducing main image data pieces from the recording medium 18 according to the obtained main list file. The step S503 controls the display 23 to indicate the contents of the reproduced main image data pieces. This reproducing action is provided by the command information piece “2” concerning the selected button picture.

A step S504 following the step S503 decides whether or not user's request for indicating a menu picture is inputted via the user interface 28 before the completion of the reproduction of the main image data pieces. When the step S504 decides that user's request for indicating a menu picture is inputted, the program advances from the step S504 to a step S505. Otherwise, the program advances from the step S504 to a step S508.

Provided that the reproduction of the main image data pieces has been completed, the program advances from the step S504 to the step S508. The step S508 deactivates the drive 18A to terminate the reproducing action. After the step S508, the current execution cycle of the program segment ends.

The step S505 deactivates the drive 18A to suspend the reproduction of the current main image data piece. The step S505 detects the ID number of the main list file mentioning the reproduction-suspended main image data piece, the ID number of the reproduction-suspended main image data piece, and the reproduction-suspended position in the reproduction-suspended main image data piece. The step S505 writes, into the resume memory 24a, reproduction-suspension point information representative of the detected ID number of the main list file, the detected ID number of the reproduction-suspended main image data piece, and the detected reproduction-suspended position.

A step S506 subsequent to the step S505 forces the image data reproducing apparatus 20 to start operating in the initial-reproduction-information responsive mode. After the step S506, the current execution cycle of the program segment ends.

The step S510 in FIG. 25 controls the drive 18A to obtain the command information pieces concerning the selected button picture from the recording medium 18. The step S510 incorporates the obtained command information pieces into a later part of the program segment. Then, the step S510 writes the value indicative of the reproduction change menu into the menu memory 24c. This writing action is provided by the command information piece “1” concerning the selected button picture. The step S510 writes the value indicative of the digest list file into the reproduced picture selection memory 24b. The digest list file corresponds to the group relating to the selected button picture. This writing action is provided by the command information piece “2” concerning the selected button picture. The step S510 controls the drive 18A to obtain, from the recording medium 18, the digest list file corresponding to the selected button picture. The step S510 controls the drive 18A to start reproducing digest image data pieces from the recording medium 18 according to the obtained digest list file. The step S510 controls the display 23 to indicate the contents of the reproduced digest image data pieces. This reproducing action is provided by the command information piece “3” concerning the selected button picture. After the step S510, the program advances to a step S511.

The step S511 decides whether or not user's request for indicating a menu picture is inputted via the user interface 28 before the completion of the reproduction of the digest image data pieces or the main image data pieces. When the step S511 decides that user's request for indicating a menu picture is inputted, the program advances from the step S511 to a step S512. Otherwise, the program advances from the step S511 to a step S520.

Provided that the reproduction of the digest image data pieces or the main image data pieces has been completed, the program advances from the step S511 to the step S520. The step S520 deactivates the drive 18A to terminate the reproducing action. After the step S520, the current execution cycle of the program segment ends.

The step S512 deactivates the drive 18A to suspend the reproduction of the current digest image data piece or the current main image data piece. Since the digest image data piece is the portion of the main image data piece, suspending the reproduction of the digest image data piece means suspending the reproduction of the portion of the main image data piece. The step S512 detects the ID number of the digest list file or the main list file mentioning the reproduction-suspended main image data piece, the ID number of the reproduction-suspended main image data piece, and the reproduction-suspended position in the reproduction-suspended main image data piece. The step S512 writes, into the resume memory 24a, reproduction-suspension point information representative of the detected ID number of the digest list file or the main list file, the detected ID number of the reproduction-suspended main image data piece, and the detected reproduction-suspended position. The step S512 forces the image data reproducing apparatus 20 to start operating in the initial-reproduction-information responsive mode. Accordingly, the step S512 controls the drive 18A to obtain the initial reproduction information from the recording medium 18. The step S512 incorporates the obtained initial reproduction information into a later part of the program segment. Then, the step S512 decides whether or not the value indicative of the reproduction change menu is recorded in the menu memory 24c. This decision by the step S512 relates to the command information piece “1” in the initial reproduction information. In this case, the value indicative of the reproduction change menu is recorded in the menu memory 24c, and hence the step S512 sequentially executes the commands in the command information pieces “2” and “5” in the initial reproduction information. The step S512 controls the drive 18A to read the main portion of the reproduction change menu picture data from the recording medium 18. The step S512 feeds the read data to the display 23, and controls the display 23 to indicate the reproduction change menu picture 110 represented by the fed data. The indication of the reproduction change menu picture 110 is provided by the command information piece “5” in the initial reproduction information.

A step S513 following the step S512 determines whether or not the cancel button picture 113 is selected and this selection is decided on the basis of the output signals from the user interface 28. When the cancel button picture 113 is selected and this selection is decided, the program advances from the step S513 to a step S514. Otherwise, the program advances from the step S513 to a step S515.

The step S514 controls the drive 18A to read, from the recording medium 18, the command information pieces “1”, “2”, and “3” concerning the cancel button picture 113. The S514 incorporates the read command information pieces “1”, “2”, and “3” into a later part of the program segment. Then, the step S514 writes the value indicative of the reproduction change menu into the menu memory 24c. This writing operation is provided by the command information piece “1” concerning the cancel button picture 113. The step S514 reads the reproduction-suspension point information from the resume memory 24a. The step S514 derives, from the read reproduction-suspension point information, the ID number of the digest list file or the main list file mentioning the reproduction-suspended main image data piece, the ID number of the reproduction-suspended main image data piece, and the reproduction-suspended position in the reproduction-suspended main image data piece. Then, the step S514 controls the drive 18A to read, from the recording medium 18, the digest list file or the main list file having the derived ID number. Subsequently, by referring to the read digest list file or the read main list file, the step S514 controls the drive 18A to restart reproducing the reproduction-suspended main image data piece from the recording medium 18 at the reproduction-suspended position or a position close or corresponding to the reproduction-suspended position. Thus, the step S514 restarts the reproduction of the digest image data pieces or the main image data pieces from the recording medium 18 according to the read digest list file or the read main list file. The step S514 controls the display 23 to indicate the contents of the reproduced digest image data pieces or the reproduced main image data pieces. The restart of the reproduction is provided by the command information piece “2” concerning the cancel button picture 113. After the step S514, the program returns to the step S511.

The step S515 determines whether or not the thumbnail menu call button picture 112 is selected and this selection is decided on the basis of the output signals from the user interface 28. When the thumbnail menu call button picture 112 is selected and this selection is decided, the program advances from the step S515 to a step S516. Otherwise, the program advances from the step S515 to a step S517.

The step S516 controls the drive 18A to read, from the recording medium 18, the command information pieces “1” and “2” concerning the thumbnail menu call button picture 112. The S516 incorporates the read command information pieces “1” and “2” into a later part of the program segment. Then, the step S516 controls the drive 18A to read the main portion of the thumbnail menu picture data from the recording medium 18. The step S516 controls the display 23 to indicate the thumbnail menu picture 70 represented by the read main portion of the thumbnail menu picture data. The indication of the thumbnail menu picture 70 is provided by the command information piece “1” concerning the thumbnail menu call button picture 112. After the step S516, the current execution cycle of the program segment ends.

The step S517 determines whether or not the reproduction change button picture 111 is selected and this selection is decided on the basis of the output signals from the user interface 28. When the reproduction change button picture 111 is selected and this selection is decided, the program advances from the step S517 to a step S518. Otherwise, the program exits from the step S517, and then the current execution cycle of the program segment ends.

The step S518 controls the drive 18A to read, from the recording medium 18, the command information pieces “1”-“11” concerning the reproduction change button picture 111. The S518 incorporates the read command information pieces “1 ”-“11” into a later part of the program segment. Then, the step S518 performs actions similar to those taken by the steps S435, S442, S444, S446, S452, S454, and S456 in FIG. 21. Accordingly, the step S518 implements switching between the reproduction of the digest image data pieces and the reproduction of the main image data pieces in the same group. After the step S518, the program returns to the step S511.

### Fourth Embodiment

A fourth embodiment of this invention is similar to one of the first to third embodiments thereof except for design changes mentioned hereafter. In the fourth embodiment of this invention, switching between the reproduction of main image data pieces and the reproduction of digest image data pieces is designed as follows.

After the reproduction of the current main image data piece is suspended, the reproduction of a selected digest image data piece in the same group as that having the reproduction-suspended main image data piece is started. The selected digest image data piece is the portion of the main image data piece having the same ID number as that of the reproduction-suspended main image data piece which is represented by the reproduction-suspension point information.

After the reproduction of the current digest image data piece (the portion of the main image data piece) is suspended, the reproduction of a selected main image data piece in the same group as that having the reproduction-suspended digest image data piece is started. The selected main image data piece has the same ID number as that of the reproduction-suspended main image data piece which is represented by the reproduction-suspension point information.

Therefore, the reproduction of a digest image data piece can be replaced by the reproduction of a main image data piece at a position close in display time domain to the reproduction-suspended position in the digest image data piece. In addition, the reproduction of a main image data piece can be replaced by the reproduction of a digest image data piece at a position close in display time domain to the reproduction-suspended position in the main image data piece.

### Fifth Embodiment

A fifth embodiment of this invention is similar to one of the first to fourth embodiments thereof except for design changes mentioned hereafter.

In the fifth embodiment of this invention, the image data reproducing apparatus 20 includes memories which can be used by the reproduction controlling section 24. Different ID numbers are assigned to the memories, respectively.

The bits b3, b2, b1, and b0 being “0010” in FIG. 12 are modified to represent a command to reproduce a list file recorded in a memory identified by a value of variable information.

The command information piece “6” (reproduce list file having name equal to obtained number N minus 100) and the command information piece “10” (reproduce list file having name equal to obtained number N plus 100) are omitted from the command information pieces concerning the reproduction change button picture 111. On the other hand, a command information piece indicating a command to record a value equal to obtained number N minus 100 into a memory identified by a value of variable information, and a command information piece indicating a command to record a value equal to obtained number N plus 100 into a memory identified by a value of variable information are added to the command information pieces concerning the reproduction change button picture 111.

A command information piece indicating a command to reproduce a list file having a name equal to a value recorded in a memory identified by a value of variable information is added to the command information pieces in the initial reproduction information.

Thereby, it is possible to implement switching between the reproduction of main image data pieces and the reproduction of digest image data pieces.

### Sixth Embodiment

A sixth embodiment of this invention is similar to one of the first to fifth embodiments thereof except for design changes mentioned hereafter. In the sixth embodiment of this invention, the resume memory 24a, the reproduced picture selection memory 24b, and the menu memory 24c are formed by a common memory.

### Seventh Embodiment

A seventh embodiment of this invention is similar to one of the first to sixth embodiments thereof except for design changes mentioned hereafter. In the seventh embodiment of this invention, the resume memory 24a, the reproduced picture selection memory 24b, and the menu memory 24c are located outside the reproduction controlling section 24.

### Eighth Embodiment

An eighth embodiment of this invention is similar to one of the first to seventh embodiments thereof except for design changes mentioned hereafter. In the eighth embodiment of this invention, the main image data pieces are used as the first image data pieces while commercial image data pieces relating to the main image data pieces are used as the second image data pieces.

### Ninth Embodiment

A ninth embodiment of this invention is similar to one of the first to seventh embodiments thereof except for design changes mentioned hereafter. In the ninth embodiment of this invention, the first image data pieces are formed by first digest image data pieces while the second image data pieces are formed by second digest image data pieces relating to the first digest image data pieces.

What is claimed is:

1. An image data recording apparatus comprising:
a menu picture data managing section for managing first menu picture data containing control information designed to allow switching from reproduction of first image data pieces to reproduction of second image data pieces or switching from reproduction of the second image data pieces to reproduction of the first image data pieces; and
a recording section for obtaining the first menu picture data from the menu picture data managing section, and for recording the obtained first menu picture data, the first image data pieces, and the second image data pieces on a recording medium.

2. An image data recording apparatus as recited in claim 1, wherein the menu picture data managing section operates for managing second menu picture data containing control information designed to allow starting reproduction of the first image data pieces or the second image data pieces from a desired point or to allow selecting desired one from the first image data pieces or the second image data pieces and starting reproduction of the selected desired image data piece, and wherein the recording section operates for obtaining the second menu picture data from the menu picture data managing section, and for recording the obtained second menu picture data on the recording medium.

3. An image data recording apparatus as recited in claim 1, further comprising a digest generating section for generating digest image data pieces representing digests of pictures represented by the first image data pieces, and wherein the recording section operates for using the digest image data pieces generated by the digest generating section as the second image data pieces.

4. An image data recording apparatus as recited in claim 1, wherein the control information in the first menu picture data represents:
a command to obtain reproduced picture identifying information indicating whether an image data piece reproduced before visualization of a first menu picture represented by the first menu picture data is one of the first image data pieces or one of the second image data pieces;
a command to obtain reproduction-suspension point information representing a position at which reproduction of the image data piece reproduced before visualization of the first menu picture is suspended; and
a command to decide a position, at which reproduction of the second image data pieces should be started, on the basis of the reproduction-suspension point information in cases where the reproduced picture identifying information indicates that the image data piece reproduced before visualization of the first menu picture is one of the first image data pieces, and decide a position, at which reproduction of the first image data pieces should be started, on the basis of the reproduction-suspension point information in cases where the reproduced picture identifying information indicates that the image data piece reproduced before visualization of the first menu picture is one of the second image data pieces.

5. An image data recording apparatus as recited in claim 1, further comprising:
a first group generating section for classifying the first image data pieces into groups according to attribute information pieces about the first image data pieces, and for generating first list files mentioning the first image data pieces in the respective groups;
a second group generating section for classifying the second image data pieces into groups according to the first list files, and for generating second list files mentioning the second image data pieces in the respective groups;
wherein the recording section operates for recording the first list files and the second list files on the recording medium.

6. An image data recording apparatus as recited in claim 5, wherein the control information in the first menu picture data represents:
a command to obtain reproduced picture identifying information indicating whether an image data piece reproduced before visualization of a first menu picture represented by the first menu picture data is one of the first image data pieces or one of the second image data pieces;
a command to obtain reproduced group identifying information indicating a group having the image data piece reproduced before visualization of the first menu picture; and
a command to decide a group, from which reproduction of the second image data pieces should be started, on the basis of the reproduced group identifying information in cases where the reproduced picture identifying information indicates that the image data piece reproduced before visualization of the first menu picture is one of the first image data pieces, and decide a group, from which reproduction of the first image data pieces should be started, on the basis of the reproduced group identifying information in cases where the reproduced picture identifying information indicates that the image data piece reproduced before visualization of the first menu picture is one of the second image data pieces.

7. An image data recording apparatus as recited in claim 4, wherein the control information in the first menu picture data represents a command to hold information indicating whether an image data piece, start of reproduction of which is decided, is one of the first image data pieces or one of the second image data pieces.

8. An image data recording apparatus as recited in claim 5, wherein the control information in the second menu picture data represents a command to start reproducing the first image data pieces or the second image data pieces from a desired group.

9. An image data recording apparatus as recited in claim 2, wherein the control information in the second menu picture data represents a command to hold information indicating whether an image data piece, start of reproduction of which is decided, is one of the first image data pieces or one of the second image data pieces.

10. An image data recording apparatus as recited in claim 2, further comprising an initial reproduction information generating section for generating initial reproduction information indicating whether the first image data pieces or the second image data pieces should be reproduced at the time of reproduction of recorded data from the recording medium, and wherein the recording section operates for recording the initial reproduction information generated by the initial reproduction information generating section on the recording medium.

11. An image data reproducing apparatus comprising:
a reproducing section for reproducing first image data pieces, second image data pieces, and first menu picture data from a recording medium, the first menu picture data containing control information designed to allow switching from reproduction of the first image data pieces to reproduction of the second image data pieces or switching from reproduction of the second image data pieces to reproduction of the first image data pieces;
a display section for indicating contents of the reproduced first image data pieces, contents of the reproduced second image data pieces, and contents of the reproduced first menu picture data;
a menu indication inputting section for inputting a request to indicate a first menu picture represented by the first menu picture data;
a menu control inputting section for inputting a request to select one from segments of the control information, contents of which are indicated by the display section, and a request to decide the selection of one from the segments; and
a reproduction controlling section for controlling the display section to indicate the contents of the control information in the first menu picture data in cases where the first image data pieces are reproduced and then the contents of the first menu picture data are indicated by the display section in response to a request inputted via the menu indication inputting section, and for controlling the reproducing section to reproduce the second image data pieces on the basis of the control information in the first menu picture data in cases where one is selected from segments of the control information, contents of which are indicated by the display section, and the selection of one from the segments is decided by requests inputted via the menu control inputting section;
the reproduction controlling section operating for controlling the display section to indicate the contents of the control information in the first menu picture data in cases where the second image data pieces are reproduced and then the contents of the first menu picture data are indicated by the display section in response to a request inputted via the menu indication inputting section, and for controlling the reproducing section to reproduce the first image data pieces on the basis of the control information in the first menu picture data in cases where one is selected from segments of the control information, contents of which are indicated by the display section, and the selection of one from the segments is decided by requests inputted via the menu control inputting section.

12. An image data reproducing apparatus as recited in claim 11:
wherein the reproducing section operates for reproducing second menu picture data from a recording medium, the second menu picture data containing control information designed to allow starting reproduction of the first image data pieces or the second image data pieces from a desired point or to allow selecting desired one from the first image data pieces or the second image data pieces and starting reproduction of the selected desired image data piece;
wherein the display section operates for indicating the reproduced second menu picture data; and
wherein the reproduction controlling section operates for controlling the display section to indicate the contents of the second menu picture data in response to a request inputted via the menu indication inputting section, and for controlling the reproducing section to start reproducing the first image data pieces or the second image data pieces on the basis of the control information in the second menu picture data in cases where one is selected from segments of the control information in the second menu picture data, contents of which are indicated by the display section, and the selection of one from the segments is decided by requests inputted via the menu control inputting section.

13. An image data reproducing apparatus as recited in claim 11:
wherein the reproduction controlling section includes a memory and operates for controlling the reproducing section to suspend reproduction of a current image data piece in response to a request inputted via the menu indication inputting section, for generating reproduced picture identifying information indicating whether an image data piece reproduced before visualization of a first menu picture represented by the first menu picture data is one of the first image data pieces or one of the second image data pieces, for generating reproduction-suspension point information representing a position at which reproduction of the image data piece reproduced before visualization of the first menu picture is suspended, and for recording the reproduced picture identifying information and the reproduction-suspension point information into the memory; and
wherein the reproduction controlling section operates for obtaining the reproduced picture identifying information and the reproduction-suspension point information from the memory in response to a request inputted via the menu control inputting section, for deciding a position, at which reproduction of the second image data pieces should be started, on the basis of the reproduction-suspension point information in cases where the reproduced picture identifying information indicates that the image data piece reproduced before visualization of the first menu picture is one of the first image data pieces, for deciding a position, at which reproduction of the first image data pieces should be started, on the basis of the reproduction-suspension point information in cases where the reproduced picture identifying information indicates that the image data piece reproduced before visualization of the first menu picture is one of the second image data pieces, and for controlling the reproducing section to start reproduction from the decided position.

14. An image data reproducing apparatus as recited in claim 11:
wherein the reproducing section operates for reproducing first list files and second list files from the recording medium, the first list files corresponding to groups respectively, the second list files corresponding to the groups respectively; and
wherein the reproduction controlling section operates for controlling the reproducing section to reproduce ones among the first image data pieces in a reproduction order and for reproduction intervals prescribed by at least one of the first list files, and for controlling the reproducing section to reproduce ones among the second image data pieces in a reproduction order and for reproduction intervals prescribed by at least one of the second list files.

15. An image data reproducing apparatus as recited in claim 14:
wherein the reproduction controlling section includes a memory and operates for controlling the reproducing section to suspend reproduction of a current image data piece in response to a request inputted via the menu indication inputting section, for generating reproduced picture identifying information indicating whether an image data piece reproduced before visualization of a first menu picture represented by the first menu picture data is one of the first image data pieces or one of the second image data pieces, and for recording the reproduced picture identifying information into the memory; and
wherein the reproduction controlling section operates for obtaining the reproduced picture identifying information from the memory in response to a request inputted via the menu control inputting section, for controlling the reproducing section to start reproducing the second image data pieces in the same group as that having the image data piece reproduced before visualization of the first menu picture in cases where the reproduced picture identifying information indicates that the image data piece reproduced before visualization of the first menu picture is one of the first image data pieces, and for controlling the reproducing section to start reproducing the first image data pieces in the same group as that having the image data piece reproduced before visualization of the first menu picture in cases where the reproduced picture identifying information indicates that the image data piece reproduced before visualization of the first menu picture is one of the second image data pieces.

16. An image data reproducing apparatus as recited in claim 11:
wherein the reproduction controlling section includes a first memory and a second memory and operates for controlling the reproducing section to suspend reproduction of a current image data piece in response to a request inputted via the menu indication inputting section, for generating reproduced picture identifying information indicating whether an image data piece reproduced before visualization of a first menu picture represented by the first menu picture data is one of the first image data pieces or one of the second image data pieces, for generating reproduction-suspension point information representing a position at which reproduction of the image data piece reproduced before visualization of the first menu picture is suspended, and for recording the reproduced picture identifying information and the reproduction-suspension point information into the first memory;
wherein the reproduction controlling section operates for obtaining the reproduced picture identifying information and the reproduction-suspension point information from the first memory in response to a request inputted via the menu control inputting section, for deciding a position, at which reproduction of the second image data pieces should be started, on the basis of the reproduction-suspension point information and recording information indicative of start of reproduction of the second image data pieces into the second memory in cases where the reproduced picture identifying information indicates that the image data piece reproduced before visualization of the first menu picture is one of the first image data pieces, for deciding a position, at which reproduction of the first image data pieces should be started, on the basis of the reproduction-suspension point information and recording information indicative of start of reproduction of the first image data pieces into the second memory in cases where the reproduced picture identifying information indicates that the image data piece reproduced before visualization of the first menu picture is one of the second image data pieces, and for controlling the reproducing section to start reproduction from the decided position;
wherein the reproducing section operates for reproducing second menu picture data from the recording medium, the second menu picture data containing control information designed to allow starting reproduction of the first image data pieces or the second image data pieces from a desired point or to allow selecting desired one from the first image data pieces or the second image data pieces and starting reproduction of the selected desired image data piece;
wherein the display section operates for indicating contents of the reproduced second menu picture data; and
wherein the reproduction controlling section operates for, in response to a request inputted via the menu indication inputting section, deciding whether contents of the first menu picture data or the second menu picture data should be indicated by the display section depending on the information in the second memory.

17. An image data reproducing apparatus as recited in claim 16:
wherein the reproducing section operates for reproducing first list files and second list files from the recording medium, the first list files corresponding to groups respectively, the second list files corresponding to the groups respectively;
wherein the reproduction controlling section operates for controlling the reproducing section to reproduce ones among the first image data pieces in a reproduction order and for reproduction intervals prescribed by at least one of the first list files, and for controlling the reproducing section to reproduce ones among the second image data pieces in a reproduction order and for reproduction intervals prescribed by at least one of the second list files;
wherein the reproduction controlling section operates for obtaining the reproduced picture identifying information from the first memory in response to a request inputted via the menu control inputting section, for controlling the reproducing section to start reproducing the second image data pieces in the same group as that having the image data piece reproduced before visualization of the first menu picture in cases where the reproduced picture identifying information indicates that the image data piece reproduced before visualization of the first menu picture is one of the first image data pieces, and for controlling the reproducing section to start reproducing the first image data pieces in the same group as that having the image data piece reproduced before visualization of the first menu picture in cases where the reproduced picture identifying information indicates that the image data piece reproduced before visualization of the first menu picture is one of the second image data pieces;
wherein the reproduction controlling section operates for controlling the display section to indicate contents of the second menu picture data in response to a request inputted via the menu indication inputting section; and
wherein the reproduction controlling section operates for controlling the reproducing section to start reproducing the first image data pieces or the second image data pieces in a desired group on the basis of the control information in the second menu picture data in cases where one is selected from segments of the control information in the second menu picture data, contents of which are indicated by the display section, and the selection of one from the segments is decided by requests inputted via the menu control inputting section.

18. An image data reproducing apparatus as recited in claim 17:
wherein the reproduction controlling section includes a third memory and operates for recording, into the third memory, information indicating whether an image data piece, start of reproduction of which is decided, is one of the first image data pieces or one of the second image data pieces when contents of the second menu picture data are indicated by the display section; and
wherein the reproduction controlling section operates for, in response to a request inputted via the menu indication inputting section, deciding whether contents of the first menu picture data or the second menu picture data should be indicated by the display section depending on the information in the third memory.

19. An image data reproducing apparatus as recited in claim 16, wherein the reproducing section operates for reproducing initial reproduction information from the recording medium, and the reproduction controlling section operates for controlling the display section to first indicate contents of the first menu picture data or the second menu picture data in accordance with the reproduced initial reproduction information.
